(19) United States
(12) Patent Application Publication
(10) Pub. No.: US 2026/0360566 A1
(43) Pub. Date: Nov. 12, 2026

(54) Fusion System that Includes a Unitary Housing having a Hollow Toroidal Interior Chamber that Includes an Interior Surface of the Unitary Housing, the Interior Surface of the Unitary Housing having a Rifled Geometric Shape, and the Unitary Housing Having a Coil that is Physically Mounted to a Ridge of the Rifled Geometric Shape

(71) Applicant: American Fusion Inc., Southlake, TX (US)

(72) Inventors: John Brandenburg, Jacksonville, OR (US); Michael G. Smith, Keller, TX (US)

(21) Appl. No.: 19/733,967

(22) Filed: Jul. 7, 2026

Related U.S. Application Data
(63) Continuation-in-part of application No. 19/720,936, filed on Jun. 26, 2026.
Application No. 19/720,936 is a continuation-in-part of application No. 19/710,441, filed on Jun. 17, 2026.
Application No. 19/710,441 is a continuation-in-part of application No. 19/693,646, filed on Jun. 1, 2026.
Application No. 19/693,646 is a continuation-in-part of application No. 19/560,120, filed on Mar. 8, 2026.
Application No. 19/560,120 is a continuation-in-part of application No. 18/354,637, filed on Jul. 18, 2023.
Application No. 18/354,637 is a continuation-in-part of application No. 17/736,084, filed on May 3, 2022, now abandoned.

(51) Int. Cl. G21B 1/05; G21B 1/13; G21B 1/15; G21B 1/17; G21B 1/21; G21B 1/25

(52) U.S. Cl. CPC G21B 1/055; G21B 1/13; G21B 1/15; G21B 1/17; G21B 1/21; G21B 1/25

(57) ABSTRACT

Systems, methods and apparatus are provided through which in some implementations a fusion system includes a unitary housing having a hollow toroidal interior chamber that includes an interior surface of the housing, the interior surface of the housing having a rifled geometric shape, and the housing having a coil that is physically mounted to a ridge of the rifled geometric shape

### RELATED APPLICATIONS

This application is a continuation-in-part patent application claiming priority under 35 U.S.C. 120 of pending U.S. Ser. No. 19/720,936 filed on 26 Jun. 2026 having docket Kep.u.0002.C-032, which is a continuation-in-part patent application claiming priority under 35 U.S.C. 120 of pending U.S. Ser. No. 19/710,441 filed on 17 Jun. 2026 having docket Kep.u.0002.C-031, which is a continuation-in-part patent application claiming priority under 35 U.S.C. 120 of pending U.S. Ser. No. 19/693,646 filed on 1 Jun. 2026 having docket Kep.u.0002.C-029, which is a continuation-in-part patent application claiming priority under 35 U.S.C. 120 of pending U.S. Ser. No. 19/560,120 filed on 8 Mar. 2026 having docket Kep.u.0002.C-028 which is a continuation-in-part patent application claiming priority under 35 U.S.C. 120 of pending U.S. Ser. No. 18/354,637 filed on 18 Jul. 2023 having docket Kep.u.0002.C-001 which is a continuation-in-part patent application claiming priority under 35 U.S.C. 120 of U.S. Ser. No. 17/736,084 filed on 3 May 2022 having docket Kep.u.0002 and abandoned on 10 Oct. 2023.

This application is a continuation-in-part patent application claiming priority under 35 U.S.C. 120 of pending U.S. Ser. No. 19/720,936 filed on 26 Jun. 2026 having docket Kep.u.0002.C-032, which is a continuation-in-part patent application claiming priority under 35 U.S.C. 120 of pending U.S. Ser. No. 19/710,441 filed on 17 Jun. 2026 having docket Kep.u.0002.C-031, which is a continuation-in-part patent application claiming priority under 35 U.S.C. 120 of pending U.S. Ser. No. 19/693,646 filed on 1 Jun. 2026 having docket Kep.u.0002.C-029, which is a continuation-in-part patent application claiming priority under 35 U.S.C. 120 of pending U.S. Ser. No. 18/354,637 filed on 18 Jul. 2023 having docket Kep.u.0002.C-001, which is a continuation-in-part patent application claiming priority under 35 U.S.C. 120 of U.S. Ser. No. 17/736,084 filed on 3 May 2022 and abandoned on 10 Oct. 2023 having docket Kep.u.0002.

### FIELD

This disclosure relates generally to experimental fusion nuclear reactors, and more particularly to experimental toroidal nuclear fusion reactors.

### BACKGROUND

Nuclear fusion is a reaction in which two or more atomic nuclei are combined to form one or more different atomic nuclei and subatomic particles (neutrons or protons). The difference in mass between the reactants and products is manifested as either the release difference in atomic binding energy between the nuclei before and after the reaction.

A stellarator is a toroidal nuclear reactor for producing controlled nuclear fusion that involves confining and heating of a gaseous plasma by means of an externally applied magnetic field.

A torsatron is a stellarator with continuous helical coils, or with a number of discrete coils that produce a similar field.

A torsatron is the simplest configuration for toroidal magnetic confinement of plasmas in steady state. The formation of toroidal plasmas with “flux invariants” can lead to stable MHD (Magneto-Hydro-Dynamic) equilibria, after a period of relaxation to a minimum energy state.

Shock heating of plasmas for fusion was demonstrated early in the fusion effort but was largely abandoned in favor of the steady state tokamak and stellarator approaches which demonstrated superior plasma confinement. Shock heating of plasmas to fusion temperatures was successfully demonstrated at Los Alamos in the Scylla and Scyllac devices in the early 60's. The tokamak and stellarator nuclear fusion reactors include a separate auxiliary heating method to bring the plasma to fusion temperatures. The heating apparatus adds considerably to the complexity and mass of any fusion device.

Many efforts have been, and presently are, focused on harnessing fusion energy using toroidal magnetic confinement of plasmas, such as in the tokamak or stellarator in steady state. The tokamak is a device which uses a powerful magnetic field to confine plasma in the shape of a torus. The stellarator is a plasma device that relies primarily on external magnets to confine a plasma. In the tokamak, the rotational transform of a helical magnetic field is formed by a toroidal field generated by external coils together with a poloidal field generated by the plasma current. In the stellarator, the twisting field is produced entirely by external non-axisymmetric coils.

Shock heating of plasmas to fusion temperatures with subsequent MHD (Magneto-Hydro-Dynamic) stable confinement was demonstrated at Los Alamos in the Scylla and Scyllac devices, as disclosed in K. F. McKenna and R. E. Siemon, “Theta-pinch research at Los Alamos” Nuclear Fusion 25(9):1267 (2011) and R. E. Siemon “A Summary of Scylla Results” LANL Informal report LA-7125-MS (1978). The Scylla machine, a straight Theta Pinch, was successful in demonstrating shock-heating of plasma to fusion temperatures but was open at both ends, allowing the plasma to escape. A torsatron magnetic configuration has been demonstrated to confine plasmas in steady state, such as disclosed in J. Lyon et al. “Compact Torsatron Reactors”, ORNL/TM-10572, 1988 and S. P. Bondarenko et. al, “First Experimental Results of URAGAN 3M Torsatron,” Plasma Physics and Controlled Fusion Research 1990, Proc. 13th International Conf. on Plasma Physics and Controlled Fusion Research Vol. 2.). Z-pinch devices typically pulse the plasma for 20 to 100 microseconds, up to 10 pulses per second.

### BRIEF DESCRIPTION

The above-mentioned shortcomings, disadvantages and problems are addressed herein, which will be understood by reading and studying the following specification.

In an aspect, a unitary housing having sections and having a hollow toroidal interior chamber and an interior surface, and the interior surface of the housing having a rifled geometric shape to which electrical energy is pulsed

In one aspect, an experimental unitary fusion system includes a rifled toroidal pinch torsatron that is operable to attain nuclear fusion of about an equal amount of helium3 and deuterium.

In another aspect, an experimental unitary fusion system includes a rifled toroidal pinch torsatron that is operable to attain nuclear fusion of about an equal amount of helium3 and deuterium through pulsing fusion.

In yet another aspect, an experimental unitary fusion system includes a rifled toroidal pinch torsatron with 5-6 set of ridges and grooves.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a cross section block diagram of an overview of an experimental clam-shell housing fusion system to manage fusion reactions, according to an implementation.

FIG. 2 is a cross section block diagram of a wire-coil torsatron experimental clam-shell housing fusion system, according to an implementation.

FIG. 3 is block diagram of a fusion control system, according to an implementation.

FIG. 4 is an isometric diagram of a half-shell of the fusion confinement device in FIG. 1-3, according to an implementation.

FIG. 5-9 are isometric diagrams of a six-coil torsatron operable in the fusion confinement device in FIG. 2, according to an implementation.

FIG. 10 is an isometric diagram of a six-lead exterior current feed configuration of a fusion confinement device in FIG. 1-3, according to an implementation.

FIG. 11 is a flowchart of a method to control an experimental fusion system, according to an implementation.

FIG. 12 is a flowchart of a method to control a pulsed fusion system, according to an implementation.

FIG. 13 is a block diagram of an experimental fusion system control computer, according to an implementation.

FIG. 14 is a block diagram of a data acquisition circuit of an experimental fusion system control computer in FIG. 13, according to an implementation.

FIG. 15 is a block diagram of a fusion reactor control mobile device, according to an implementation.

FIG. 16 is a top-down view cross section diagram of an experimental unitary fusion system, according to an implementation in which the center piece has holes for accommodating bolts, the outer perimeter has no holes for accommodating bolts, the outer portion of the vanes are higher than the inner portion of the vanes.

FIG. 16-39 show different variations of the topology of the interior chamber and the vanes that can be implemented between FIG. 16-39.

FIG. 17 is a top-down view cross section diagram of an experimental unitary fusion shell, according to an implementation, in which the center piece has no holes for accommodating bolts, the outer perimeter has no holes for accommodating bolts, the outer portion of the vanes are the same height as the inner portion of the vanes and the number of the vanes is 15.

FIG. 18 is a top-down view cross section diagram of an experimental unitary fusion shell, according to an implementation, in which the center piece has no holes for accommodating bolts, the outer perimeter has no holes for accommodating bolts, the outer portion of the vanes are the same height as the inner portion of the vanes and the number of the vanes is 15.

FIG. 19 is a top-down view cross section diagram of an experimental unitary fusion shell, according to an implementation, in which the center piece has no holes for accommodating bolts, the outer perimeter has no holes for accommodating bolts, the outer portion of the vanes are the same height as the inner portion of the vanes and the number of the vanes is 15.

FIG. 20 is a top-down view cross section diagram of an experimental unitary fusion shell, according to an implementation, in which the center piece has no holes for accommodating bolts, the outer perimeter has no holes for accommodating bolts, the outer portion of the vanes are the same height as the inner portion of the vanes and the number of the vanes is 15.

FIG. 21 is a top-down view cross section diagram of an experimental unitary fusion shell, according to an implementation, in which the center piece has no holes for accommodating bolts, the outer perimeter has no holes for accommodating bolts, the outer portion of the vanes are the same height as the inner portion of the vanes and the number of the vanes is 15.

FIG. 22 is a top-down view cross section diagram of an experimental unitary fusion shell, according to an implementation, in which the center piece has no holes for accommodating bolts, the outer perimeter has no holes for accommodating bolts, the outer portion of the vanes are the same height as the inner portion of the vanes and the number of the vanes is 15.

FIG. 23 is a top-down view cross section diagram of an experimental unitary fusion shell, according to an implementation, in which the center piece has no holes for accommodating bolts, the outer perimeter has no holes for accommodating bolts, the outer portion of the vanes are the same height as the inner portion of the vanes and the number of the vanes is 15.

FIG. 24 is a top-down view cross section diagram of an experimental unitary fusion shell, according to an implementation, in which the center piece has no holes for accommodating bolts, the outer perimeter has no holes for accommodating bolts, the outer portion of the vanes are the same height as the inner portion of the vanes and the number of the vanes is 15.

FIG. 25 is a top-down view cross section diagram of an experimental unitary fusion shell, according to an implementation, in which the center piece has no holes for accommodating bolts, the outer perimeter has holes for accommodating bolts, the outer portion of the vanes are the same height as the inner portion of the vanes and the number of the vanes is 15.

FIG. 26 is a top-down view cross section diagram of an experimental unitary fusion shell, according to an implementation, in which the center piece has no holes for accommodating bolts, the outer perimeter has holes for accommodating bolts, the outer portion of the vanes are the same height as the inner portion of the vanes and the number of the vanes is 15.

FIG. 27 is a top-down view cross section diagram of an experimental unitary fusion shell, according to an implementation, in which the center piece has no holes for accommodating bolts, the outer perimeter has holes for accommodating bolts, the outer portion of the vanes are the same height as the inner portion of the vanes and the number of the vanes is 15.

FIG. 28 is a top-down view cross section diagram of an experimental unitary fusion shell, according to an implementation, in which the center piece has holes for accommodating bolts, the outer perimeter has holes for accommodating bolts, the outer portion of the vanes are higher than the inner portion of the vanes and the number of the vanes is 15.

FIG. 29 is a top-down view cross section diagram of an experimental unitary fusion shell, according to an implementation, in which the center piece has no holes for accommodating bolts, the outer perimeter has no holes for accommodating bolts, the outer portion of the vanes are higher than the inner portion of the vanes and the number of the vanes is 15.

FIG. 30 is a top-down view cross section diagram of an experimental unitary fusion shell, according to an implementation, in which the center piece has no holes for accommodating bolts, the outer perimeter has no holes for accommodating bolts, the outer portion of the vanes are higher than the inner portion of the vanes and the number of the vanes is 15.

FIG. 31 is a top-down view cross section diagram of an experimental unitary fusion shell, according to an implementation, in which the center piece has no holes for accommodating bolts, the outer perimeter has no holes for accommodating bolts, the outer portion of the vanes are higher than the inner portion of the vanes and the number of the vanes is 15.

FIG. 32 is a top-down view cross section diagram of an experimental unitary fusion shell, according to an implementation, in which the center piece has no holes for accommodating bolts, the outer perimeter has no holes for accommodating bolts, the outer portion of the vanes are higher than the inner portion of the vanes and the number of the vanes is 15.

FIG. 33 is a top-down view cross section diagram of an experimental unitary fusion shell, according to an implementation, in which the center piece has no holes for accommodating bolts, the outer perimeter has no holes for accommodating bolts, the outer portion of the vanes are higher than the inner portion of the vanes and the number of the vanes is 15.

FIG. 34 is a top-down view cross section diagram of an experimental unitary fusion shell, according to an implementation, in which the center piece has no holes for accommodating bolts, the outer perimeter has no holes for accommodating bolts, the outer portion of the vanes are higher than the inner portion of the vanes and the number of the vanes is 15.

FIG. 35 is a top-down view cross section diagram of an experimental unitary fusion shell, according to an implementation, in which the center piece has holes for accommodating bolts, the outer perimeter has holes for accommodating bolts, the outer portion of the vanes are higher than the inner portion of the vanes and the number of the vanes is 15.

FIG. 36 is a top-down view cross section diagram of an experimental unitary fusion shell, according to an implementation, in which the center piece has holes for accommodating bolts, the outer perimeter has holes for accommodating bolts, the outer portion of the vanes are higher than the inner portion of the vanes and the number of the vanes is 15.

FIG. 37 is an isometric diagram of an experimental unitary fusion shell, according to an implementation, in which the center piece has holes for accommodating bolts, the outer perimeter has holes for accommodating bolts, the outer portion of the vanes are higher than the inner portion of the vanes and the number of the vanes is 15.

FIG. 38 is a top-down view cross section diagram of an experimental unitary fusion system, according to an implementation in which the center piece has holes for accommodating bolts, the outer portion of the vanes are higher than the inner portion of the vanes. 15 sections of the shell are separated by rubber and the number of the vanes is 15.

FIG. 39 is a top-down view cross section diagram of an experimental unitary fusion system, according to an implementation in which the center piece has holes for accommodating bolts, the outer portion of the vanes are higher than the inner portion of the vanes. Four sections of the shell are separated by rubber and the number of the vanes is 4.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into six sections. In the first section, apparatus of implementations are described. In the second section, implementations of methods are described. In the third section, a hardware and the operating environment in conjunction with which implementations may be practiced are described. In the fourth section, implementation of a unitary design of a fusion reactor are described. In the fifth section, physics in operation of apparatus in systems, methods and apparatus described herein is described. In the sixth section, testing and experimental criteria is described. Finally, in the seventh section, a conclusion of the detailed description is provided.

This disclosure can be utilized for many types of uses, including experimental use.

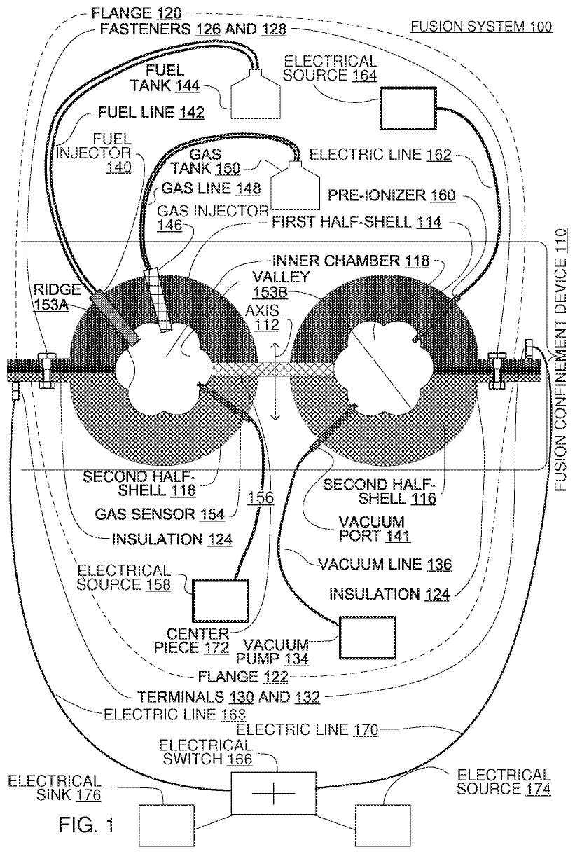

FIG. 1 is a block diagram of an overview of an experimental clam-shell housing fusion system 100 to manage fusion reactions, according to an implementation. In this section, particular apparatus of implementations are described by reference to a series of diagrams.

Tokomaks and stellarators are steady state machines, which are not pulsed. The technical focus on steady state systems has taught away from consideration of rapid timescale effects.

In clam-shell housing fusion system 100, a torsatron magnetic configuration is employed to maintain a hot-dense plasma in a toroidal equilibrium configuration during the fusion power pulse.

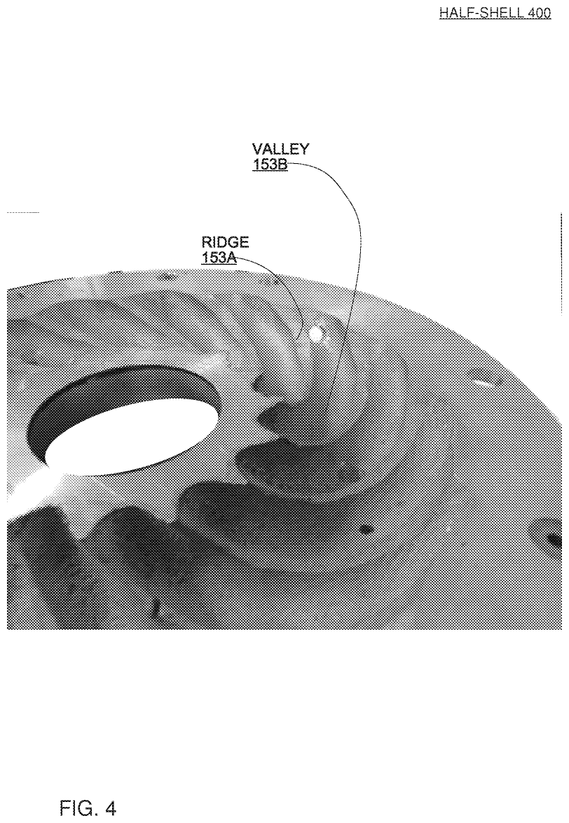

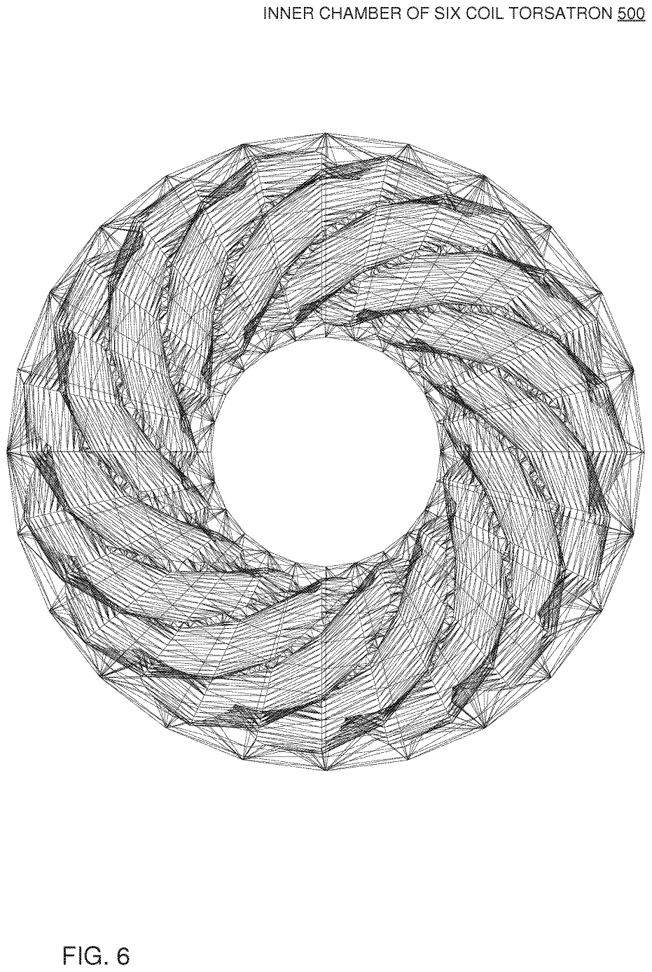

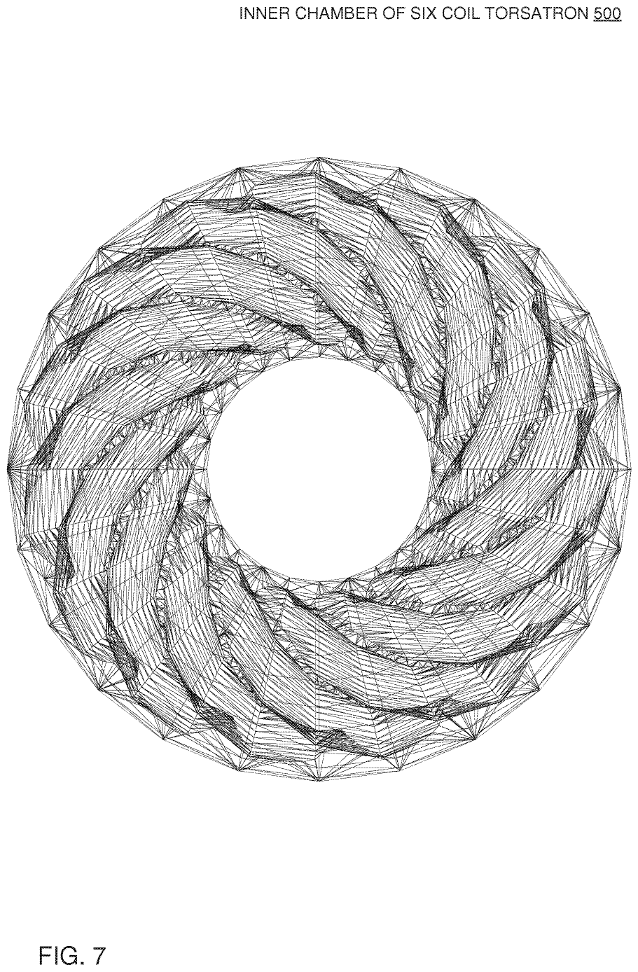

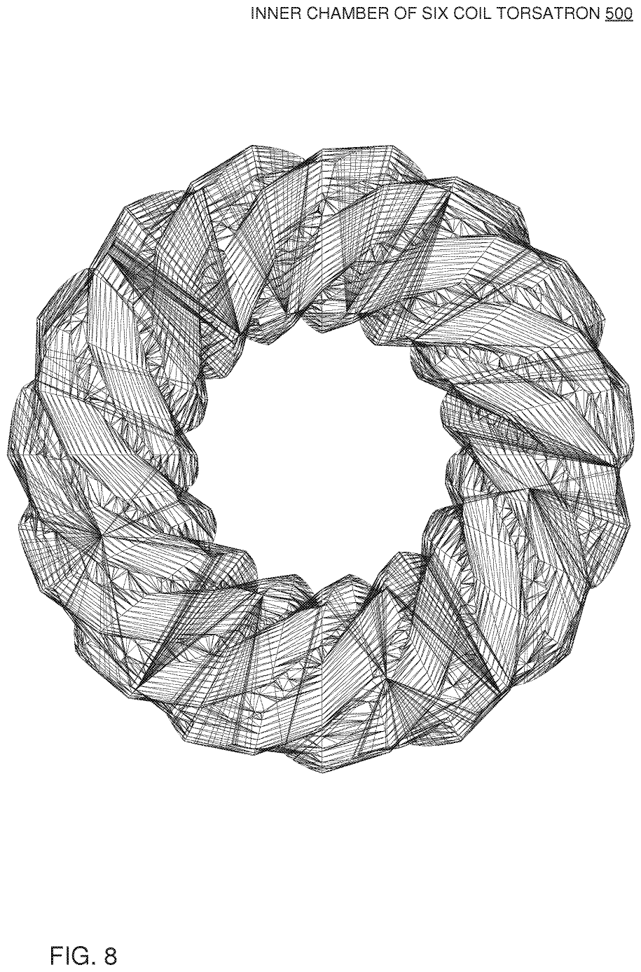

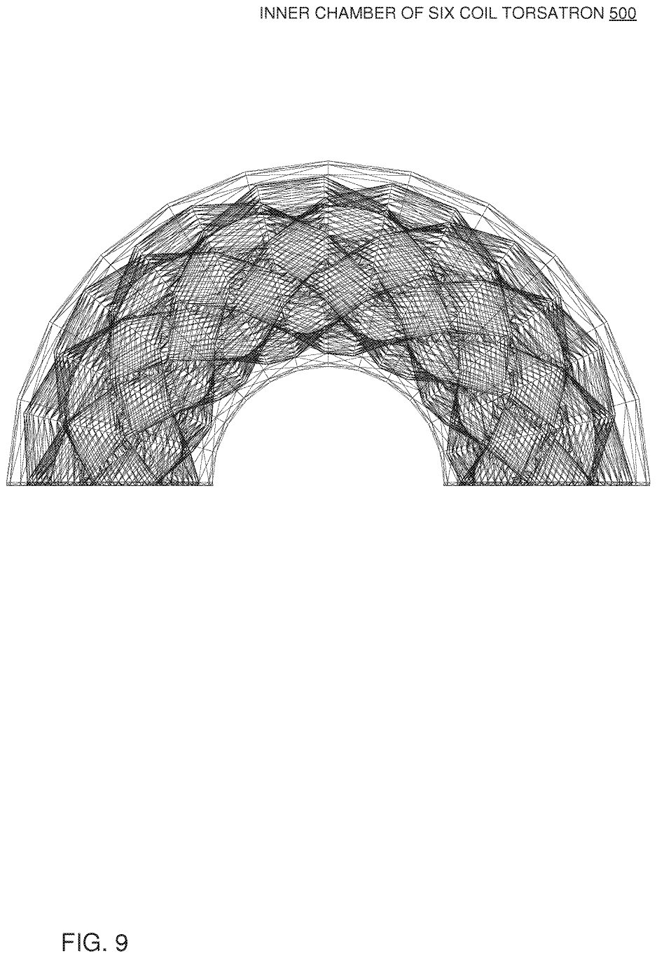

The clam-shell housing fusion system 100 includes a fusion confinement device 110 (and a center axis 112 of the fusion confinement device 110) enclosing a first half-shell 114 and a second half-shell 116. In some implementations such as shown in FIG. 1, the first half-shell 114 is symmetrical to the second half-shell 116. The first half-shell 114 and the second half-shell 116 form an inner chamber 118. The inner chamber 118 forms a rifled toroidal theta pinch (RTTP), as shown in FIG. 4-9. The inner chamber 118 is also referred to as a hollow toroidal interior chamber.

A cross section diagram of the fusion confinement device 110 is shown in FIG. 1. The fusion confinement device 110 is circular in shape when viewed from above. In some implementations the inner chamber 118 is circular in shape in cross-section (as shown in FIG. 1). In other embodiments the inner chamber 118 has a square shape in cross-section, and in other implementations the inner chamber 118 has a parabolic shape in cross-section. In other implementations of the fusion confinement device 110, the two halves (the first half-shell 114 and the second half-shell 116) are unequal and asymmetrical portions of the inner chamber 118. For example, one portion of the inner chamber 118 forms 90 degrees of the inner chamber 118 and the other portion of the inner chamber 118 forms 270 degrees of cross section of the inner chamber 118. In some implementations, the diameter of the inner chamber 118 torus is 3 meters. In some implementations, the diameter of the inner chamber 118 torus is 1 meter.

In the fusion confinement device 110, both the second half-shell 116 and the first half-shell 114 include a flange 120 and 122, respectively, on the outer perimeters. Electrical insulation 124 is in between the flanges 120 and 122. The second half-shell 116 and the first half-shell 114 are held together by non-ferrous and non-conductive fasteners 126 and 128 thereby holding together the first half-shell 114 and the second half-shell 116. The flanges 120 and 122 also include electrical terminals 130 and 132. Terminals 130 and 132 are connected to flange 122, and in some implementations penetrate the flange 122 but in no case do the terminals 130 and 132 penetrate the insulation layer 124. Each of the non-ferrous and non-conductive fasteners 126 and 128 can include the nut-and-bolt implementation of the non-ferrous and non-conductive fasteners 126 and 128 as shown in FIG. 1, but can include any other functionally equivalent apparatus to hold together the second half-shell 116 and the first half-shell 114, such as C-clamps.

The fusion confinement device 110 in various implementations can be constructed of high strength aluminum alloy or quartz crystal and weigh approximately a ton. In some implementations of the clam-shell housing fusion system 100, adding small amounts of yttrium and scandium to aluminum of the first half-shell 114 and the second half-shell 116 will increase the strength while not affecting electrical conductivity. In some implementations of the fusion confinement device 110, the housing is quartz crystal with a layer of electrically conductive material such as aluminum on the interior of the inner chamber 118.

The clam-shell housing fusion system 100 further includes a vacuum pump 134 that is operably coupled to a vacuum line 136, that is operably coupled to a vacuum port 138 in the wall of the second half-shell 116.

The fusion confinement device 110 of the clam-shell housing fusion system 100 further includes a fuel injector 140 that traverses through the hemispherical portion of the first half-shell 114 and into the inner chamber 118. The fuel injector 140 receives a fuel through a fuel line 142 that receives the fuel from fuel tank(s) 144. Examples of the fuel include a 50/50 mix of gaseous helium3 and gaseous deuterium, in which case, the fuel tank(s) 144 includes at least two fuel tanks, a first tank for the gaseous helium3 and a second tank for the gaseous deuterium. In some implementations, the fuel tank(s) include a third tank to store gaseous tritium for the fuel.

In some implementations, a gas injector 146 in the fusion confinement device 110 of the clam-shell housing fusion system 100 is coupled to, and receives gas from a gas line 148 outside of the fusion confinement device 110 that is coupled to a gas tank 150. The gas injector 146 injects the concentration(s) of gases into the inner chamber 118, such as the concentration of tritium and/or helium4. When helium4 is injected into the inner chamber 118 by the gas injector 146 and helium3 is also injected into the inner chamber 118 by the fuel injector 140, the helium4 will not fuse with the helium3 because helium4 is inert and is not reactive in fusion.

In some implementations, at least one electromagnetic (EM) foil 152 (such as 5-6 EM foils) that are evenly spaced away from each other is generated by electricity flowing through the inner chamber 118.

When injected, Helium3 fuel is pressurized and heated to fusion by the pressure and temperatures of between fusion temperatures of between 100,000,000 degrees K and 150,000,000 degrees K for deuterium-tritium fuel, fusion temperatures of between 600,000,000 degrees K and 1,000,000,000 degrees K for Helium3 and deuterium fuel and fusion temperatures of between 600,000,000 degrees K and 700,000,000 degrees K for a Helium3 fuel of a plasma that are created by the EM foil(s) 152 that traverse(s) the torodial inner chamber 118. The EM foil 152 is not a spiraled wire that is mounted or attached to a ridge 153A of the inner chamber 118. Rather the ridge 153A generates an EM foil 152 when electricity passes through the inner chamber 118 and the electricity aggregates and concentrates along the ridge 153A as indicated by Maxwell's Equations to the extent that nearly all of the electricity is in the ridge 153A. The EM foil 152 shapes electromagnetic force and generates maximum compression force in the same way that a hydrofoil shapes water to generate a maximum lifting force. The EM foil 152 also shapes the electromagnetic field to produce a configuration that maximizes stability on the plasma.

Maxwell's equations indicate that for pulsed fields, the magnetic lines of force must lie in the metal grooves, and be parallel everywhere to the metal surfaces, and also not penetrate the metal surfaces. The electric current in the metal surface must follow this pattern and be consistent with the magnetic field. This follows from Faraday's law and the law that forbids magnetic monopoles (Maxwell's equations #2 and #3). Maxwell's equation #3 indicates that a magnetic field (B or H) does not flow outward or inward (because the right-hand side is zero). Maxwell's equation #2 is derived from Faraday's laws of Electromagnetic Induction, which indicates that whenever there are n-turns of conducting coil in a closed path which is placed in a time-varying magnetic field, an alternating electromotive force gets induced in each and every coil, which is given by Lenz's law. Faraday's law indicates that the time rate of change of the magnetic field is proportional to the vorticity of the electric field around the magnetic lines of force, meaning that since the electric field vanishes for pulsed fields inside the metal, the magnetic lines of force that penetrate the metal surface must end inside it. But his would mean magnetic monopoles (magnetic free charge) would have to exist in the metal, but since magnetic fields have no monopoles like electric fields, the pulsed magnetic lines of force cannot penetrate the metal surfaces but must lie parallel to those surfaces.

In regards to the geometric shape of the surface of the inner chamber 118, in some implementations, the ratio of the distance from the center of the cross-section of the inner chamber 118 to the grooves in comparison to the distance from the center of the cross-section of the inner chamber 118 to the ridge(s) 153A is 1.16. The top of the grooves are ridge(s) 153A and the bottom of the grooves are valley(s) 153B.

The rifling of the first half-shell 114 and the second half-shell 116 that form the inner chamber 118 for this pulsed system causes “burning in” a flux invariant A·B (the Taylor invariant, where A is the magnetic vector potential) into the plasma, which then persists to create helical magnetic fields in the plasma and the inner chamber 118, even though the immediate effect of the rifling fades with time. The plasma will relax into a minimum energy state (Taylor relaxation) while preserving the global average value of A·B and other flux invariants). Such complex interactions between the plasma and rifling on the walls of the chamber over time are seemingly counter intuitive. In the implementation shown in FIG. 1, the grooves have a semi-circular geometric shape. In other implementations, the grooves have a hemispherical-circular geometric shape. In other implementations, the grooves have a square (right-angled) geometric shape. In other implementations, the grooves have a parabolic geometric shape.

A gas sensor 154 in the fusion confinement device 110 of the clam-shell housing fusion system 100 is electrically powered by, and coupled to, an electric line 156 outside of the fusion confinement device 110 that is electrically coupled to an electrical source 158. The gas sensor 154 determines the concentration(s) of gases in inner chamber 118, such as the concentration of tritium or helium4.

The fuel in the clam-shell housing fusion system 100 is a mixture of gaseous helium3 and gaseous deuterium. In some implementations, the mixture of gaseous helium3 and gaseous deuterium is a mixture of about 50% gaseous helium3 and about 50% gaseous deuterium in which molecules of the gaseous helium3 fuses with molecules of the gaseous deuterium in the inner chamber 118. In some implementations, a small amount of tritium is added to aid ignition of the fusion reaction.

A pre-ionizer 160 in the fusion confinement device 110 is electrically energized by, and coupled to, an electric line 162 outside of the fusion confinement device 110 that is electrically coupled to an electrical source 164.

In some implementations, an electrical switch 166 is operable to open a circuit (through electric line 170) between an electrical source 174 and the second half-shell 116. In some implementations, the electrical source 174 includes a voltage capacitor bank having 500 miliFarads and ¼ million Joules of energy that provides 15,000 volts. In some implementations, the electrical source 174 includes a voltage capacitor bank having 500 miliFarads and 1 million Joules of energy that provides 15,000 volts.

In some implementations, output power from the fusion confinement device 110 along the electric line 170 is controlled by solid state switching in the electrical switch 166. In some implementations, the electrical source 174 provides a million Joules of energy at 15,000 volts. In alternative embodiments, the electrical source 174 is electrically connected to second half-shell 116 rather than the first half-shell 114 and the electrical sink 176 is connected to the first half-shell 114 rather than the second half-shell 116.

In some implementations, regenerative energy recovery is performed by the electrical switch 166 by diverting some of the electricity that is transferred from the second half-shell 116 to the electrical sink 176 instead to the electrical source 174, in order to replace the electricity that is transferred from the electrical source 174 to the second half-shell 116. The regenerative energy recovery occurs because the fusion energy pulse heats the plasma confined by the magnetic field and expands against the plasma, creating a current in EM foil 152, which using the electrical switch 166, can be used to recharge the electrical source 174.

In the implementation of a conductive center piece 172 shown in FIG. 1, the conductive center piece 172 is a round disk. In other implementations, the conductive center piece 172 is a ring that is only between the first half-shell 114 and the second half-shell 116, but is absent between the hemispheres of the first half-shell 114 and the second half-shell 116.

The electrical switch 166 is operable to open a circuit (through electric lines 168 and 170) between an electrical sink 176 and the second half-shell 116. The electricity from the electrical source 174 flows into the flange 120 of the first half-shell 114 through the terminal 130 and then around the rifled inner chamber 118 into the center piece 172 then around the second half-shell 116 before exiting the terminal 132 back to the electrical source 174. In some implementations, the first half-shell 114 will be charged negative and the second half-shell 116 will be charged positive, but in other implementations, that polarity will be reversed. Examples of the electrical sink 176 are a battery or a power conditioner.

While the clam-shell housing fusion system 100 is not limited to any particular fusion confinement device 110, first half-shell 114, second half-shell 116, inner chamber 118, flange 120, flange 122, insulation layer 124, non-ferrous and non-conductive fasteners 126 and 128, terminal 130, terminal 132, vacuum pump 134, vacuum line 136, vacuum port 138, fuel injector 140, fuel line 142, fuel tank 144, gas injector 146, gas line 148, EM foil 152, gas tank 150, gas sensor 154, electric line 156, electrical source 158, pre-ionizer 160, electric line 162, electrical source 164, electrical switch 166, electric line 168, electric line 170, conductive center piece 172, electrical source 174, electrical sink 176, and for sake of clarity a simplified fusion confinement device 110, first half-shell 114, second half-shell 116, inner chamber 118, flange 120, flange 122, insulation layer 124, non-ferrous and non-conductive fasteners 126 and 128, terminal 130, terminal 132, vacuum pump 134, vacuum line 136, vacuum port 138, fuel injector 140, fuel line 142, fuel tank 144, gas injector 146, gas line 148 and gas tank 150, EM foil 152, gas sensor 154, electric line 156, electrical source 158, pre-ionizer 160, electric line 162, electrical source 164, electrical switch 166, electric line 168, electric line 170, conductive center piece 172, electrical source 174 and electrical sink 176 are described.

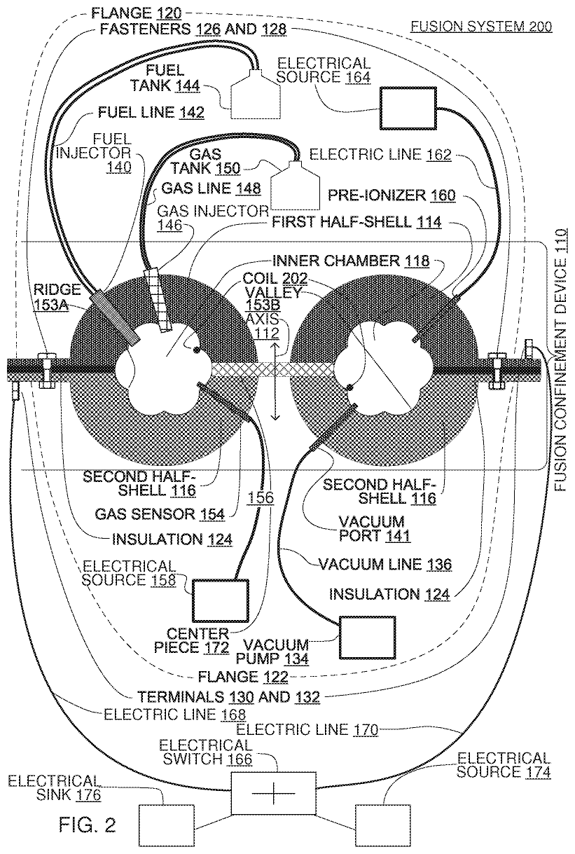

FIG. 2 is an isometric cross section block diagram of a wire-coil torsatron operable in the clam-shell housing fusion system 200, according to an implementation.

A coil 202 is a spiraled wire that is mounted or attached to a ridge 153A of the inner chamber 118. Electricity passes through the coil 202. In some implementations, all of the coil(s) 202 are physically mounted in regards to the rifling, on the land(s) (the highpoint) between the grooves, such as shown in FIG. 2. In other implementations, all of the coil(s) 202 are mounted in the grooves (the low point) between the ridge(s) 153A.

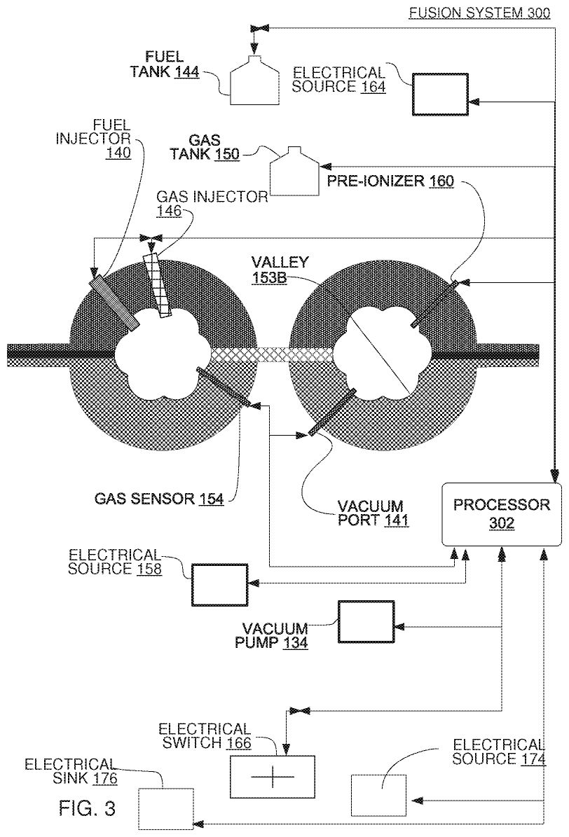

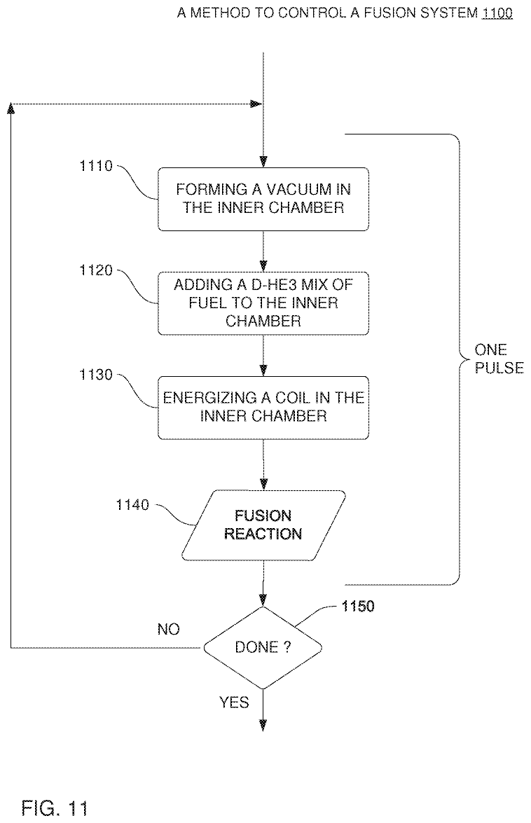

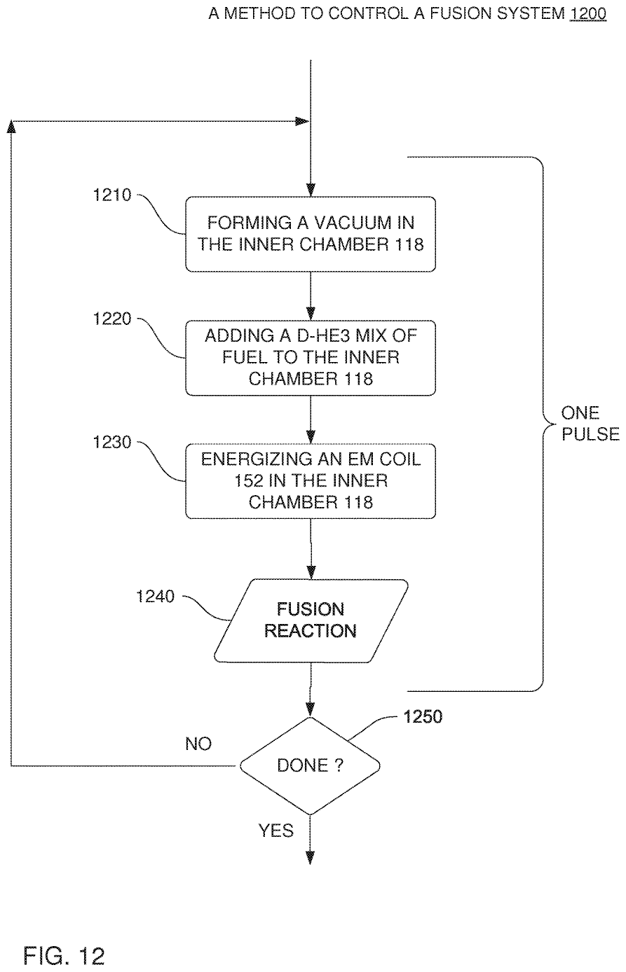

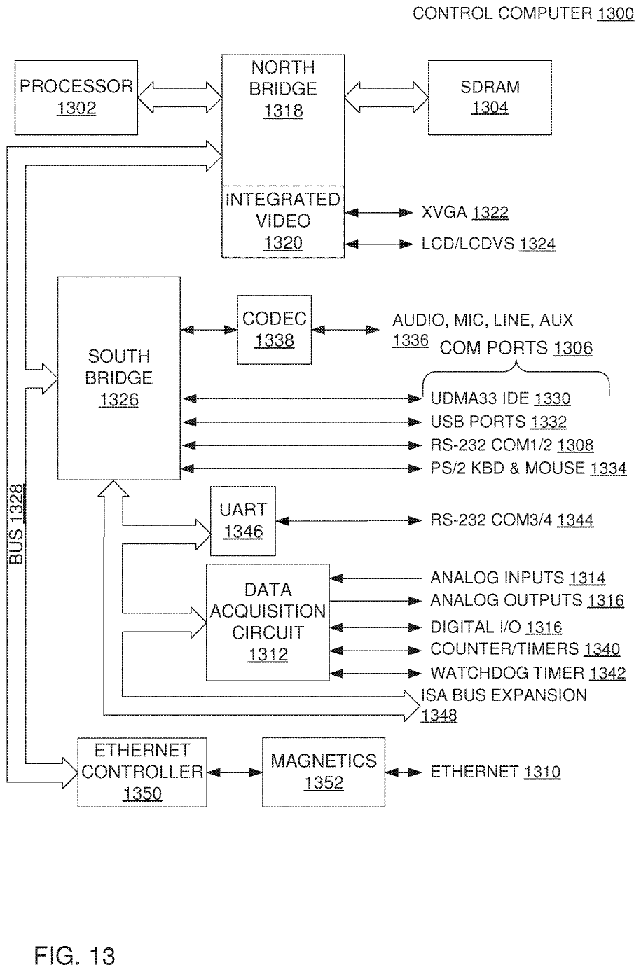

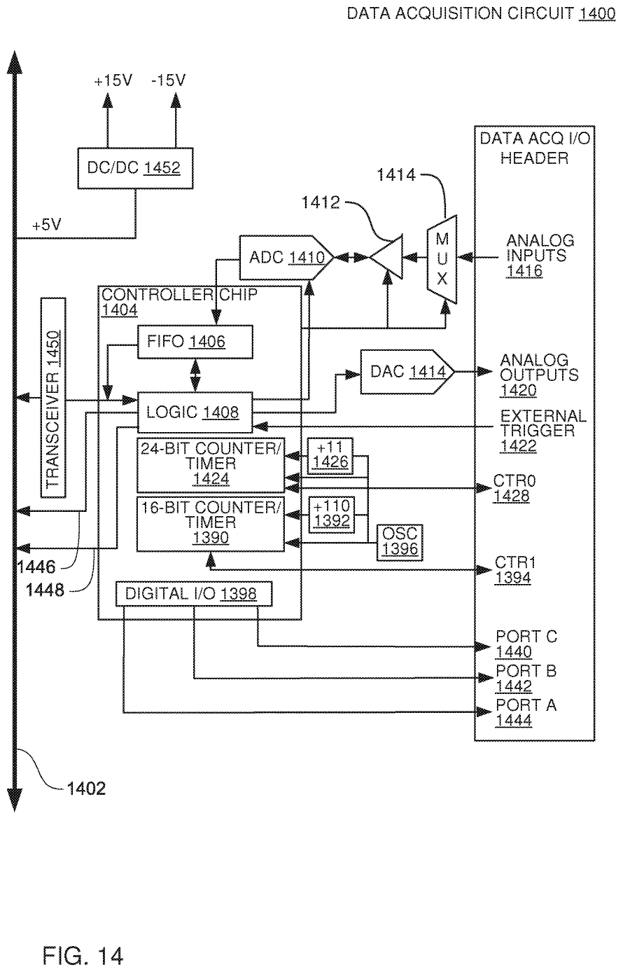

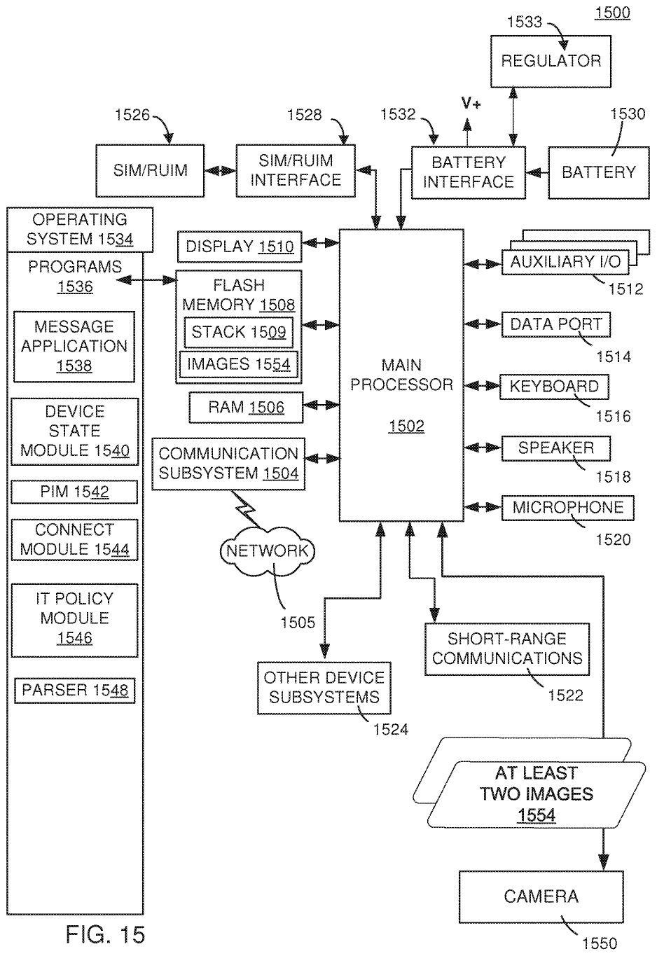

FIG. 3 is a block diagram of a fusion control system 300, according to an implementation. In fusion control system 300, a processor 302 controls all or some of the electrical components in FIG. 3. Examples of the processor 302 include processor 1302 in FIG. 13, controller chip 1404 in FIG. 14 or main processor 1502 in FIG. 15. In some implementations, the method in FIG. 11 or FIG. 12 is performed by processor 302 to control components in the fusion control system 300, components such as the vacuum pump 134, fuel injector 140, vacuum port 141, fuel tank 144, gas injector 146, gas tank 150, gas sensor 154, pre-ionizer 160, electrical source 164, electrical switch 166, electrical source 174 and/or the electrical sink 176.

FIG. 4 is an isometric diagram of a half-shell 400 of a six-coil torsatron operable in the fusion confinement device in FIG. 1, according to an implementation. The half-shell 400 is the first half-shell 114 or the second half-shell 116 in FIG. 1.

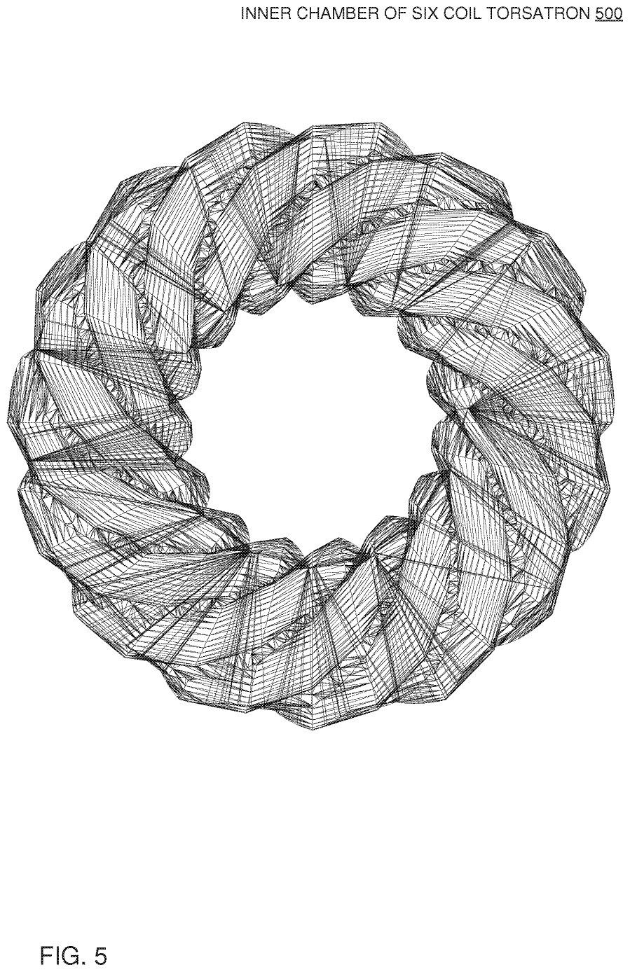

FIG. 5-9 are isometric diagrams of a six-coil torsatron operable in the fusion confinement device 102 in FIG. 2, according to an implementation. The diagrams in FIG. 5-9 show the approximate contours of the outer perimeter of the inner chamber 118 of the fusion confinement device 102 in FIG. 2. The diagrams in FIG. 5-9 show a theta pinch device in which the magnetic field runs down the axis of the inner chamber, while the electric field is in the azimuthal direction.

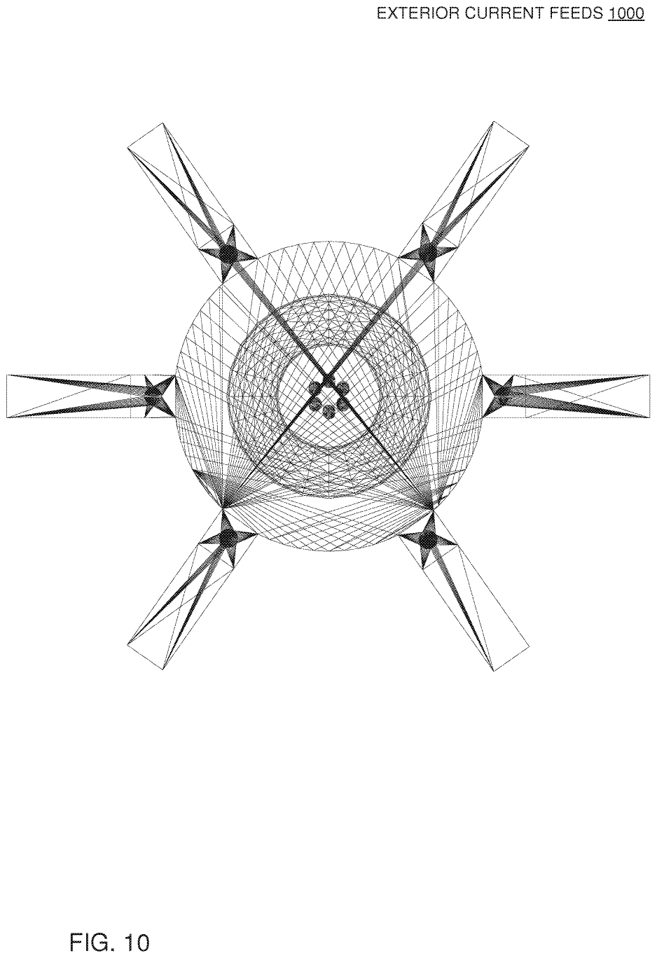

FIG. 10 is an isometric diagram of a six-lead exterior current feed configuration of a fusion confinement device 1000, according to an implementation. The configuration shown in FIG. 10 is suitable for use by the fusion confinement device 110 in FIG. 2.

### Method Implementations

In the previous section, apparatus of the operation of an implementation was described. In this section, the particular methods performed by the apparatus in FIGS. 1-10 and 16-39 of such an implementation are described by reference to a series of flowcharts.

FIG. 11 is a flowchart of a method 1100 to control a pulsed clam-shell housing fusion system, according to an implementation. Method 1100 provides control of a clam-shell housing fusion system having a rifled toroidal theta pinch (RTTP). Method 1100 can be performed multiple times in quick succession, in order to pulse fusion reactions, in comparison to steady-state fusion reactors which maintain a state of constant fusion reactions over much longer periods of time.

Method 1100 includes forming 1110 a vacuum in an inner chamber of a fusion confinement device. When block 1110 is performed for the first time after an absence of activity of at least a few minutes, if not a few days or few months, block 1110 vents the inner chamber to clear helium4 ash, thus preparing the fusion confinement device for a new pulse of fusion reaction.

Method 1100 thereafter includes adding 1120 a deuterium-helium3 mix of fuel to the inner chamber of the fusion confinement device. In one implementation, the total length of time to perform blocks 1110 and 1120 for the first time is about 5 μs (about 0.000005 second), thereafter, the length of time to perform blocks 1110 and 1120 is about 6 μs (about 0.000006 second).

Method 1100 thereafter includes energizing 1130 a first half-shell of the fusion confinement device, which energizes a coil, leading to an intense magnetic field at the walls of the rifled toroidal chamber, thereby forming and pushing a plasma inward. In one implementation, the length of time to perform block 1130 is about 5 μs (about 0.000005 second). Thereafter, a shock wave forms in the plasma on walls of the inner chamber and implodes inward toward a magnetic field on the outside of the plasma shockwave. In one implementation, the length of time to form the shock wave and implode the plasma shockwave is about 5 μs (about 0.000005 second). Thereafter, shock waves collide in the center of the inner chamber, thereby shock heating the plasma to fusion temperatures of between 100,000,000 degrees K and 150,000,000 degrees K for deuterium-tritium fuel, fusion temperatures of between 600,000,000 degrees K and 1,000,000,000 degrees K for Helium3 and deuterium fuel and fusion temperatures of between 600,000,000 degrees K and 700,000,000 degrees K for a Helium3 fuel. In one implementation, the length of time for the shock waves to collide and for the shock heating to occur is about 5 μs (about 0.000005 second). Thereafter, the plasma relaxes into stable magnetic-plasma equilibrium. In one implementation, the length of time for the plasma to relax is about 5 μs (about 0.000005 second). Thereafter, the fuel in the plasma undergoes fusion reaction and expands pushing against the magnetic field to force the magnetic back into the walls, thereby generating electricity to recharge the electrical source 174 of the EM foil 112 and the coil 202, at block 1140. In one implementation, the length of time of the fusion reaction is about 1 ms (about 0.0010 second).

In some implementations, the energizing 1130 of the first half-shell of the fusion confinement device is continued during the formation of the intense magnetic field, the formation and pushing of the plasma inward, the formation of the shock wave in the plasma, the implosion of the plasma inward toward the magnetic field, the collision of the shock waves and the shock heating of the plasma to fusion temperatures and relaxation of the plasma and until the beginning of the fusion reaction.

Performance of the blocks, 1110, 1120, 1130 and 1140 in FIG. 11 produces a pulse of fusion reaction. One pulse of fusion reaction is the performance of blocks 1110, 1120, 1130 and 1140. The time of one pulse is approximately 1 ms (about 0.001 second), thus in the method 1100 in FIG. 11, the number of fusion pulses that can be performed in one second is approximately 1000. In some implementations, 60 pulses is performed each second.

At block 1150, when no further pulsing (blocks 1110, 1120, 1130, and 1140) is required or desired, the method ends, otherwise, the method 1100 is repeated starting at block 1110.

FIG. 12 is a flowchart of a method 1200 to control a pulsed clam-shell housing fusion system, according to an implementation. Method 1200 provides control of a clam-shell housing fusion system having a rifled toroidal theta pinch (RTTP), such as clam-shell housing fusion systems 100 and 200. Method 1200 can be performed multiple times in quick succession, in order to pulse fusion reactions, in comparison to steady-state fusion reactors which maintain a state of constant fusion reactions over much longer periods of time.

Method 1200 includes forming 1210 a vacuum in an inner chamber 118 of fusion confinement device 110 in FIG. 1 and FIG. 2. When block 1210 is performed for the first time after an absence of activity of at least a few minutes, if not a few days or few months, block 1210 vents the inner chamber 118 to clear helium4 ash, thus preparing the fusion confinement device for a new pulse of fusion reaction.

Method 1200 thereafter includes adding 1220 a deuterium-helium3 mix of fuel to the inner chamber 118 of the fusion confinement device 110 in FIG. 1 or FIG. 2. In one implementation, the total length of time to perform blocks 1210 and 1220 for the first time is about 5 μs (about 0.000005 second), thereafter, the length of time to perform blocks 1210 and 1220 is about 6 μs (about 0.000006 second).

Method 1200 thereafter includes energizing 1230 a first half-shell of the fusion confinement device 110, which energizes an EM foil 152, leading to an intense magnetic field at the walls of the rifled toroidal chamber, thereby forming and pushing a plasma inward. In one implementation, the length of time to perform block 1230 is about 5 μs (about 0.000005 second). Thereafter, a shock wave forms in the plasma on walls of the inner chamber and implodes inward toward a magnetic field on the outside of the plasma shockwave. In one implementation, the length of time to form the shock wave and implode the plasma shockwave is about 5 μs (about 0.000005 second). Thereafter, shock waves collide in the center of the inner chamber 118, thereby shock heating the plasma to fusion temperatures of between 100,000,000 degrees K and 150,000,000 degrees K for deuterium-tritium fuel, fusion temperatures of between 600,000,000 degrees K and 1,000,000,000 degrees K for Helium3 and deuterium fuel and fusion temperatures of between 600,000,000 degrees K and 700,000,000 degrees K for a Helium3 fuel. In one implementation, the length of time for the shock waves to collide and for the shock heating to occur is about 5 μs (about 0.000005 second). Thereafter, the plasma relaxes into stable magnetic-plasma equilibrium. In one implementation, the length of time for the plasma to relax is about 5 μs (about 0.000005 second). Thereafter, the fuel in the plasma undergoes fusion reaction and expands pushing against the magnetic field to force the magnetic back into the walls, thereby generating electricity to recharge the EM foil power supply, at block 1240. In one implementation, the length of time of the fusion reaction is about 1 ms (about 0.0010 second).

In some implementations, the energizing 1230 of the first half-shell of the fusion confinement device 110 is continued during the formation of the intense magnetic field, the formation and pushing of the plasma inward, the formation of the shock wave in the plasma, the implosion of the plasma inward toward the magnetic field, the collision of the shock waves and the shock heating of the plasma to fusion temperatures and relaxation of the plasma and until the beginning of the fusion reaction.

Performance of the blocks, 1210, 1220, 1230 and 1240 in FIG. 12 produces a pulse of fusion reaction. One pulse of fusion reaction is the performance of blocks 1210, 1220, 1230 and 1240. The time of one pulse is approximately 1 ms (about 0.001 second), thus in the method 1200 in FIG. 12, the number of fusion pulses that can be performed in one second is approximately 1000. In some implementations, 60 pulses is performed each second.

At block 1250, when no further pulsing (blocks 1210, 1220, 1230, and 1240) is required or desired, the method ends, otherwise, the method 1200 is repeated starting at block 1210.

In some implementations, methods 1100 and 1200 are implemented as a sequence of instructions which, when executed by a processor, such as processor 1302 in FIG. 13, controller chip 1404 in FIG. 14 or main processor 1502 in FIG. 15, cause the processor to perform the respective method. In other implementations, methods 1100 and 1200 are implemented as a computer-accessible medium having executable instructions capable of directing a processor, such as such as processor 1302 in FIG. 13, controller chip 1404 in FIG. 14 or main processor 1502 in FIG. 15, to perform the respective method. In varying implementations, the medium is a magnetic medium, an electronic medium, or an optical medium.

### Hardware and Operating Environment

FIG. 13 is a block diagram of a fusion system control computer 1300, according to an implementation. The fusion system control computer 1300 includes a processor 1302 (such as a Pentium III processor from Intel Corp. in this example) which includes dynamic and static ram and non-volatile program read-only-memory (not shown), operating memory 1304 (SDRAM in this example), communication ports 1306 (e.g, RS-232 1308 COM1/2 or Ethernet 1310), and a data acquisition circuit 1312 with analog inputs 1314 and outputs and digital inputs and outputs 1316.

In some implementations of the fusion system control computer 1300, the processor 1302 and the operating memory 1304 are coupled through a bridge 1318. In some implementations of the fusion system control computer 1300, the bridge 1318 includes a video port 1320 having display outputs 1322 and 1324.

In some implementations of the fusion system control computer 1300, the ports communication ports 1306 are coupled through a bridge 1326 and a bus 1328 to the bridge 1318. In some implementations of the fusion system control computer 1300, the RS-232 1308 communication port 1306 also includes an integrated drive electronics (IDE) port 1330 such as an ultra direct memory access 33 (UDMA33) port, and universal serial bus (USB) ports 1332, and a PS/2 keyboard and mouse port 1334. In some implementations of the fusion system control computer 1300, a port 1336 for audio, microphone, line and auxiliary devices is coupled through a coder/decoder (CODEC) 1338 to the bridge 1326.

In some implementations of the fusion system control computer 1300, the data acquisition circuit 1312 is also coupled to counter timer ports 1340 and watchdog timer ports 1342. In some implementations of the fusion system control computer 1300, an RS-232 port 1344 is coupled through a universal asynchronous receiver/transmitter (UART) 1346 to the bridge 1326.

In some implementations of the fusion system control computer 1300, an industry standard architecture (ISA) bus expansion port is coupled to the bridge 1326. In some implementations of the fusion system control computer 1300, the Ethernet port 1310 is coupled to the bus 1328 through an Ethernet controller 1350 and a magnetics 1352.

FIG. 14 is a block diagram of a data acquisition circuit 1400 of fusion system control computer 1300 in FIG. 13, according to an implementation. The data acquisition circuit is one example of the data acquisition circuit 1312 in FIG. 13 above. Some implementations of the data acquisition circuit 1400 provide 16-bit A/D performance with input voltage capability up to +/−10V, and programmable input ranges.

The data acquisition circuit 1400 includes a bus 1402, such as a conventional PC/104 bus. The data acquisition circuit 1400 is operably coupled to a controller chip 1404. Some implementations of the controller chip 1404 include an analog/digital first-in/first-out (FIFO) buffer 1406 that is operably coupled to controller logic 1408. In some implementations of the data acquisition circuit 1400, the FIFO 1406 receives signal data from and analog/digital converter (ADC) 1410, which exchanges signal data with a programmable gain amplifier 1412, which receives data from a multiplexer 1414, which receives signal data from analog inputs 1416.

In some implementations of the data acquisition circuit 1400, the controller logic 1408 sends signal data to the ADC 1410 and a digital/analog converter (DAC) 1418. The DAC 1418 sends signal data to analog outputs. In some implementations of the data acquisition circuit 1400, the controller logic 1408 receives signal data from an external trigger 1422.

In some implementations of the data acquisition circuit 1400, the controller chip 1404 includes a 24-bit counter/timer 1424 that receives signal data from a +10 component 1426 and exchanges signal data with a “CTR 0” 1428. In some implementations of the data acquisition circuit 1400, the controller chip 1404 includes a 16-bit counter/timer 1430 that receives signal data from a +100 component 1432 and exchanges signal data with a “CTR 1” 1428. The 24-bit counter/timer 1424, the +10 component 1426, the 16-bit counter/timer 1430 and the +100 component 1432 all receive signal data from a oscillator (OSC) 1436.

In some implementations of the data acquisition circuit 1400, the controller chip 1404 includes a digital input/output (I/O) component 1438 that sends digital signal data to “port C” 1440, “port B” 1442 and “port A” 1444.

In some implementations of the data acquisition circuit 1400, the controller logic 1408 sends signal data to the bus 1402 via a control line 1446 and an interrupt line 1448. In some implementations of the data acquisition circuit 1400, the controller logic 1408 exchanges signal data to the bus 1402 via a transceiver 1450. In some implementations of the data acquisition circuit 1400, the bus supplies +5 volts of electricity to a DC-to-DC converter 1452, that in turn supplies +15V and −15V of electricity.

Some implementations of the data acquisition circuit 1400 include 4 12-bit D/A channels, 24 programmable digital I/O lines, and two programmable counter/timers. Placement of the analog circuitry away from the high-speed digital logic ensures low-noise performance for important applications. Some implementations of the data acquisition circuit 1400 are fully supported by operating systems that include DOS™ Linux™, RTLinux™, QNX™, Windows 98/NT/2000/XP/CE™, and VxWorks™ to simplify application development.

FIG. 15 is a block diagram of a fusion reactor control mobile device 1500, according to an implementation. The fusion reactor control mobile device 1500 includes a number of components such as a main processor 1502 that controls the overall operation of the fusion reactor control mobile device 1500. Communication functions, including data and voice communications, are performed through a communication subsystem 1504. The communication subsystem 1504 receives messages from and sends messages to a wireless network 1505. In this exemplary implementation of the fusion reactor control mobile device 1500, the communication subsystem 1504 is configured in accordance with the Global System for Mobile Communication (GSM), General Packet Radio Services (GPRS) standards, 3G, 4G, 5G and/or 6G. It will also be understood by persons skilled in the art that the implementations described herein are intended to use any other suitable standards that are developed in the future. The wireless link connecting the communication subsystem 1504 with the wireless network 1505 represents one or more different Radio Frequency (RF) channels, operating according to defined protocols specified for 4G or 5G communications. With newer network protocols, these channels are capable of supporting both circuit switched voice communications and packet switched data communications.

Although the wireless network 1505 associated with fusion reactor control mobile device 1500 is a GSM/GPRS, 3G, 4G, 5G and/or 6G wireless network in one exemplary implementation, other wireless networks may also be associated with the fusion reactor control mobile device 1500 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks, 3G, 4G, 5G and/or 6G. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems.

The main processor 1502 also interacts with additional subsystems such as a Random Access Memory (RAM) 1506, a flash memory 1508, a display 1510, an auxiliary input/output (I/O) subsystem 1512, a data port 1514, a keyboard 1516, a speaker 1518, a microphone 1520, short-range communications 1522 and other device subsystems 1524.

Some of the subsystems of the fusion reactor control mobile device 1500 perform communication-related functions, whereas other subsystems may provide “resident” or on-device functions. By way of example, the display 1510 and the keyboard 1516 may be used for both communication-related functions, such as entering a text message for transmission over the wireless network 1505, and device-resident functions such as a calculator or task list.

The fusion reactor control mobile device 1500 can send and receive communication signals over the wireless network 1505 after required network registration or activation procedures have been completed. Network access is associated with a subscriber or user of the fusion reactor control mobile device 1500. To identify a subscriber, the fusion reactor control mobile device 1500 requires a SIM/RUIM card 1526 (i.e. Subscriber Identity Module or a Removable User Identity Module) to be inserted into a SIM/RUIM interface 1528 in order to communicate with a network. The SIM card or RUIM 1526 is one type of a conventional “smart card” that can be used to identify a subscriber of the fusion reactor control mobile device 1500 and to customize the fusion reactor control mobile device 1500, among other aspects. Without the SIM card 1526, the fusion reactor control mobile device 1500 is not fully operational for communication with the wireless network 1505. By inserting the SIM card/RUIM 1526 into the SIM/RUIM interface 1528, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 1526 includes a processor and memory for storing information. Once the SIM card/RUIM 1526 is inserted into the SIM/RUIM interface 1528, it is coupled to the main processor 1502. In order to identify the subscriber, the SIM card/RUIM 1526 can include some user parameters such as an International Mobile Subscriber Identity (IMSI). An advantage of using the SIM card/RUIM 1526 is that a subscriber is not necessarily bound by any single physical mobile device. The SIM card/RUIM 1526 may store additional subscriber information for a mobile device as well, including datebook (or calendar) information and recent call information. Alternatively, user identification information can also be programmed into the flash memory 1508.

The fusion reactor control mobile device 1500 is a battery-powered device and includes a battery interface 1532 for receiving one or more rechargeable batteries 1530. In one or more implementations, the battery 1530 can be a smart battery with an embedded microprocessor. The battery interface 1532 is coupled to a regulator 1533, which assists the battery 1530 in providing power V+ to the fusion reactor control mobile device 1500. Although current technology makes use of a battery, future technologies such as micro fuel cells may provide the power to the fusion reactor control mobile device 1500.

The fusion reactor control mobile device 1500 also includes an operating system 1534 and software components 1536 to 1548 which are described in more detail below. The operating system 1534 and the software components 1536 to 1548 that are executed by the main processor 1502 are typically stored in a persistent store such as the flash memory 1508, which may alternatively be a read-only memory (ROM) or similar storage element (not shown). Those skilled in the art will appreciate that portions of the operating system 1534 and the software components 1536 to 1548, such as specific device applications, or parts thereof, may be temporarily loaded into a volatile store such as the RAM 1506. Other software components can also be included.

The subset of software components 1536 that control basic device operations, including data and voice communication applications, will normally be installed on the fusion reactor control mobile device 1500 during its manufacture. Other software applications include a message application 1538 that can be any suitable software program that allows a user of the fusion reactor control mobile device 1500 to send and receive electronic messages. Various alternatives exist for the message application 1538 as is well known to those skilled in the art. Messages that have been sent or received by the user are typically stored in the flash memory 1508 of the fusion reactor control mobile device 1500 or some other suitable storage element in the fusion reactor control mobile device 1500. In one or more implementations, some of the sent and received messages may be stored remotely from the device 1500 such as in a data store of an associated host system with which the fusion reactor control mobile device 1500 communicates.

The software applications can further include a device state module 1540, a Personal Information Manager (PIM) 1542, and other suitable modules (not shown). The device state module 1540 provides persistence, i.e. the device state module 1540 ensures that important device data is stored in persistent memory, such as the flash memory 1508, so that the data is not lost when the fusion reactor control mobile device 1500 is turned off or loses power.

The PIM 1542 includes functionality for organizing and managing data items of interest to the user, such as, but not limited to, e-mail, contacts, calendar events, voice mails, appointments, and task items. A PIM application has the ability to send and receive data items via the wireless network 1505. PIM data items may be seamlessly integrated, synchronized, and updated via the wireless network 1505 with the mobile device subscriber's corresponding data items stored and/or associated with a host computer system. This functionality creates a mirrored host computer on the fusion reactor control mobile device 1500 with respect to such items. This can be particularly advantageous when the host computer system is the mobile device subscriber's office computer system.

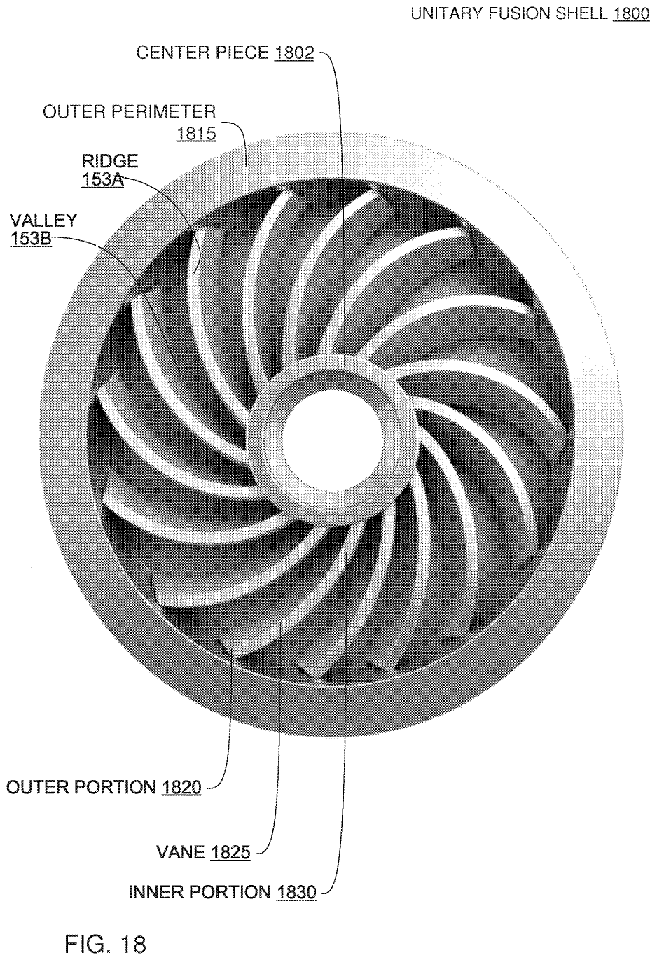

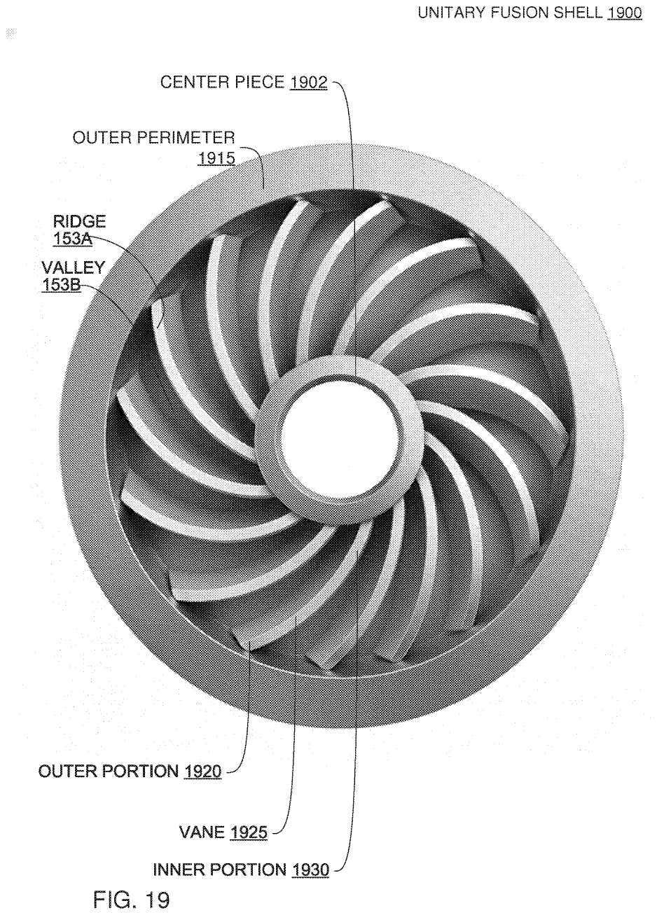

The fusion reactor control mobile device 1500 also includes a connect module 1544, and an IT policy module 1546. The connect module 1544 implements the communication protocols that are required for the fusion reactor control mobile device 1500 to communicate with the wireless infrastructure and any host system, such as an enterprise system, with which the fusion reactor control mobile device 1500 is authorized to interface. Examples of a wireless infrastructure and an enterprise system are given in FIGS. 18 and 19, which are described in more detail below.

The connect module 1544 includes a set of APIs that can be integrated with the fusion reactor control mobile device 1500 to allow the fusion reactor control mobile device 1500 to use any number of services associated with the enterprise system. The connect module 1544 allows the fusion reactor control mobile device 1500 to establish an end-to-end secure, authenticated communication pipe with the host system. A subset of applications for which access is provided by the connect module 1544 can be used to pass IT policy commands from the host system to the fusion reactor control mobile device 1500. This can be done in a wireless or wired manner. These instructions can then be passed to the IT policy module 1546 to modify the configuration of the device 1500. Alternatively, in some cases, the IT policy update can also be done over a wired connection.

The IT policy module 1546 receives IT policy data that encodes the IT policy. The IT policy module 1546 then ensures that the IT policy data is authenticated by the fusion reactor control mobile device 1500. The IT policy data can then be stored in the flash memory 1506 in its native form. After the IT policy data is stored, a global notification can be sent by the IT policy module 1546 to all of the applications residing on the fusion reactor control mobile device 1500. Applications for which the IT policy may be applicable then respond by reading the IT policy data to look for IT policy rules that are applicable.

The IT policy module 1546 can include a parser 1548, which can be used by the applications to read the IT policy rules. In some cases, another module or application can provide the parser. Grouped IT policy rules, described in more detail below, are retrieved as byte streams, which are then sent (recursively) into the parser to determine the values of each IT policy rule defined within the grouped IT policy rule. In one or more implementations, the IT policy module 1546 can determine which applications are affected by the IT policy data and send a notification to only those applications. In either of these cases, for applications that are not being executed by the main processor 1502 at the time of the notification, the applications can call the parser or the IT policy module 1546 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 1546 sends an acknowledgement back to the host system to indicate that the IT policy data was received and successfully applied.

Other types of software applications can also be installed on the fusion reactor control mobile device 1500. These software applications can be third party applications, which are added after the manufacture of the fusion reactor control mobile device 1500. Examples of third party applications include games, calculators, utilities, etc.

The additional applications can be loaded onto the fusion reactor control mobile device 1500 through at least one of the wireless network 1505, the auxiliary I/O subsystem 1512, the data port 1514, the short-range communications subsystem 1522, or any other suitable device subsystem 1524. This flexibility in application installation increases the functionality of the fusion reactor control mobile device 1500 and may provide enhanced on-device functions, communication-related functions, or both. For example, secure communication applications may enable electronic commerce functions and other such financial transactions to be performed using the fusion reactor control mobile device 1500.

The data port 1514 enables a subscriber to set preferences through an external device or software application and extends the capabilities of the fusion reactor control mobile device 1500 by providing for information or software downloads to the fusion reactor control mobile device 1500 other than through a wireless communication network. The alternate download path may, for example, be used to load an encryption key onto the fusion reactor control mobile device 1500 through a direct and thus reliable and trusted connection to provide secure device communication.

The data port 1514 can be any suitable port that enables data communication between the fusion reactor control mobile device 1500 and another computing device. The data port 1514 can be a serial or a parallel port. In some instances, the data port 1514 can be a USB port that includes data lines for data transfer and a supply line that can provide a charging current to charge the battery 1530 of the fusion reactor control mobile device 1500.

The short-range communications subsystem 1522 provides for communication between the fusion reactor control mobile device 1500 and different systems or devices, without the use of the wireless network 1505. For example, the subsystem 1522 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 1504 and input to the main processor 1502. The main processor 1502 will then process the received signal for output to the display 1510 or alternatively to the auxiliary I/O subsystem 1512. A subscriber may also compose data items, such as e-mail messages, for example, using the keyboard 1516 in conjunction with the display 1510 and possibly the auxiliary I/O subsystem 1512. The auxiliary subsystem 1512 may include devices such as: a touch screen, mouse, track ball, infrared fingerprint detector, or a roller wheel with dynamic button pressing capability. The keyboard 1516 is preferably an alphanumeric keyboard and/or telephone-type keypad. However, other types of keyboards may also be used. A composed item may be transmitted over the wireless network 1505 through the communication subsystem 1504.

For voice communications, the overall operation of the fusion reactor control mobile device 1500 is substantially similar, except that the received signals are output to the speaker 1518, and signals for transmission are generated by the microphone 1520. Alternative voice or audio I/O subsystems, such as a voice message recording subsystem, can also be implemented on the fusion reactor control mobile device 1500. Although voice or audio signal output is accomplished primarily through the speaker 1518, the display 1510 can also be used to provide additional information such as the identity of a calling party, duration of a voice call, or other voice call related information.

In some implementations, the fusion reactor control mobile device 1500 includes a camera 1550 receiving a plurality of images 1554 from and examining pixel-values of the plurality of images 1554.

### Unitary Design

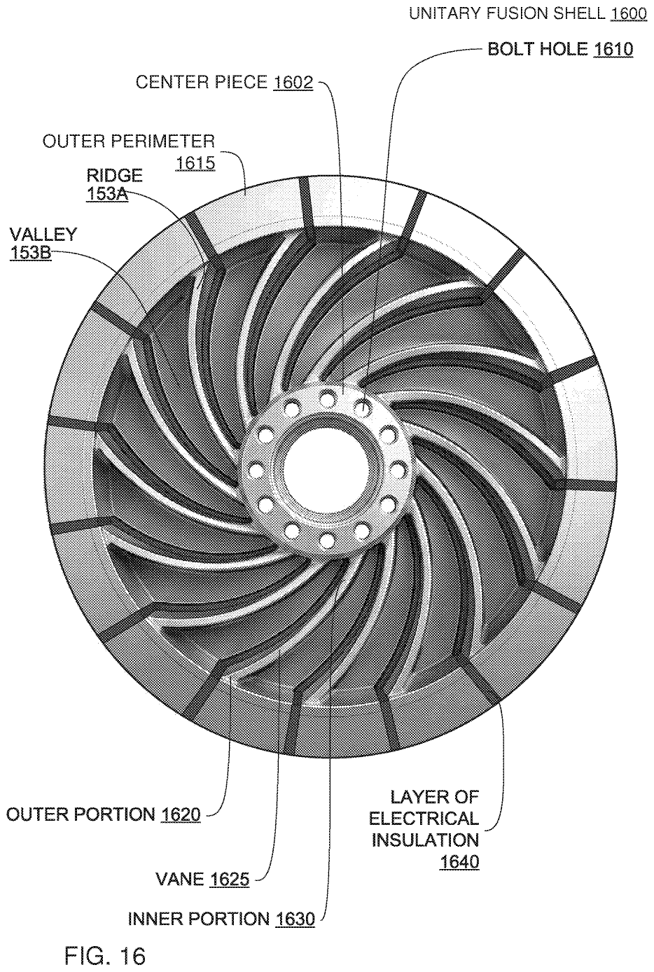

FIG. 16-39 show different variations of the topology of the interior chamber and the vanes that can be implemented between FIG. 16-39. Various implementations of different experimental unitary fusion systems can be made from various features in FIG. 16-39.

FIG. 16 is a top-down view cross section diagram of an experimental unitary fusion system 1600, according to an implementation. The experimental unitary fusion shell 1600 shows a cross-section view of one half of a unitary integrated housing for a unitary fusion system. The experimental unitary fusion shell 1600 includes a center piece 1605 that has holes (such as hole 1610) for accommodating bolts. In some implementations, an outer perimeter 1615 has no holes for accommodating bolts. The outer portion (such as outer portion 1620) of a plurality of vanes (such as vane 1625) are higher than an inner portion (such as inner portion 1630) of the vanes. In the implementation shown in FIG. 16, 15 sections of the shell are separated by a layer of electrical insulation 1640 (such as rubber). The electrical insulation 1640 extends radially around the experimental unitary fusion shell 1600 in order to electrically isolate each section of the experimental unitary fusion shell 1600. Each section is defined by each layer of electrical insulation 1640. Some implementations of the experimental unitary fusion shell 1600 includes as little as 1 section (and thus one layer of electrical insulation 1640. In the implementation shown in FIG. 16, there is one section for each vane 1650, and because there are 15 vanes 1625, there are 15 sections, although in other implementations different quantities of vanes can be used, such as 4, 10, 16, 24. A section can include a wide variety of a number of vanes per section; for example, 5 vanes can be included in each section, and where 15 vanes are included in the experimental unitary fusion shell 1600, then the experimental unitary fusion shell 1600 will include 3 sections.

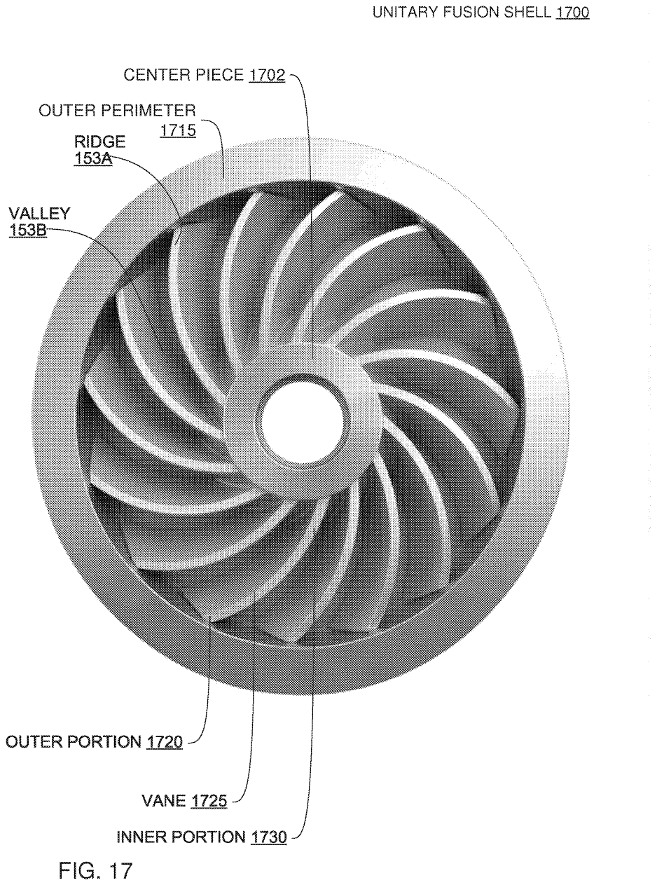

FIG. 17-39 show different variations of the topology of the vanes that can be implemented with FIG. 16.

FIG. 17 is a top-down view cross section diagram of an experimental unitary fusion shell 1700. The experimental unitary fusion shell 1700 shows one half of a unitary integrated unitary fusion system which includes a center piece 1705 that has no holes for accommodating bolts. An outer perimeter 1715 has no holes for accommodating bolts. An outer portion (such as outer portion 1720) of a plurality of vanes (such as vane 1725) are the same height as an inner portion (such as inner portion 1730) of the vanes. The number of the vanes is 15, although in other implementations different quantities of vanes can be used, such as 4, 10, 16, 24.

FIG. 18 is a top-down view cross section diagram of an experimental unitary fusion shell 1800. The experimental unitary fusion shell 1800 shows one half of a unitary integrated unitary fusion system which includes a center piece 1805 that has no holes for accommodating bolts. An outer perimeter 1815 has no holes for accommodating bolts. An outer portion (such as outer portion 1820) of a plurality of vanes (such as vane 1825) are the same height as an inner portion (such as inner portion 1830) of the vanes. The number of the vanes is 15, although in other implementations different quantities of vanes can be used, such as 4, 10, 16, 24.

FIG. 19 is a top-down view cross section diagram of an experimental unitary fusion shell 1900. The experimental unitary fusion shell 1900 shows one half of a unitary integrated unitary fusion system which includes a center piece 1905 that has no holes for accommodating bolts. An outer perimeter 1915 has no holes for accommodating bolts. An outer portion (such as outer portion 1920) of a plurality of vanes (such as vane 1925) are the same height as an inner portion (such as inner portion 1930) of the vanes. The number of the vanes is 15, although in other implementations different quantities of vanes can be used, such as 4, 10, 16, 24.

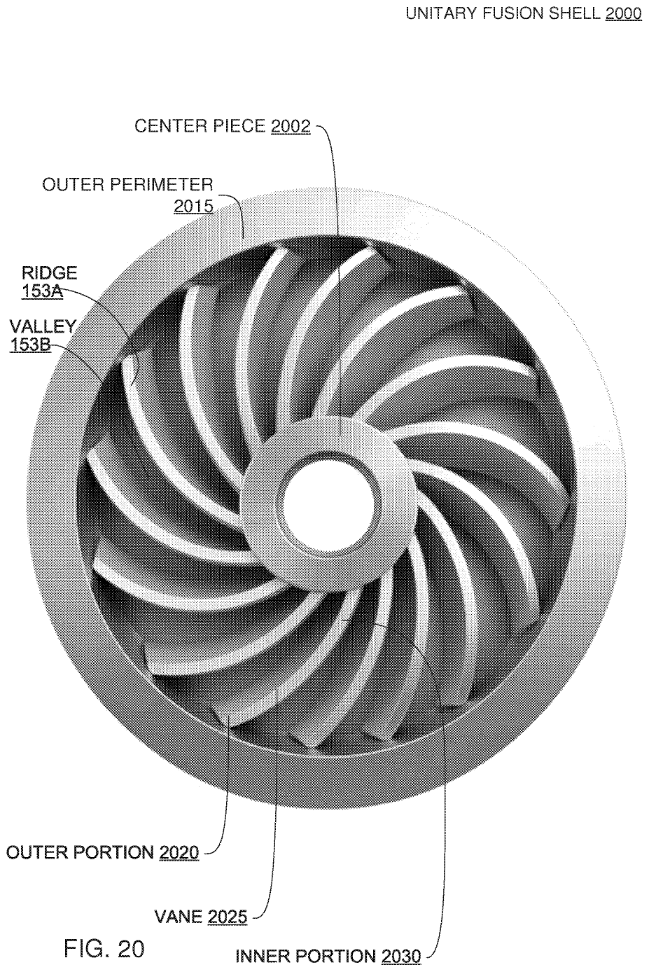

FIG. 20 is a top-down view cross section diagram of an experimental unitary fusion shell 2000. The experimental unitary fusion shell 2000 shows one half of a unitary integrated unitary fusion system which includes a center piece 2005 that has no holes for accommodating bolts. An outer perimeter 2015 has no holes for accommodating bolts. An outer portion (such as outer portion 2020) of a plurality of vanes (such as vane 2025) are the same height as an inner portion (such as inner portion 2030) of the vanes. The number of the vanes is 15, although in other implementations different quantities of vanes can be used, such as 4, 10, 16, 24.

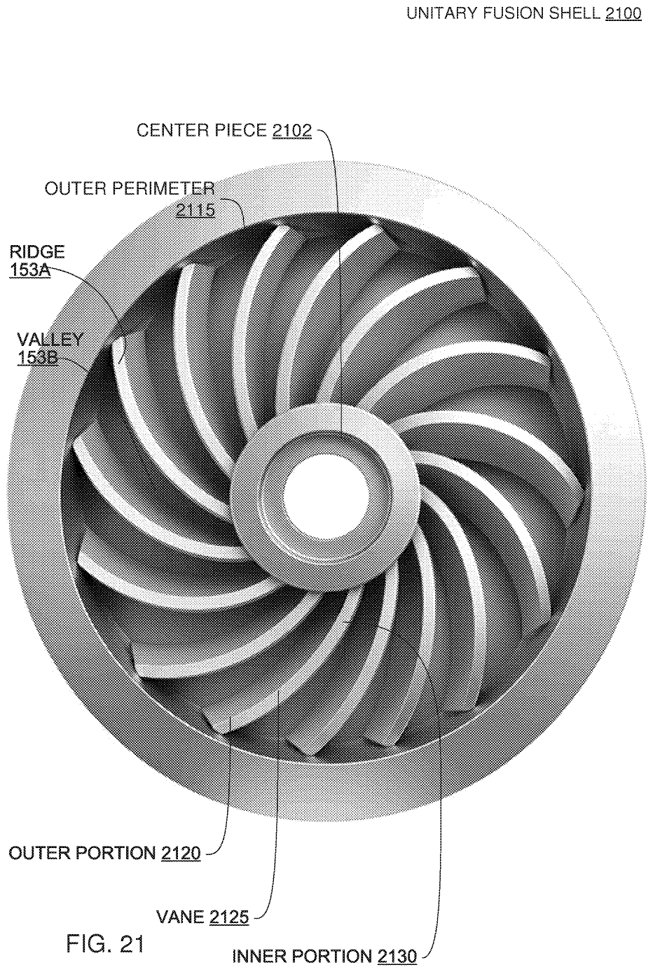

FIG. 21 is a top-down view cross section diagram of an experimental unitary fusion shell 2100. The experimental unitary fusion shell 2100 shows one half of a unitary integrated unitary fusion system which includes a center piece 2105 that has no holes for accommodating bolts. An outer perimeter 2115 has no holes for accommodating bolts. An outer portion (such as outer portion 2120) of a plurality of vanes (such as vane 2125) are the same height as an inner portion (such as inner portion 2130) of the vanes. The number of the vanes is 15, although in other implementations different quantities of vanes can be used, such as 4, 10, 16, 24.

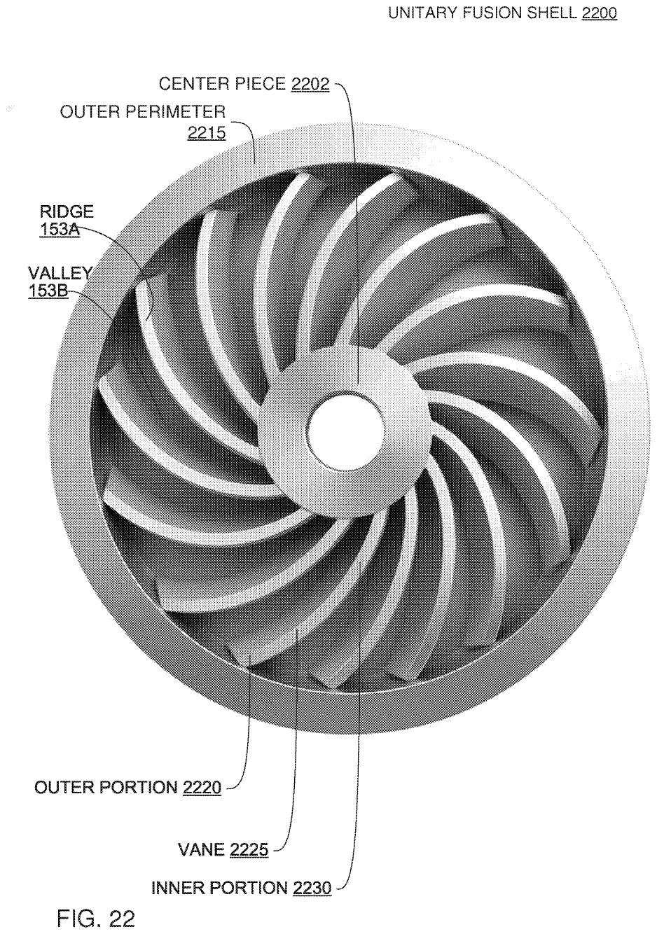

FIG. 22 is a top-down view cross section diagram of an experimental unitary fusion shell 2200. The experimental unitary fusion shell 2200 shows one half of a unitary integrated unitary fusion system which includes a center piece 2205 that has no holes for accommodating bolts. An outer perimeter 2215 has no holes for accommodating bolts. An outer portion (such as outer portion 2220) of a plurality of vanes (such as vane 2225) are the same height as an inner portion (such as inner portion 2230) of the vanes. The number of the vanes is 15, although in other implementations different quantities of vanes can be used, such as 4, 10, 16, 24.

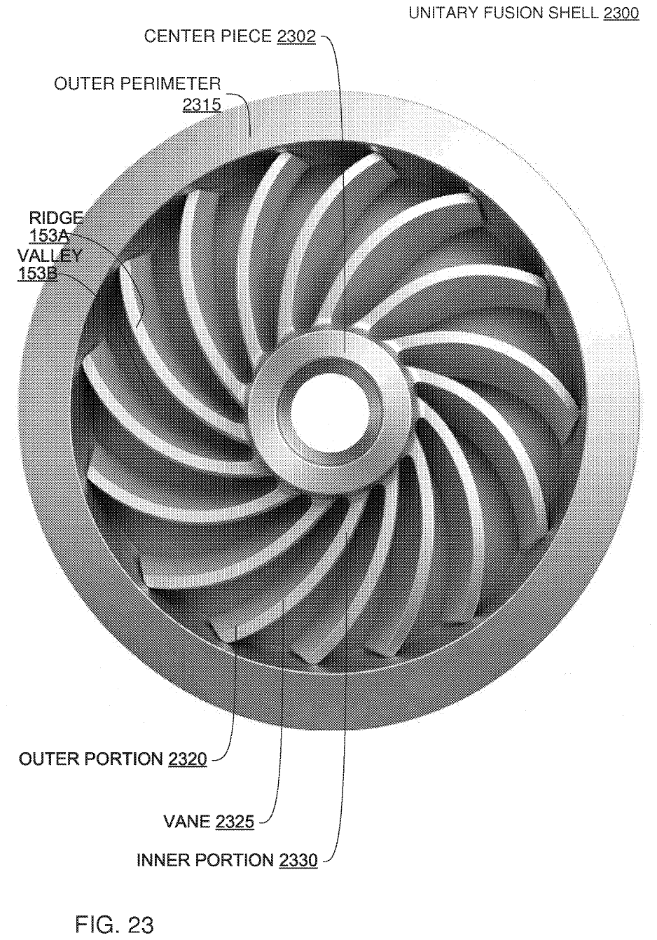

FIG. 23 is a top-down view cross section diagram of an experimental unitary fusion shell 2300. The experimental unitary fusion shell 2300 shows one half of a unitary integrated unitary fusion system which includes a center piece 2305 that has no holes for accommodating bolts. An outer perimeter 2315 has no holes for accommodating bolts. An outer portion (such as outer portion 2320) of a plurality of vanes (such as vane 2325) are the same height as an inner portion (such as inner portion 2330) of the vanes. The number of the vanes is 15, although in other implementations different quantities of vanes can be used, such as 4, 10, 16, 24.

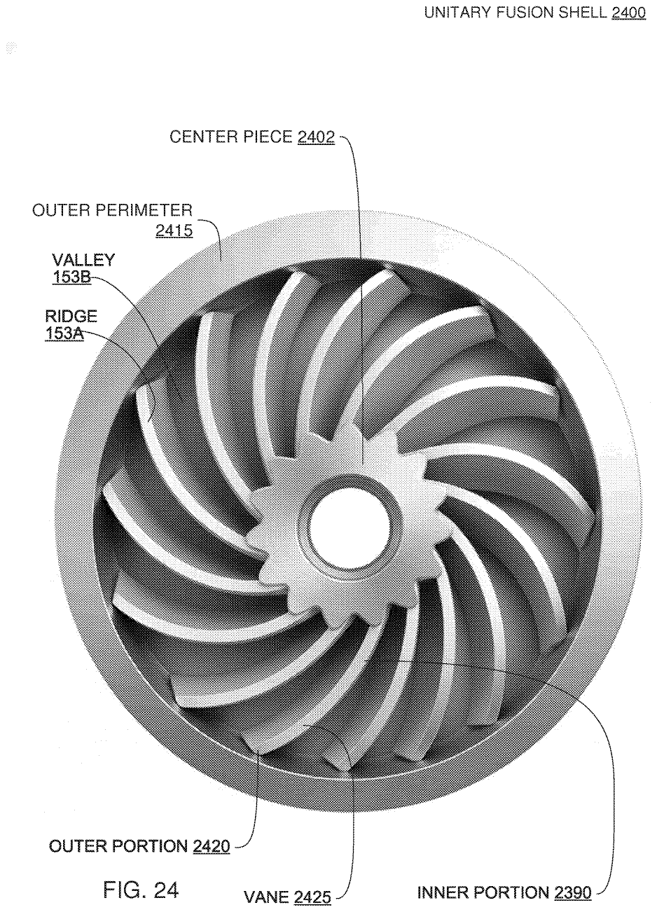

FIG. 24 is a top-down view cross section diagram of an experimental unitary fusion shell 2400. The experimental unitary fusion shell 2400 shows one half of a unitary integrated unitary fusion system which includes a center piece 2405 that has no holes for accommodating bolts. An outer perimeter 2415 has no holes for accommodating bolts. An outer portion (such as outer portion 2420) of a plurality of vanes (such as vane 2425) are the same height as an inner portion (such as inner portion 2430) of the vanes. The number of the vanes is 15, although in other implementations different quantities of vanes can be used, such as 4, 10, 16, 24.

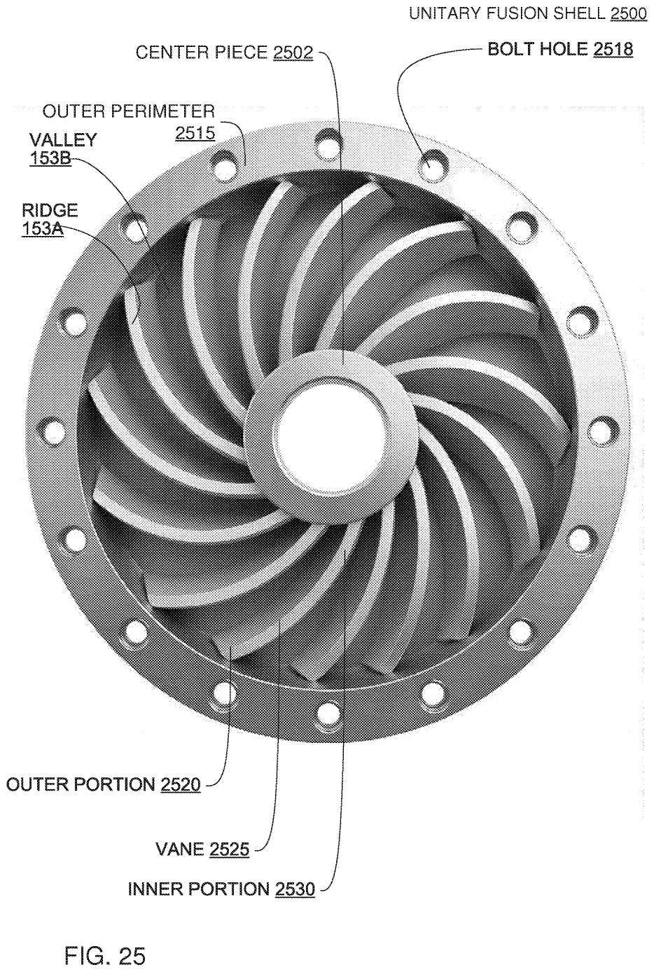

FIG. 25 is a top-down view cross section diagram of an experimental unitary fusion shell 2500. The experimental unitary fusion shell 2500 shows one half of a unitary integrated unitary fusion system which includes a center piece 2505 that has no holes for accommodating bolts. An outer perimeter 2515 has holes (such as hole 2518) for accommodating bolts. An outer portion (such as outer portion 2520) of a plurality of vanes (such as vane 2525) are the same height as an inner portion (such as inner portion 2530) of the vanes. The number of the vanes is 15, although in other implementations different quantities of vanes can be used, such as 4, 10, 16, 24.

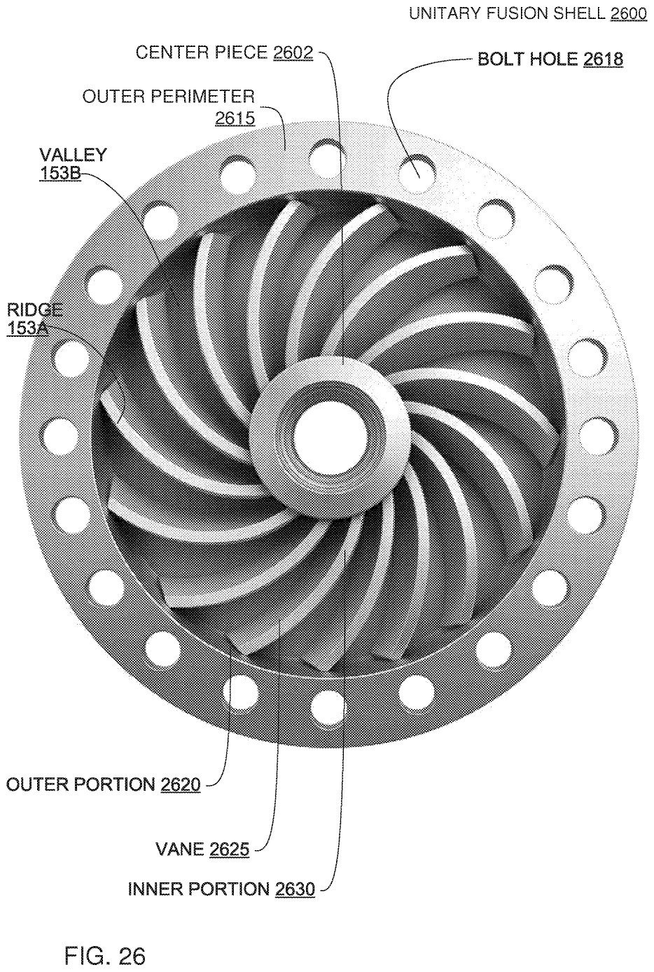

FIG. 26 is a top-down view cross section diagram of an experimental unitary fusion shell 2600. The experimental unitary fusion shell 2600 shows one half of a unitary integrated unitary fusion system which includes a center piece 2605 that has no holes for accommodating bolts. An outer perimeter 2615 has holes (such as hole 2618) for accommodating bolts. An outer portion (such as outer portion 2620) of a plurality of vanes (such as vane 2625) are the same height as an inner portion (such as inner portion 2630) of the vanes. The number of the vanes is 15, although in other implementations different quantities of vanes can be used, such as 4, 10, 16, 24.

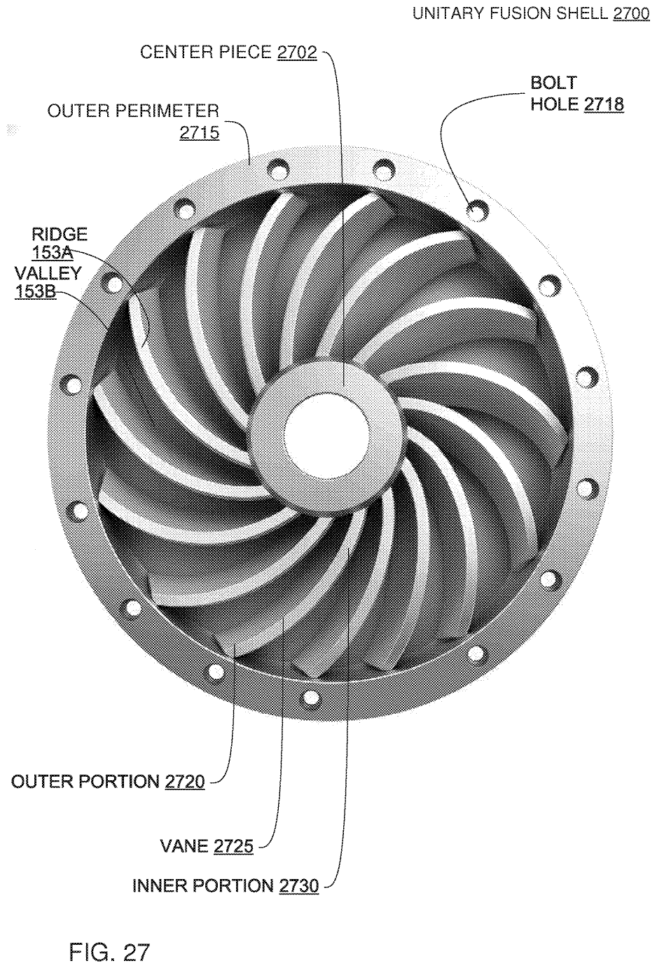

FIG. 27 is a top-down view cross section diagram of an experimental unitary fusion shell 2700. The experimental unitary fusion shell 2700 shows one half of a unitary integrated unitary fusion system which includes a center piece 2705 that has no holes for accommodating bolts. An outer perimeter 2715 has holes (such as hole 2718) for accommodating bolts. The outer portion of the vanes are the same height as an inner portion (such as inner portion 2730) of the vanes. The number of the vanes is 15, although in other implementations different quantities of vanes can be used, such as 4, 10, 16, 24.

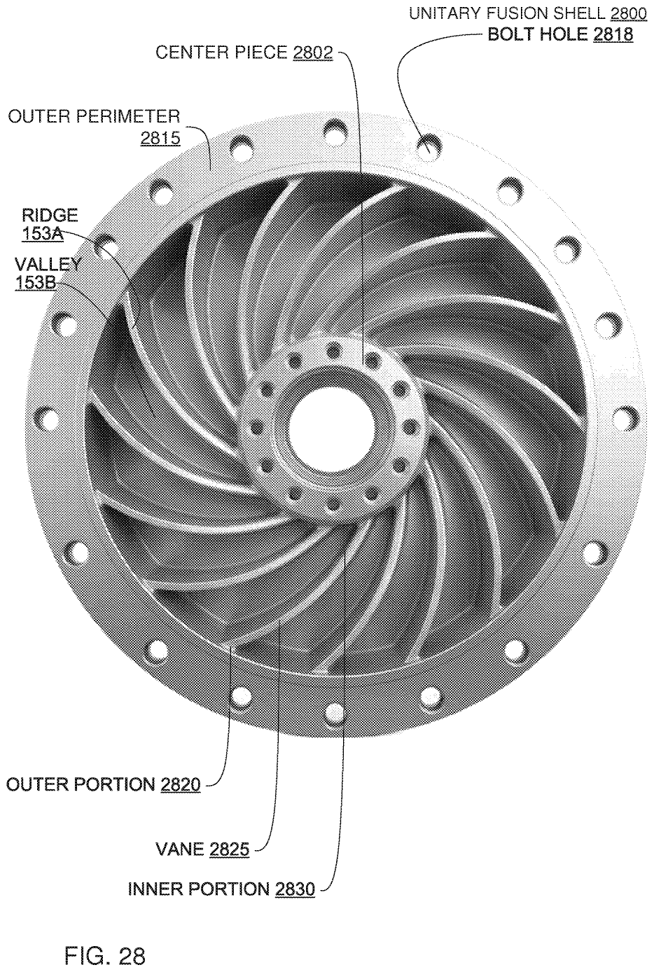

FIG. 28 is a top-down view cross section diagram of an experimental unitary fusion shell 2800. The experimental unitary fusion shell 2800 shows one half of a unitary integrated unitary fusion system which includes a center piece 2805 that has holes for accommodating bolts. An outer perimeter 2815 has holes (such as hole 2818) for accommodating bolts. An outer portion (such as outer portion 2820) of the vanes (such as vane 2825) are higher than an inner portion (such as inner portion 2830) of the vanes. The number of the vanes is 15, although in other implementations different quantities of vanes can be used, such as 4, 10, 16, 24. In implementations of the experimental unitary fusion shell 2800 having bolts that extend through the bolt holes in both the center piece 2802 and the outer perimeter 2815, the bolts provides strength in holding together the section(s) of the experimental unitary fusion shell 2800 and maintaining a pressure differential between of the chamber 118 and the exterior of the experimental unitary fusion shell 2800

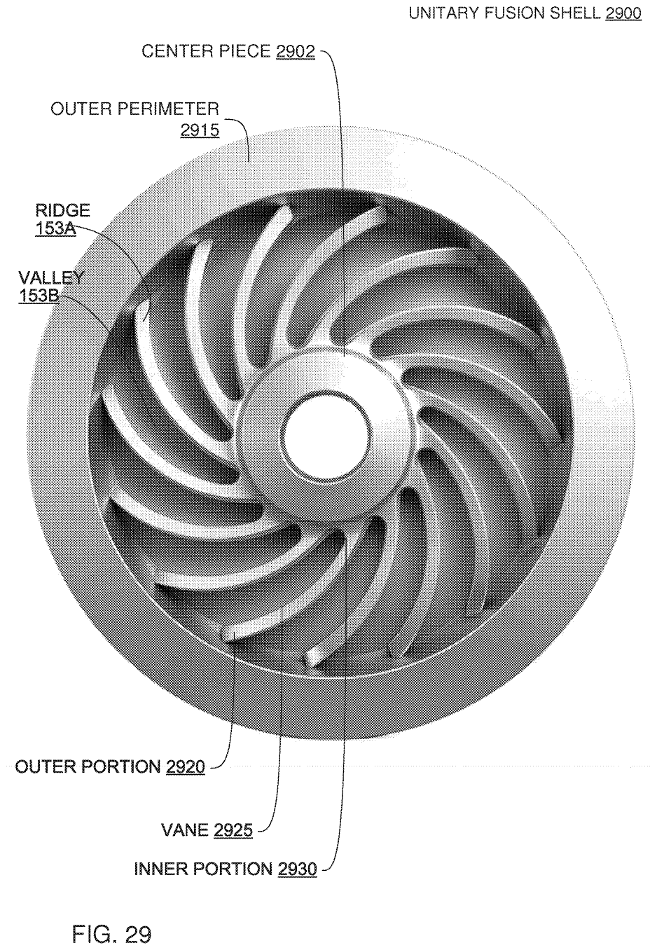

FIG. 29 is a top-down view cross section diagram of an experimental unitary fusion shell 2900. The experimental unitary fusion shell 2900 shows one half of a unitary integrated unitary fusion system which includes a center piece 2905 that has no holes for accommodating bolts. An outer perimeter 2915 has no holes for accommodating bolts. An outer portion (such as outer portion 2920) of the vanes (such as vane 2925) are higher than an inner portion (such as inner portion 2930) (such as inner portion 2930) of the vanes. The number of the vanes is 15, although in other implementations different quantities of vanes can be used, such as 4, 10, 16, 24.

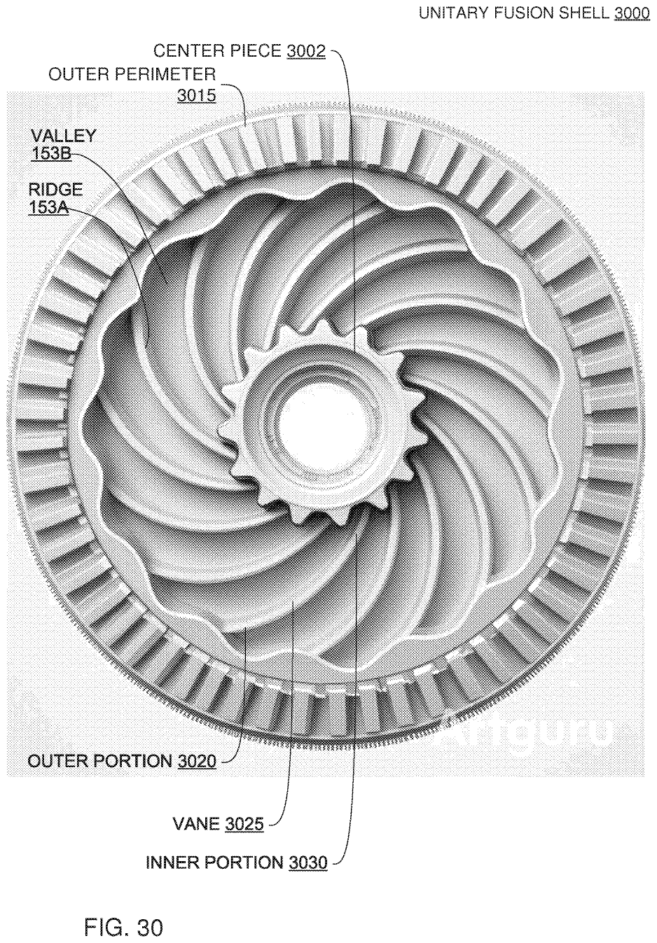

FIG. 30 is a top-down view cross section diagram of an experimental unitary fusion shell 3000. The experimental unitary fusion shell 3000 shows one half of a unitary integrated unitary fusion system which includes a center piece 3005 that has no holes for accommodating bolts. An outer perimeter 3015 has no holes for accommodating bolts. An outer portion (such as outer portion 3020) of the vanes (such as vane 3025) are higher than an inner portion (such as inner portion 3030) (such as inner portion 3030) of the vanes. The number of the vanes is 15, although in other implementations different quantities of vanes can be used, such as 4, 10, 16, 24.

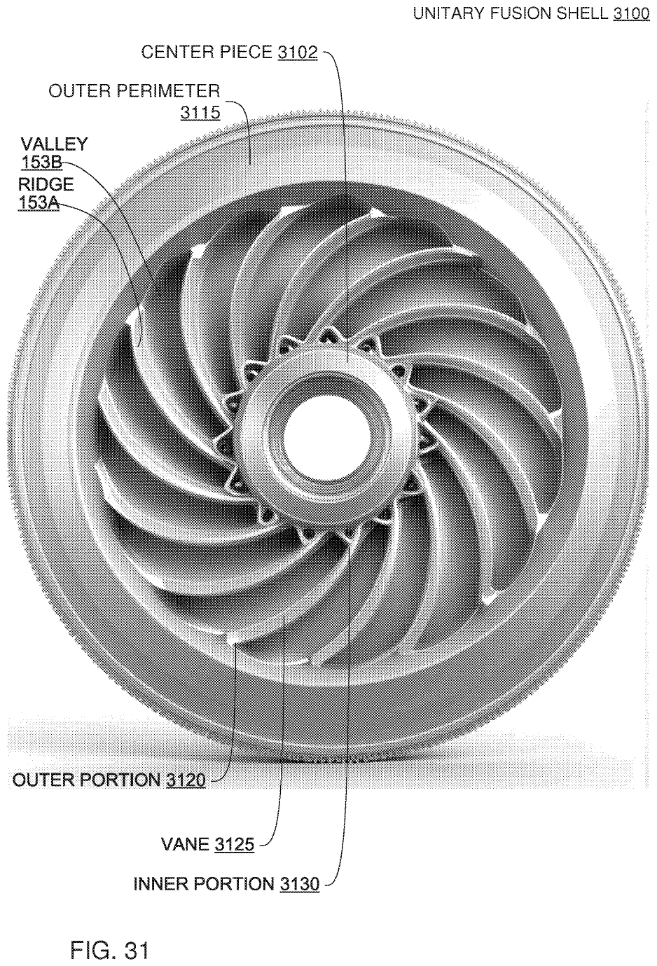

FIG. 31 is a top-down view cross section diagram of an experimental unitary fusion shell 3100. The experimental unitary fusion shell 3100 shows one half of a unitary integrated unitary fusion system which includes a center piece 3105 that has no holes for accommodating bolts. An outer perimeter 3115 has no holes for accommodating bolts. An outer portion (such as outer portion 3120) of the vanes (such as vane 3125) are higher than an inner portion (such as inner portion 3130) (such as inner portion 3130) of the vanes. The number of the vanes is 15, although in other implementations different quantities of vanes can be used, such as 4, 10, 16, 24.

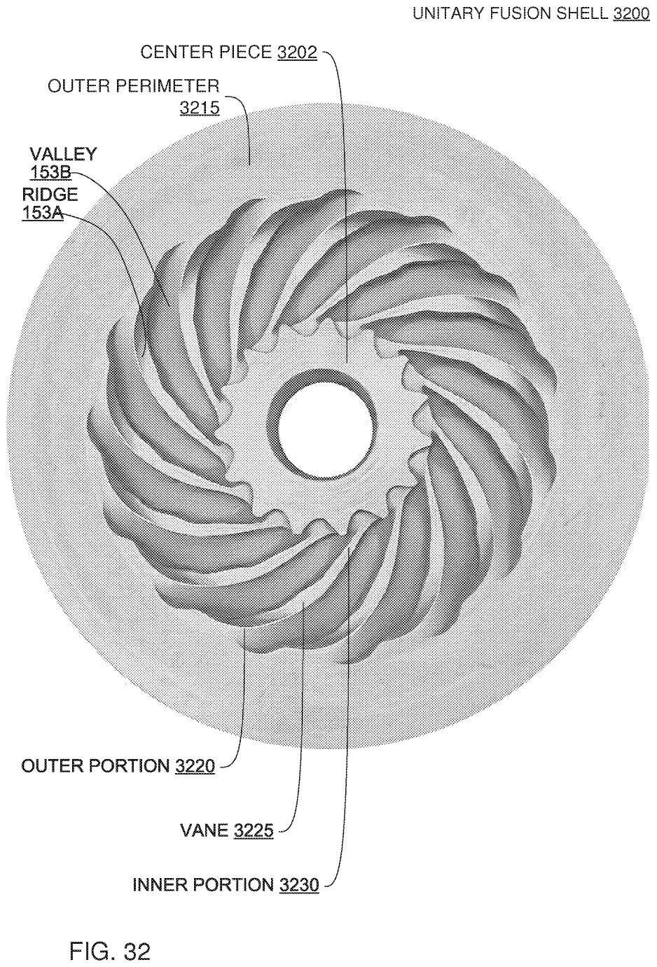

FIG. 32 is a top-down view cross section diagram of an experimental unitary fusion shell 3200. The experimental unitary fusion shell 3200 shows one half of a unitary integrated unitary fusion system which includes a center piece 3205 that has no holes for accommodating bolts. An outer perimeter 3215 has no holes for accommodating bolts. An outer portion (such as outer portion 3220) of the vanes (such as vane 3225) are higher than an inner portion (such as inner portion 3230) (such as inner portion 3230) of the vanes. The number of the vanes is 15, although in other implementations different quantities of vanes can be used, such as 4, 10, 16, 24.

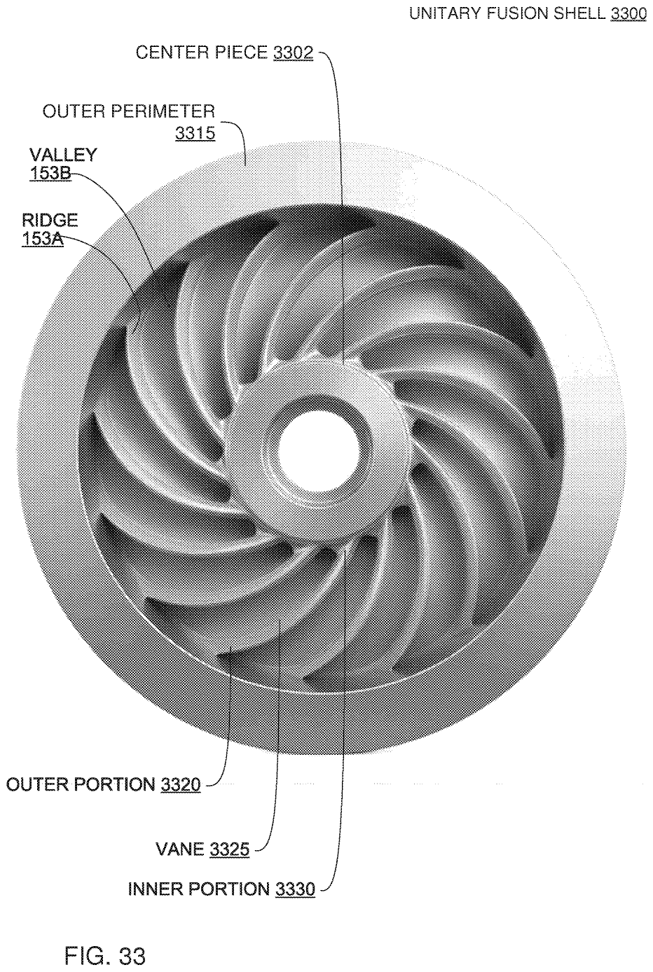

FIG. 33 is a top-down view cross section diagram of an experimental unitary fusion shell 3300. The experimental unitary fusion shell 3300 shows one half of a unitary integrated unitary fusion system which includes a center piece 3305 that has no holes for accommodating bolts. An outer perimeter 3315 has no holes for accommodating bolts. An outer portion (such as outer portion 3320) of the vanes (such as vane 3325) are higher than an inner portion (such as inner portion 3330) (such as inner portion 3330) of the vanes. The number of the vanes is 15, although in other implementations different quantities of vanes can be used, such as 4, 10, 16, 24.

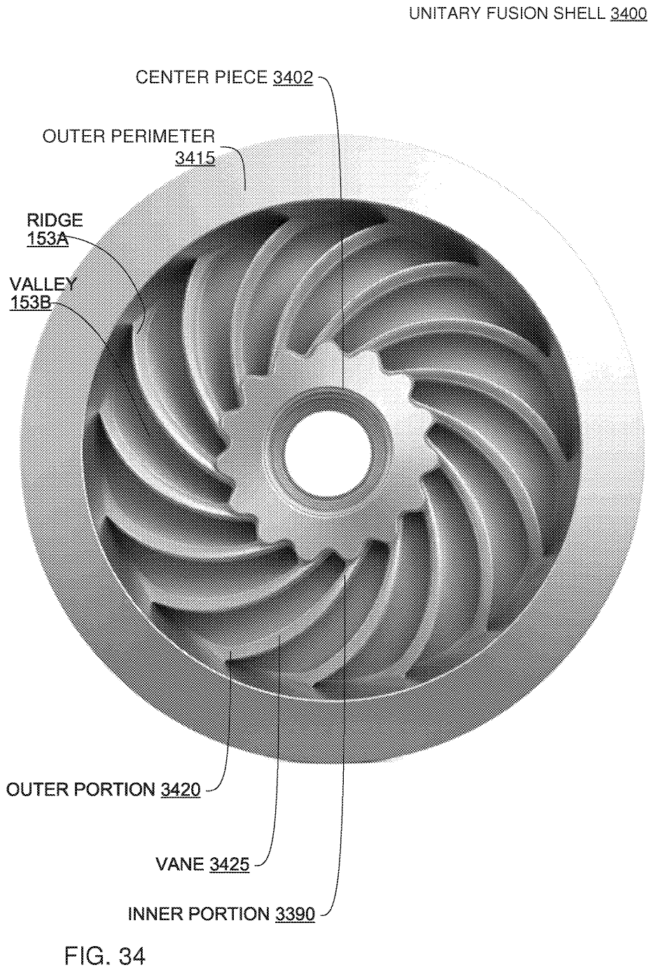

FIG. 34 is a top-down view cross section diagram of an experimental unitary fusion shell 3400. The experimental unitary fusion shell 3400 shows one half of a unitary integrated unitary fusion system which includes a center piece 3405 that has no holes for accommodating bolts. An outer perimeter 3415 has no holes for accommodating bolts. An outer portion (such as outer portion 3420) of the vanes (such as vane 3425) are higher than an inner portion (such as inner portion 3430) (such as inner portion 3430) of the vanes. The number of the vanes is 15, although in other implementations different quantities of vanes can be used, such as 4, 10, 16, 24.

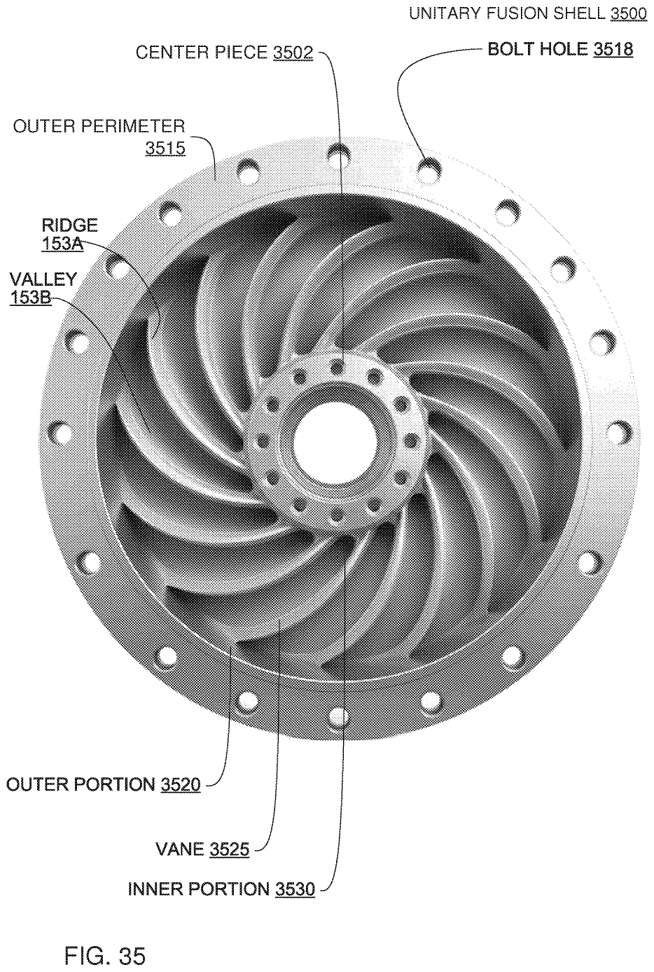

FIG. 35 is a top-down view cross section diagram of an experimental unitary fusion shell 3500. The experimental unitary fusion shell 3500 shows one half of a unitary integrated unitary fusion system which includes a center piece 3505 that has holes for accommodating bolts. An outer perimeter 3515 has holes (such as hole 3518) for accommodating bolts. An outer portion (such as outer portion 3920) of the vanes (such as vane 3925) are higher than an inner portion (such as inner portion 3930) (such as inner portion 3930) of the vanes. The number of the vanes is 15, although in other implementations different quantities of vanes can be used, such as 4, 10, 16, 24.

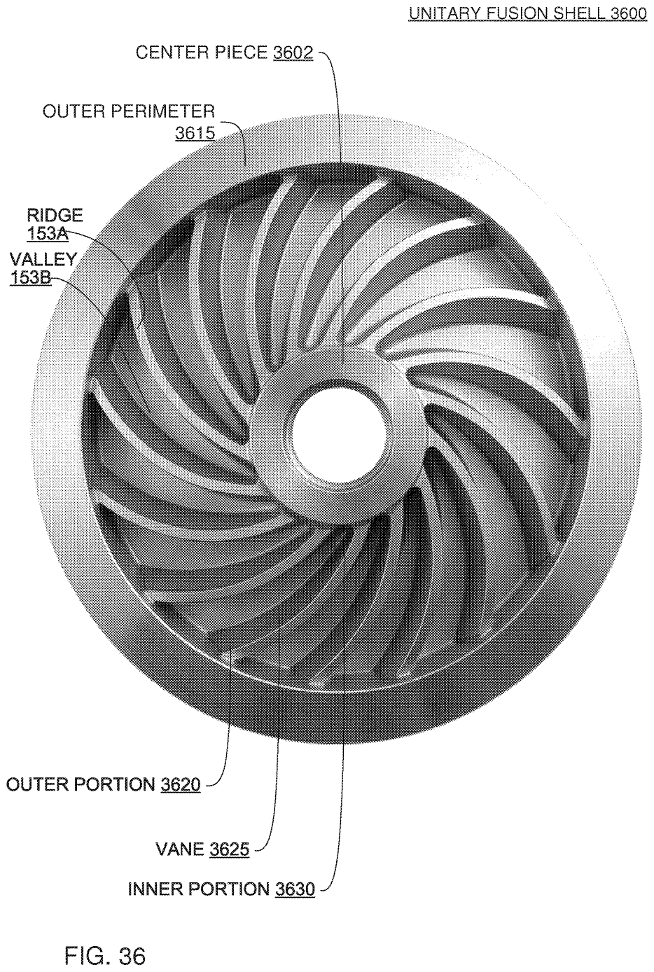

FIG. 36 is a top-down view cross section diagram of an experimental unitary fusion shell 3600. The experimental unitary fusion shell 3600 shows one half of a unitary integrated unitary fusion system which includes a center piece 3605 that has holes for accommodating bolts. An outer perimeter 3615 has holes (such as hole 3618) for accommodating bolts. An outer portion (such as outer portion 3620) of the vanes (such as vane 3625) are higher than an inner portion (such as inner portion 3630) (such as inner portion 3630) of the vanes. The number of the vanes is 15, although in other implementations different quantities of vanes can be used, such as 4, 10, 16, 24.

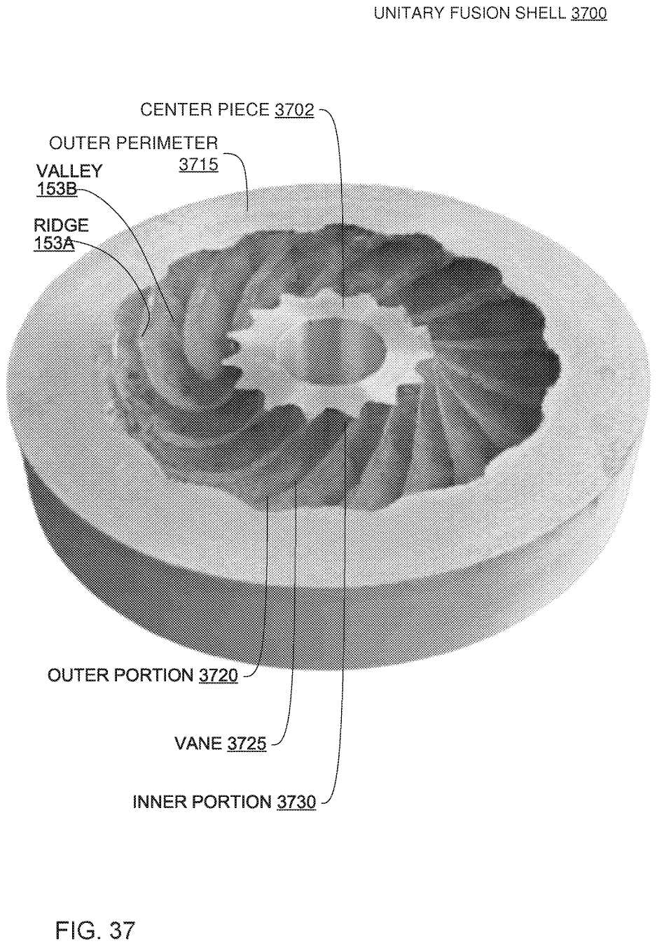

FIG. 37 is an isometric diagram of an experimental unitary fusion shell 3700, according to an implementation. The experimental unitary fusion shell 3700 shows one half of a unitary integrated unitary fusion system which includes, in which the center piece 3705 that has holes for accommodating bolts. An outer perimeter 3715 has holes (such as hole 3718) for accommodating bolts. An outer portion (such as outer portion 3720) of the vanes (such as vane 3725) are higher than an inner portion (such as inner portion 3730) (such as inner portion 3730) of the vanes. The number of the vanes is 15, although in other implementations different quantities of vanes can be used, such as 4, 10, 16, 24.

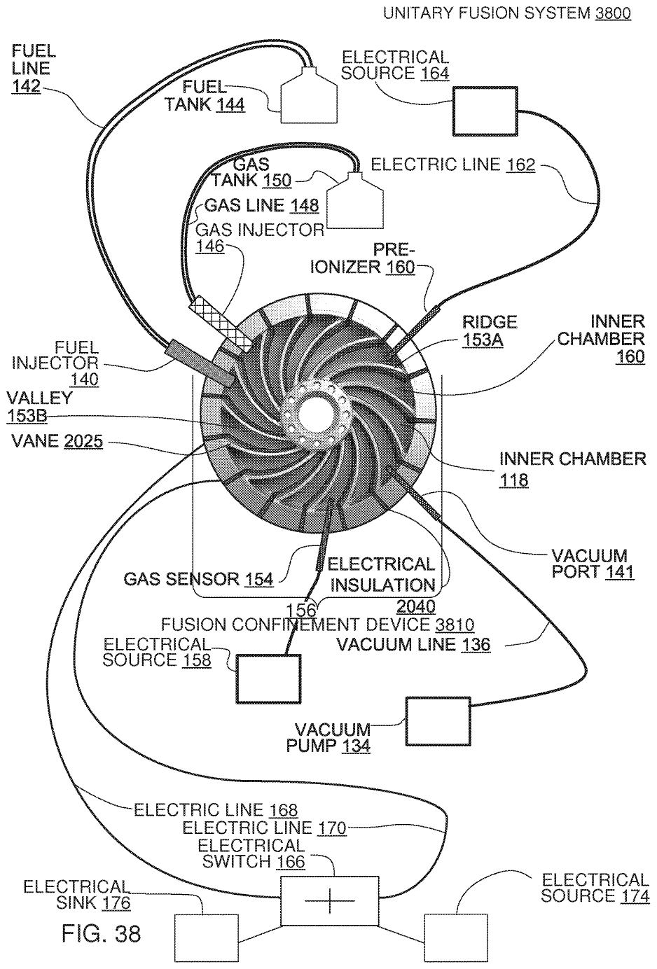

FIG. 38 is a block diagram of an overview of an experimental unitary fusion system 3800 to manage fusion reactions, according to an implementation. In this section, particular apparatus of implementations are described by reference to a series of diagrams. An inner ring 3915 has holes for accommodating bolts.

A top-down view cross section diagram of the experimental unitary fusion system 3800 is shown in FIG. 38. In unitary fusion system 3800, a torsatron magnetic configuration is employed to maintain a hot-dense plasma in a toroidal equilibrium configuration during a fusion power pulse.

The unitary fusion system 3800 includes an experimental fusion confinement device that forms an inner chamber 118. The inner chamber 118 forms a rifled toroidal theta pinch (RTTP), as shown in FIG. 16-39. The inner chamber 118 is also referred to as a hollow toroidal interior chamber.

The experimental fusion confinement device 3810 is circular in shape when viewed from above, and can be referred to as a “donut” in general. In some implementations the inner chamber 118 is generally circular in shape in cross-section (as shown in FIG. 38). In some implementations, the diameter of the inner chamber 118 torus is 3 meters. In some implementations, the diameter of the inner chamber 118 torus is 1 meter.

The experimental fusion confinement device 3810 is a single device, such as formed by a 3D printer or other manufacturing techniques that are capable of creating a cavity in a block of material, and the experimental fusion confinement device 3800 is not formed from multiple half-shells and does not include fasteners 126 and 128 as shown in FIG. 1 to hold together the experimental fusion confinement device, such as C-clamps.

The experimental unitary fusion system 3800 further includes a vacuum pump 134 that is operably coupled to a vacuum line 136, that is operably coupled to a vacuum port 138 in the wall of the experimental unitary fusion system 3800.

The experimental unitary fusion system 3800 of the unitary fusion system 3800 further includes a fuel injector 140 that traverses into the inner chamber 118. The fuel injector 140 receives a fuel through a fuel line 142 that receives the fuel from fuel tank(s) 144. Examples of the fuel include a 50/50 mix of gaseous helium3 and gaseous deuterium, in which case, the fuel tank(s) 144 includes at least two fuel tanks, a first tank for the gaseous helium3 and a second tank for the gaseous deuterium. In some implementations, the fuel tank(s) include a third tank to store gaseous tritium for the fuel.

In some implementations, a gas injector 146 in the experimental unitary fusion system 3800 is coupled to, and receives gas from a gas line 148 outside of the experimental unitary fusion system 3800 that is coupled to a gas tank 150. The gas injector 146 injects the concentration(s) of gases into the inner chamber 118, such as the concentration of tritium and/or helium4. When helium4 is injected into the inner chamber 118 by the gas injector 146 and helium3 is also injected into the inner chamber 118 by the fuel injector 140, the helium4 will not fuse with the helium3 because helium4 is inert and is not reactive in fusion.

In some implementations, at least one electromagnetic (EM) foil 152 (such as 5-6 EM foils) that are evenly spaced away from each other is generated by electricity flowing through the inner chamber 118.

The rifling of the experimental unitary fusion system 3800 that form the inner chamber 118 for this pulsed system causes “burning in” a flux invariant A·B (the Taylor invariant, where A is the magnetic vector potential) into the plasma, which then persists to create helical magnetic fields in the plasma and the inner chamber 118, even though the immediate effect of the rifling fades with time. The plasma will relax into a minimum energy state (Taylor relaxation) while preserving the global average value of A·B and other flux invariants). Such complex interactions between the plasma and rifling on the walls of the chamber over time are seemingly counter intuitive. In the implementation shown in FIG. 38, the grooves have a semi-circular geometric shape. In other implementations, the grooves have a hemispherical-circular geometric shape. In other implementations, the grooves have a square (right-angled) geometric shape. In other implementations, the grooves have a parabolic geometric shape.

A gas sensor 154 in the experimental unitary fusion system 3800 is electrically powered by, and coupled to, an electric line 156 outside of the experimental unitary fusion system 3800 that is electrically coupled to an electrical source 158. The gas sensor 154 determines the concentration(s) of gases in inner chamber 118, such as the concentration of tritium or helium4.

The fuel in the unitary fusion system 3800 is a mixture of gaseous helium3 and gaseous deuterium. In some implementations, the mixture of gaseous helium3 and gaseous deuterium is a mixture of about 50% gaseous helium3 and about 50% gaseous deuterium in which molecules of the gaseous helium3 fuses with molecules of the gaseous deuterium in the inner chamber 118. In some implementations, a small amount of tritium is added to aid ignition of the fusion reaction.

A pre-ionizer 160 in the experimental unitary fusion system 3800 is electrically energized by, and coupled to, an electric line 162 outside of the experimental unitary fusion system 3800 that is electrically coupled to an electrical source 164.

In some implementations, an electrical switch 166 is operable to open a circuit (through electric line 170) between an electrical source 174 and the experimental unitary fusion system 3800. In some implementations, the electrical source 174 includes a voltage capacitor bank having 500 miliFarads and 14 million Joules of energy that provides 15,000 volts. In some implementations, the electrical source 174 includes a voltage capacitor bank having 500 miliFarads and 1 million Joules of energy that provides 15,000 volts.

In some implementations, output power from the experimental unitary fusion system 3800 along the electric line 170 is controlled by solid state switching in the electrical switch 166. In some implementations, the electrical source 174 provides a million Joules of energy at 15,000 volts. In alternative embodiments, the electrical source 174 is electrically connected to experimental unitary fusion system 3800 and the electrical sink 176 is connected to the experimental unitary fusion system 3800.

In some implementations, regenerative energy recovery is performed by the electrical switch 166 by diverting some of the electricity that is transferred from the experimental unitary fusion system 3800 to the electrical sink 176 instead to the electrical source 174, in order to replace the electricity that is transferred from the electrical source 174 to the experimental unitary fusion system 3800. The regenerative energy recovery occurs because the fusion energy pulse heats the plasma confined by the magnetic field and expands against the plasma, creating a current in EM foil 152, which using the electrical switch 166, can be used to recharge the electrical source 174.

The electrical switch 166 is operable to open a circuit (through electric lines 168 and 170) between an electrical sink 176 and the experimental unitary fusion system 3800. The electricity from the electrical source 174 flows into the vane 1625 and then around the section of rifled inner chamber 118 then around the section of the experimental unitary fusion system 3800 before exiting back to the electrical source 174. Examples of the electrical sink 176 are a battery or a power conditioner. Each section of the experimental unitary fusion system 3800 is connected to the electric lines 168 and 170 as shown by the section that includes vane 1625.

In some implementations, each section of the experimental unitary fusion system 3800 includes a fuel injector that is a different fuel injector than the injector 140.

In some implementations, each section of the experimental unitary fusion system 3800 includes a separate vacuum port.

In some implementations, each section of the experimental unitary fusion system 3800 includes a separate gas injector.

In some implementations, each section of the experimental unitary fusion system 3800 includes a separate gas sensor.

In some implementations, each section of the experimental unitary fusion system 3800 includes a pre-ionizer that is a different pre-ionizer than the pre-ionizer 160.

The experimental unitary fusion confinement device 3810 in various implementations can be constructed of high strength aluminum alloy and weigh approximately a ton. In some implementations of the unitary fusion system 3800, adding small amounts of yttrium and scandium to aluminum of the experimental unitary fusion confinement device 3810 will increase the strength while not affecting electrical conductivity. In some implementations of the experimental unitary fusion confinement device 3810, the housing is quartz crystal with a layer of electrically conductive material such as aluminum on the interior of the inner chamber 118.

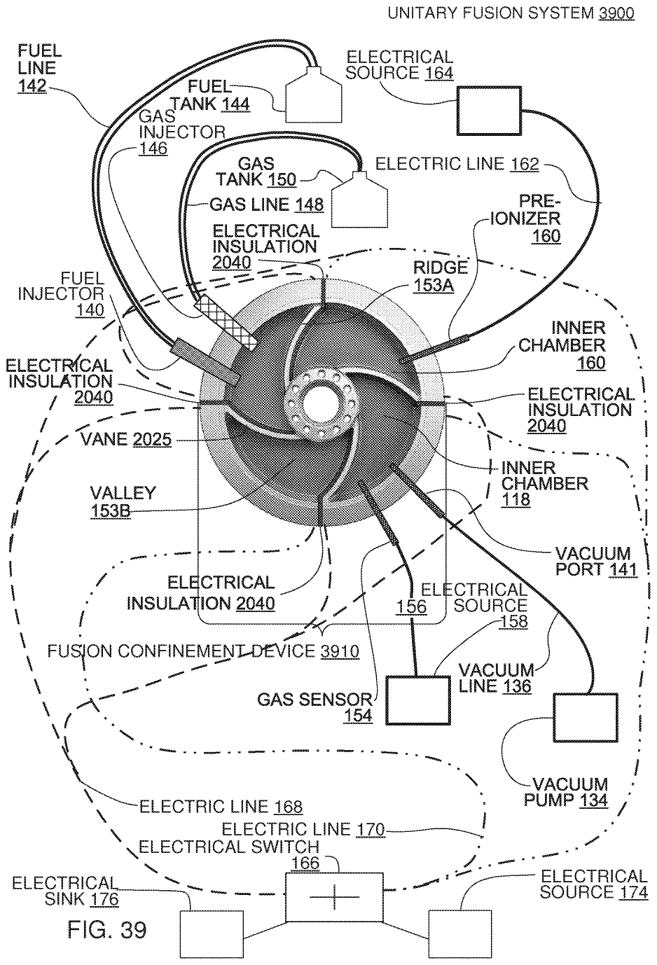

FIG. 39 is a block diagram of an overview of an experimental unitary fusion system 3900 to manage fusion reactions, according to an implementation. In this section, particular apparatus of implementations are described by reference to a series of diagrams.

A top-down view cross section diagram of the experimental unitary fusion system 3900 is shown in FIG. 39. In unitary fusion system 3900, a torsatron magnetic configuration is employed to maintain a hot-dense plasma in a toroidal equilibrium configuration during a fusion power pulse.

The unitary fusion system 3900 includes an experimental fusion confinement device 3910 that forms an inner chamber 118. The inner chamber 118 forms a rifled toroidal theta pinch (RTTP), as shown in FIG. 39. The inner chamber 118 is also referred to as a hollow toroidal interior chamber.

The experimental fusion confinement device 3910 is circular in shape when viewed from above, and can be referred to as a “donut” in general. In some implementations the inner chamber 118 is generally circular in shape (as shown in FIG. 39) and in cross-section. In some implementations, the diameter of the inner chamber 118 torus is 3 meters. In some implementations, the diameter of the inner chamber 118 torus is 1 meter.

The experimental fusion confinement device 3910 is a single device, such as formed by a 3D printer or other manufacturing techniques that are capable of creating a cavity in a block of material, and the experimental fusion confinement device 3910 is not formed from multiple half-shells and do not include fasteners 126 and 128 as shown in FIG. 1 to hold together the experimental unitary fusion system 3900, such as C-clamps.

The unitary fusion system 3900 further includes a vacuum pump 134 that traverses into the inner chamber 118 and that is operably coupled to a vacuum line 136, that is operably coupled to a vacuum port 138 in the wall of the experimental unitary fusion system 3900.

The experimental unitary fusion system 3900 further includes a fuel injector 140 that traverses into the inner chamber 118. The fuel injector 140 receives a fuel through a fuel line 142 that receives the fuel from fuel tank(s) 144. Examples of the fuel include a 50/50 mix of gaseous helium3 and gaseous deuterium, in which case, the fuel tank(s) 144 includes at least two fuel tanks, a first tank for the gaseous helium3 and a second tank for the gaseous deuterium. In some implementations, the fuel tank(s) include a third tank to store gaseous tritium for the fuel.

In some implementations, a gas injector 146 in the fusion confinement device 3910 of the unitary fusion system 3900 is coupled to, and receives gas from a gas line 148 outside of the experimental unitary fusion system 3900 that is coupled to a gas tank 150. The gas injector 146 injects the concentration(s) of gases into the inner chamber 118, such as the concentration of tritium and/or helium4. When helium4 is injected into the inner chamber 118 by the gas injector 146 and helium3 is also injected into the inner chamber 118 by the fuel injector 140, the helium4 will not fuse with the helium3 because helium4 is inert and is not reactive in fusion.

In some implementations, at least one electromagnetic (EM) foil 152 (such as 5-6 EM foils) that are evenly spaced away from each other that is generated by electricity flowing through the inner chamber 118.

The rifling of the experimental unitary fusion system 3900 that form the inner chamber 118 for this pulsed system causes “burning in” a flux invariant A·B (the Taylor invariant, where A is the magnetic vector potential) into the plasma, which then persists to create helical magnetic fields in the plasma and the inner chamber 118. The plasma will relax into a minimum energy state (Taylor relaxation) while preserving the global average value of A·B and other flux invariants). Such complex interactions between the plasma and rifling on the walls of the chamber over time are seemingly counter intuitive. In the implementation shown in FIG. 39, the grooves have a semi-circular geometric shape. In other implementations, the grooves have a hemispherical-circular geometric shape. In other implementations, the grooves have a square (right-angled) geometric shape. In other implementations, the grooves have a parabolic geometric shape.

A gas sensor 154 in the experimental unitary fusion system 3900 is electrically powered by, and coupled to, an electric line 156 outside of the experimental unitary fusion system 3900 that is electrically coupled to an electrical source 158. The gas sensor 154 determines the concentration(s) of gases in the inner chamber 118, such as the concentration of tritium or helium4.

The fuel in the unitary fusion system 3900 is a mixture of gaseous helium3 and gaseous deuterium. In some implementations, the mixture of gaseous helium3 and gaseous deuterium is a mixture of about 50% gaseous helium3 and about 50% gaseous deuterium in which molecules of the gaseous helium3 fuses with molecules of the gaseous deuterium in the inner chamber 118. In some implementations, a small amount of tritium is added to aid ignition of the fusion reaction.

A pre-ionizer 160 in the experimental unitary fusion system 3900 is electrically energized by, and coupled to, an electric line 162 outside of the experimental unitary fusion system 3900 that is electrically coupled to an electrical source 164.

In some implementations, an electrical switch 166 is operable to open a circuit (through electric line 170) between an electrical source 174 and the experimental unitary fusion system 3900. In some implementations, the electrical source 174 includes a voltage capacitor bank having 44 miliFarads and 1% million Joules of energy that provides 15,000 volts. In some implementations, the electrical source 174 includes a voltage capacitor bank having 88 miliFarads and 1 million Joules of energy that provides 15,000 volts.

In some implementations, output power from the experimental unitary fusion system 3900 along the electric line 170 is controlled by solid state switching in the electrical switch 166. In some implementations, the electrical source 174 provides a million Joules of energy at 15,000 volts. In alternative embodiments, the electrical source 174 is electrically connected to experimental unitary fusion system 3900 and the electrical sink 176 is connected to the experimental unitary fusion system 3900.

In some implementations, regenerative energy recovery is performed by the electrical switch 166 by diverting some of the electricity that is transferred from the experimental unitary fusion system 3900 to the electrical sink 176 instead to the electrical source 174, in order to replace the electricity that is transferred from the electrical source 174 to the experimental unitary fusion system 3900. The regenerative energy recovery occurs because the fusion energy pulse heats the plasma confined by the magnetic field and expands against the plasma, creating a current in EM foil 152, which using the electrical switch 166, can be used to recharge the electrical source 174.

The electrical switch 166 is operable to open a circuit (through electric lines 168 and 170) between an electrical sink 176 and the experimental unitary fusion system 3900. The electricity from the electrical source 174 flows into the vane 1625 and then around the section of rifled inner chamber 118 then around the section of the experimental unitary fusion system 3900 before exiting back to the electrical source 174. Examples of the electrical sink 176 are a battery or a power conditioner. Each section of the experimental unitary fusion system 3900 is connected to the electric lines 168 and 170. More specifically, the electric line 168 is electrically connected to one side of each of the sections, and the electric line 170 is electrically connected to the opposite side of each of the sections in which the electricity flows from the one side of each section to the opposite side of each section. In some implementations as shown in FIG. 39, the electric line 168 is electrically connected to the left side of each of the sections, and the electric line 170 is electrically connected to the right side of each of the sections in which the electricity flows from the left side of each section to the right side of each section. In some implementations, the electric line 168 is electrically connected to the right side of each of the sections, and the electric line 170 is electrically connected to the left side of each of the sections in which the electricity flows from the right side of each section to the left side of each section.

In some implementations, each section of the experimental fusion confinement device 3910 includes a fuel injector that is a different fuel injector than the injector 140

In some implementations, each section of the experimental fusion confinement device 3910 includes a separate vacuum port.

In some implementations, each section of the experimental fusion confinement device 3910 includes a separate gas injector.

In some implementations, each section of the experimental fusion confinement device 3910 includes a separate gas sensor.

In some implementations, each section of the experimental fusion confinement device 3910 includes a pre-ionizer that is a different pre-ionizer than the pre-ionizer 160.

In some implementations, each section of the experimental fusion confinement device 3910 includes an injector 140, a vacuum port 141, a gas injector 146, gas sensor 154, and a pre-ionizer 160.

The experimental unitary fusion confinement device 3910 in various implementations can be constructed of high strength aluminum alloy and weigh approximately a ton. In some implementations of the unitary fusion system 3900, adding small amounts of yttrium and scandium to aluminum of the experimental unitary fusion confinement device 3910 will increase the strength while not affecting electrical conductivity. In some implementations of the experimental unitary fusion confinement device 3910, the housing includes quartz crystal with a layer of electrically conductive material, such as aluminum, on the interior of the inner chamber 118.

A difference between the experimental fusion confinement devices shown in the FIGS. 1-3, 11-12 and the FIG. 16-39 is in the clam-shell apparatus of FIG. 1-3, 11-12 that the electricity flows from the flange 120 (outer perimeter of the fusion confinement device) towards the center of the fusion confinement device, while in the unitary apparatus of FIG. 16-39 the electricity flows from the beginning of each section to the other side of each section.

Various implementations of different experimental unitary fusion systems can be made from various features in FIGS. 16-39. For example, one implementation of an experimental unitary fusion system can be made from the vanes (e.g. vane 1725 in FIG. 17), the centerpiece 1802 in FIG. 18, the bolt holes (such as bolt hole 2618 in FIG. 26) and the bolt holes (such as bolt hole 1610 in FIG. 16).

A difference between the clam-shell apparatus of FIGS. 1-10 and the unitary apparatus of FIGS. 16-39 is that in the clam-shell apparatus of FIG. 1-10 the electricity flows from the flange on either the top or bottom side and the to the center, and then and in the unitary apparatus of FIGS. 16-39 the electricity flows from one end of each section to another other end of each section.

In some implementations of the unitary devices 16-30, the geometric shape of the vanes, valleys and ridges are the same geometric shape as the geometric shape of the vanes, valleys and ridges in the clam-shell devices 1-10. In some implementations of the clam-shell devices in FIGS. 1-10, the geometric shape of the vanes, valleys and ridges are the same geometric shape as the geometric shape of the vanes, valleys and ridges in the unitary devices 16-39.

### Physics in Operation of Apparatus in FIGS. 1-3, 11-12 and 16-39

In an overview of implementations of experimental use of the devices in FIGS. 1-3, 4-12, and 16-39, when electricity is applied to rifled geometrically shaped walls of the chamber 118, a magnetic field is generated in the chamber 118 of current pulse at high field strength (e.g. 20 Teslas), a plasma implodes off of the rifled geometrically shaped walls of the chamber 118 in “snowplow” shock waves, the plasma stagnates in a toroidal shape and is shock-heated to fusion temperatures, the plasma configuration relaxes to form a stable vortex form and undergoes fusion with self-heating due to D-He3 (Deuterium-Helium3) fusion, and the plasma pushes against the magnetic field, thus generating electricity.

In systems, methods and apparatus described herein, when deuterium-tritium fuel is injected, the fuel is pressurized and heated to fusion by the pressure and temperatures of between 100,000,000 degrees Kelvin (K) and 150,000,000 degrees K of a plasma that are created by the EM foil(s) 152 that traverse(s) the torodial inner chamber 118. The EM foil 152 is not a spiraled wire that is mounted or attached to a ridge 153A of the inner chamber 118. Rather the ridge 153A generates an EM foil 152 when electricity passes through the inner chamber 118 and the electricity aggregates and concentrates along the ridge(s) 153A as indicated by Maxwell's Equations to the extent that nearly all of the electricity is in the ridge 153A. The EM foil 152 shapes electromagnetic force and generates maximum compression force in the same way that a hydrofoil shapes water to generate a maximum lifting force. The EM foil 152 also shapes the electromagnetic field to produce a configuration that maximizes stability on the plasma.

Maxwell's equations indicate that for pulsed fields, the magnetic lines of force must lie in the metal grooves, and be parallel everywhere to the metal surfaces, and also not penetrate the metal surfaces. The electric current in the metal surface must follow this pattern and be consistent with the magnetic field. This follows from Faraday's law and the law that forbids magnetic monopoles (Maxwell's equations #2 and #3). Maxwell's equation #3 indicates that a magnetic field (B or H) does not flow outward or inward (because the right-hand side is zero). Maxwell's equation #2 is derived from Faraday's laws of Electromagnetic Induction, which indicates that whenever there are n-turns of conducting coil in a closed path which is placed in a time-varying magnetic field, an alternating electromotive force gets induced in each and every coil, which is given by Lenz's law. Faraday's law indicates that the time rate of change of the magnetic field is proportional to the vorticity of the electric field around the magnetic lines of force, meaning that since the electric field vanishes for pulsed fields inside the metal, the magnetic lines of force that penetrate the metal surface must end inside it. But his would mean magnetic monopoles (magnetic free charge) would have to exist in the metal, but since magnetic fields have no monopoles like electric fields, the pulsed magnetic lines of force cannot penetrate the metal surfaces but must lie parallel to those surfaces.

In regards to the geometric shape of the surface of the inner chamber 118, in some implementations, the ratio of the distance from the center of the cross-section of the inner chamber 118 to the grooves in comparison to the distance from the center of the cross-section of the inner chamber 118 to the ridge(s) is 1.16.

Aneutronic fusion is any form of fusion reaction in which very little of the energy released is carried by neutrons. While the lowest-threshold nuclear fusion reactions release up to 80% of their energy in the form of neutrons, aneutronic reactions release energy in the form of charged particles, typically protons or alpha particles. Successful aneutronic fusion greatly reduces problems associated with neutron radiation such as damaging ionizing radiation, neutron activation, and requirements for biological shielding, remote handling and safety.

Aneutronic fusion reaction eliminates the radiation from neutrons, which are difficult to shield against, and usually is implemented by heavy and costly shielding.

In the systems, methods and apparatus described herein however, the same toroidal magnetic configuration, called a torsatron, which is used to confine the fusion plasma, is used to initially shock heat the plasma to fusion temperatures of between 100,000,000 degrees K and 150,000,000 degrees K for deuterium-tritium fuel, fusion temperatures of between 600,000,000 degrees K and 1,000,000,000 degrees K for Helium3 and deuterium fuel and fusion temperatures of between 600,000,000 degrees K and 700,000,000 degrees K for a Helium3 fuel. However, drawing on the inherent simplicity of the well demonstrated torsatron configuration and its unexploited ability to achieve shock heating of plasmas.

The magnetic field, pulse time and gas density required to heat a deuterium and helium3 mixture to the required density and 30 to 60 KeV (600 million degrees K) temperatures, assuming a pulse length of 100 milliseconds are determined as follows: When a thin pre-ionized plasma is present in the inner chamber 118 and a fast-rising magnetic field pulse is applied at the walls, the plasma is then swept up in a “snowplow” shockwave of approximate speed Vₛ=(B²/8πρ)^{1/2} CGS. The plasma layer implodes and stagnates on itself converting its kinetic energy to heat. The resulting plasma pressure is approximately equal to the peak magnetic energy density of the pulse: B²/8π. Assuming a pulse length of 1 millisecond, the fusion triple product condition nτT for deuterium and helium3 is an energy density of 1.6×10⁴ atmospheres, corresponding to an approximate pulsed magnetic field strength of 200 kG or 20 T.

Modifications to these numbers can occur due to MHD (Magneto-Hydro-Dynamic) stability requirements of the confined plasma that may lessen the ratio of thermodynamic energy in the plasma divided by the magnetic energy density, a ratio called β. A being β≈100% for a system is considered optimal, however MHD plasma requirements may lower R to the lesser value of 4%. This can be compensated for by raising the magnetic field or lengthening the pulse. Both pulsed 20T magnetic field coils and steady state plasma confinement in torsatrons are feasible.

A chamber filled with a mixture of helium3 and deuterium and a fast-rising magnetic pulse reaching approximately 0.2 MegaGauss in strength, that creates an imploding shockwave in the plasma. Numbers used here must be considered as approximate and empirical as the formation, implosion, and stagnation processes of the shockwave used to heat the plasma are known to involve many non-linear processes. Shock speed will be approximately determined by the initial plasma mass density and the magnetic field strength during the implosion phase. The initial mass density, ρₒ is:

ρₒ=1.9×10¹⁶/cm³*4.0×10⁻²⁴ g=1.0×10⁻⁷ g/cm³

The approximate shock speed will then be: Vₛ≈(B²/(8πρ))^{1/2}=2×10⁸ cm/see, where B is magnetic field strength and ρ is mass density (in grams/cc), the thermal speed at 60 KeV (2.2×10⁸ cm/sec) corresponding to a temperature of 60 KeV (700 million degrees K) and thus more than sufficient to trigger fusion in the deuterium and helium3 plasma. However, empirically, this high temperature tends to be reduced, by a variety of loss processes, in the final stagnated plasma state, by approximately an order of magnitude.

After stagnation of the plasma shockwave the magnetic field energy density will “equipartition” with the thermodynamic energy in the plasma resulting in a plasma of energy density of approximately β B²/(87), the same as in the magnetic field but multiplied by an efficiency factor β≈100%. Ideally, the efficiency factor β=100% but empirical evidence indicates this is actually 4% in actual toroidal magnetic confinement devices.

This means confining an MHD stable plasma in a torsatron at the deuterium and helium3 nτ (Lawson criterion)≈10¹⁵ sec/cm³, of approximate number density 10¹⁶/cm³, assuming a confinement time of 0.1 second. The pulsed magnetic fields of 0.2 MegaGuass peak value, required to satisfy the β requirement to confine the hot deuterium and helium3 fusion plasma satisfying the triple product, nkTτ (Lawson criterion times plasma temperature) 50 atmosphere-seconds, meaning a pressure of 2000 atmospheres. This will require, in turn, pulsed magnetic fields of 0.2 mega-gauss peak value. Such fields are achievable but will exert pressures of 1×10³ atmospheres on the structure of the systems, methods and apparatus described herein, requiring alloys of high strength and high electrical conductivity. This high magnetic field also ensures that high energy protons and high energy nuclei produced by the fusion reactions are confined in the plasma to heat the plasma.

A processor, such as processor 1302 in FIG. 13, controller chip 1404 in FIG. 14 or main processor 1502 in FIG. 15, cause the processor to control the unitary fusion system 3800 in a manner of controlled pulsed fusion. More specifically, the processor controls the vacuum pump 134, the vacuum port 138, the fuel injector 140, the fuel tank 144, the gas injector 146 and the gas tank 150, the gas sensor 154, the electrical source 158, the electrical source 164, the electrical switch 166, the electrical source 174 and the electrical sink 176.

The devices and methods in systems, methods and apparatus described herein use shock implosion to form a toroidal plasma equilibria and the use of helical magnetic field topologies to promote MHD (Magneto Hydro-Dynamic) stability. This can be done by engraving the toroidal conducting chamber inner walls with a helical pattern of grooves (such as the vanes in FIG. 16-43) resembling “rifling” in a gun barrel, in order to create a helical pattern of field lines in the imploding plasma shock. The stagnation of the toroidal shock then forms a plasma that relaxes to a stable NMD equilibrium, with helical field lines for stability and finite Beta: <P>/<B²/8π>. The NMD equilibria that result can be described through forms of the Grad-Shafranov Equation that result from relaxation of the toroidal plasma to minimum energy with two global flux invariants A·B, and ψ² which are impressed on the plasma when it forms a toroidal imploding NMD shock front. These global flux invariants are then conserved in the toroidal stagnated plasma as it relaxes to equilibrium. The shock heating of the plasma, followed by a period of stable plasma confinement, is projected to make conditions allowing the controlled release of fusion energy. This process could then become cyclic, with shock heating followed by periods of stable confinement of plasma, during which fusion energy would be released, followed by plasma dissipation by diffusion and then recharging of the chamber with fresh fuel to begin another cycle. Allowing energy gain for the system once the plasma achieves fusion ignition. Helium 3 isotope, while rare on Earth, is found in abundance locked in lunar soil, where it can be easily recovered and shipped to Earth as part of planned Lunar base operations. In addition, He3 can be produced on Earth as a decay product of Tritium, which has a 12.2 year half-life and is the product of heavy water fission reactors, such as the very successful CANDU design.

In the remainder of this section, the concept and theory of formation of stable plasmas by shock implosion is discussed, followed by a description of the resulting toroidal plasmas a brief summary of the promising results.

The capability of such plasmas to “ignite” or self-heat by their own fusion energy generation is discussed below and at least one example of the required conditions are calculated below.

In the NMD shock formation and Implosion Phase of operation, a generalized model of the formation and “lift-off” of a plasma shock wave from a conducting inner surface of a toroidal chamber with engraved helical grooves.

Pulsed magnetic fields can create imploding shock waves in plasmas. These imploding shock waves then collapse and stagnate to form a hot, dense plasma.

This “rifled torus” concept is unique. Considering that the currents are driven through the conductor as an intense pulse because it is abruptly connected to fully charged capacitor bank. In pulsed power scenarios, rapidly rising magnetic fields must, initially, be outside the conductor, so B=0, in the bulk metal, and the magnetic lines of force lie everywhere parallel to the conductor surfaces, above them, that is

B·\hat{n}=0 (1)

Therefore, pulsed currents initially ride on the surface of conductors in thin layers, following the details of the conductor surface, that is, the initial magnetic field pattern in a pulsed power system can be machined or formed into the surface of the conductors.

When the pulsed power system is activated, a rapidly rising magnetic field appears above the conductor along with the induced electric field that produces and rapidly rising magnetic field appears above the conductor induces the breakdown to conducting plasma of the gases adjacent to the surface where an opposing current layers forms in the plasma. The opposing current layers repel each other and so a plasma shockwave forms in the gases adjacent to the layers and moves the plasma away from the surface with a J×B force. In conditions where the thermodynamic pressure of Normally, the gas the thermodynamic pressure of the gas is very low compared to the pressure of the magnetic field, which will normally be a rapidly rising pulse. In such cases, the shock speed can be found approximately by the condition of momentum balance of the magnetic pressure behind the shock, being opposed by the momentum flux of the gas atoms being swept up by the shock wave to form a thin layer comoving with the shock. This is called the “snowplow” shock model. Ideally, the gas will be swept up, ionized to form a plasma, and carried forward with the shock wave as a thin layer, but in real experiments magnetic diffusion, driven by both collisional and plasma turbulence broadens the layer and the layer loses some of the mass it gains. Accordingly, making the Approximation that the snowplow shock does not accumulate mass as it travels but, instead its motion is, to good approximation, governed by the equation (in cgs):

$$\frac{{B}^{2}}{8 π} = {ρ}_{o} {v}^{2} \qquad ( 2 )$$

$$v = \sqrt{{B}^{2} / ( 8 {πρ}_{o} )} \qquad ( 3 )$$

When this is done in a torus, or “donut” shaped hollow chamber, with a small minor radius r, and larger major radius R, with “rifling” pattern of grooves on the interior surface of the torus, the magnetic field pattern determined by the pattern of grooves is “imprinted” onto the plasma shock wave that moves chamber, with an approximate speed v that is determined by Eq. 3 to be controlled by the pulsed magnetic field strength B(t) given to good approximation by the simple expression:

B(t)=Bₒ Sin(ωt) (4)

The magnetic field will thus rise to its peak in the quarter-cycle time of the pulse Tp/4=π/(2ω). The radius of the imploding shock will thus be given, to reasonable approximation, by the equation, where vₒ=Bₒ/(8πρₒ)^{1/2} and r_{w} is the wall minor radius

$$r = \frac{{v}_{o}}{ω} Cos ( ω t ) \qquad ( 5 )$$

The parameters Bₒ and ρₒ are adjusted to have the conditions

$${r}_{w} = \frac{{v}_{o}}{ω} \qquad ( 6 a )$$

$$ω = \frac{π}{2 {T}_{p}} \qquad ( 6 b )$$

These conditions ensure that the stagnation of the imploding shockwave on itself, occurs at the time of maximum magnetic field intensity Bₒ.

Once this point of stagnation occurs, the pulsed power system is “crowbarred”, or short circuited by switches, to trap the magnetic energy in the system in the chamber. At this point the plasma pressure P will be approximately a “mesa” profile of peak pressure Pₒ with a magnetic field largely excluded from the plasma. The value of Pₒ will be approximately given by the pressure balance equation for equilibrium:

$${P}_{o} = \frac{{B}_{o}^{2}}{8 π} \qquad ( 7 )$$

However, this mesa profile equilibrium will rapidly “relax” by turbulent diffusion driven by MHD waves to a diffuse, approximately Gaussian profile of fields and plasma pressure, of minimum magnetic and thermodynamic energy, while preserving magnetic flux invariants imprinted upon the highly conducting plasma and preserved as it relaxes to a minimum energy state, which is a MHD equilibrium. This relaxation to a state of minimum magnetic and thermodynamic energy is seen in numerous experiments producing stable toroidal plasmas, such as seen in Tokomaks and RFP (Reversed Field Pinches) [3,4]]

Based on the assumed toroidal symmetry and a relaxation to a final MHD pressure equilibrium, the analysis used for the Grad Shafranov Equation [#] can be used, where it can be written for a toroidal MHD equilibrium condition: J×B/c=∇P, (in cgs) where ψ is the poloidal flux function, the magnetic field expression:

$$B = \frac{f ( ψ ) \hat{θ}}{r} + \frac{∇ ψ \times \hat{θ}}{r} \qquad ( 8 )$$

Where a poloidal magnetic field component, Be, and a toroidal component B

$${B}_{ϕ} = \frac{∇ ψ \times \hat{θ}}{r} n \qquad ( 9 )$$

$${B}_{θ} = \frac{F ( ψ ) \hat{θ}}{r} \qquad ( 10 )$$

Defining the pressure function P(ψ) and rB_{θ}=F(ψ). The final equibrium equation for ψ is

$${Δ}^{*} ψ = {r}^{2} \frac{d P ( ψ )}{d ψ} + \frac{d {F}^{2} ( ψ )}{d ψ} \qquad ( 11 )$$

Where the operator is defined as:

$${Δ}^{*} ψ = \frac{{\partial }^{2} ψ}{\partial {r}^{2}} - \frac{1}{r} \frac{\partial ψ}{\partial r} + \frac{{\partial }^{2} ψ}{\partial {z}^{2}} \qquad ( 12 )$$

During the relaxation to a minimum energy state the plasma forms an MHD equilibrium. This process of relaxation, is through broad spectrum high frequency MHD turbulence, rather than violent low frequency global scale instabilities. This relaxation to a quiescent final equilibrium after a period of unstable behavior, has been observed in numerous different toroidal confinement experiments, most notably in Tokomaks, during what is termed the “current penetration phrase.” These MHD relaxations result in finite plasma pressure toroidal equilibria. This process is thus crucial to the quest to achieve stable confinement of plasmas for magnetic confinement fusion.

In what is termed the “Sonic Bath” model of energy removal from the magnetized plasma as it relaxes to a minimum energy state, is largely accomplished by energy transfer across field lines by magneto-sonic waves. In the final quiescent stage of relaxation the plasma is observed to change profiles but not volume. The magneto-sonic wave turbulence, which moves across field lines, can readily escape and damp by heating plasma on open field lines, however, for a quiescent relaxation to equilibrium, the MHD turbulence is dominated by high frequency Alfven waves that are trapped on the closed magnetic field lines. So the last crucial stages of a toroidal plasma relaxing to equilibrium quiescently, will be dominated by Alfven turbulence. This turbulence is characterized by incompressible. That is ∇·v=0, where v is the plasma wave velocity field.

It is also one of the crucial phenomenology's of these experiments over the decades that produce toroidal plasma equilibria with the property of having basic structures that are largely independent of magnetic field strength and plasma temperature once the conditions of the MHD approximation are satisfied. This property can be termed ESI (Energy Scale Invariance). ESI means that magnetic confinement experiments can produce plasmas of similar size and geometry in a series of experiments conducted at progressively and higher field strengths and plasma pressures. This has allowed the successful extrapolation of results of low field strength experiments to near fusion reactor conditions. Thus, the process of MHD relation to minimum energy equilibria to be governed by parameters that reflect ESI can be expected.

As to the more detailed description of the final equilibria profiles of current and magnetic field vector field profiles, the structural parameters of these equilibria can be determined by the values of two global flux invariants, the Helicity, A·B, which essentially determines the “twist rate” of the magnetic field lines in the toroidal equilibrium plasma and also the “Baricity” ψ², from the greek baro for weight or pressure, where y is the poloidal flux, which determines the thermodynamic pressure of the plasma. Both of these invariants scale approximately with the magnetic field energy, or flux density squared, and thus satisfy the approximate requirement of ESI. This “Double Invariant Theory” has been successfully applied to the Tokamak and RFP (Reverse Field Pinch) and yields finite Beta Equilibria.

The Helicity invariant A·B represents the linking of poloidal and toroidal fluxes and is very robust. This can be seen from minimal general conditions on the plasma turbulence velocity field v to preserve A·B in a plasma surviving even if the plasma turns ‘inside out’.

$$\frac{\partial H}{\partial t} = \int \frac{\partial A}{\partial t} \cdot B + A \cdot \frac{\partial A}{\partial t} dV \qquad ( 13 )$$

Where in ideal MHD

$$\frac{\partial A}{\partial t} = v \times B \qquad ( 14 )$$

$$and$$

$$\frac{\partial B}{\partial t} = ∇ \times ( v \times B ) \qquad ( 15 )$$

We then use the relations

$$∇ \cdot ( Q \times R ) = ∇ \times Q , R - Q \cdot ∇ \times R \qquad ( 16 )$$

$$and$$

$$v \times B \cdot B = 0 \qquad ( 17 )$$

$$To simply$$

$$\frac{\partial H}{\partial t} = \int 0 + A \cdot \frac{\partial B}{\partial t} d V = \int ∇ \cdot ( A \times v \times B ) + ( v \times B ) \cdot B dV \qquad ( 18 )$$

Therefore, the volume integral reduces to surface integral which vanishes because v=0 on the chamber walls

$$\frac{\partial H}{\partial t} = \int ( A \times v \times B ) \cdot dS = 0 \qquad ( 19 )$$

Accordingly, the Helicity is conserved, for ideal MHD, with no conditions on the MHD turbulence velocity field except the condition of v=0 on the chamber walls. The plasma can literally turn itself “inside out” and Helicity will be conserved. Therefore, if only Helicity is conserved the plasma can be mostly lost to open field lines and not part of the final toroidal equilibrium. The resulting MHD equilibrium approaches the limit of a zero pressure, “Force Free” configuration.

$$\frac{\partial H}{\partial t} = \int ( A \times v \times B ) \cdot dS = 0 \qquad ( 19 )$$

In contrast, the conservation of Baricity is confined to less general conditions on the MHD turbulent velocity field, in particular the plasma must relax to a minimum energy state without violent global motions, and preserve the topological relationship between its inner and outer flux surfaces. That is, the MHD configuration cannot turn “inside out.” Accordingly, conservation of Baricity is consistent with plasma being retained on closed field lines and the final equilibrium being one with finite pressure. Thus, the Baricity is conserved for the case of high frequency Alven turbulence.

The Baricity is only conserved in the limit of average circular symmetry of the plasma turbulence and its being dominated by high frequency incompressible oscillations. These latter two conditions will occur in the final stages of the toroidal plasma relaxation in the Sonic Bath Model, where the plasma volume is effectively constant and toroidally symmetric and the turbulence is dominated Alfvén waves, that are trapped on the magnetic field lines. The conservation of Barcity in these circumstances be shown.

An equation, based on the ideal MHD relation, δA=v×B and the expression in toroidal geometry B_{φ}=∇_{ψ}x [symbol] /r is:

$$\frac{d ψ}{dt} \frac{\hat{θ}}{r} = v \times ∇ ψ \times \frac{\hat{θ}}{r} \qquad ( 20 )$$

Using the identity A×B×C=B(A·C)−C(A·B), thus:

$$\frac{\partial ψ}{\partial t} \frac{\hat{θ}}{r} = ∇ ψ ( v \cdot \frac{\hat{θ}}{r} ) - \frac{\hat{θ}}{r} ( v \cdot ∇ ψ ) \qquad ( 21 )$$

Where, assumed only ψ and v are variables in the high frequency turbulence.

The first term on the right are assumed to go to zero when summed globally in the case of the Sonic Bath relaxation, because the MHD turbulence is assumed to be of high frequency and isotropic. When this first term is set to zero and the expression is simplified as:

$$\frac{\partial ψ}{\partial t} = - ( v \cdot ∇ ψ ) \qquad ( 22 )$$

Substituting, from the beginning, the term ½ψ², scaling approximately with magnetic energy and Helicity, for y and have:

$$ψ \frac{\partial ψ}{\partial t} = - ψ ∇ \cdot ( ψ v ) + \frac{1}{2} {φ}^{2} ( ∇ \cdot v ) \qquad ( 23 )$$

Where the second term on the right vanishes in the Sonic Bath Model because the end stage of the relaxation is dominated by Alve'n wave turbulence for which ∇·v=0

Therefore:

$$\int \frac{\partial ψ}{\partial t} d V = \int ∇ \cdot ( {ψ}^{2} v ) dV \qquad ( 24 )$$

This yields a form that, when integrated over the plasma volume, becomes a surface integral that vanishes due to v=0 on the chamber walls or, alternatively, on the separatrix of the plasma toroidal equilibrium where ψ=0.

$$\int ∇ \cdot ( {ψ}^{2} v ) dV = ∮ {ψ}^{2} v \cdot dS = 0 \qquad ( 25 )$$

Thus, Baricity is a global flux invariant for the last stages of the plasma relaxation, provided the plasma relaxes without violent instabilities. This is the same requirement seen experimentally for good confinement of plasma in a toroidal equilibrium.

The physical meaning of the two plasma invariants is that the Helicity Invariant conserves the average “pitch angle” of the toroidal plasma magnetic field lines as it relaxes to a minimum energy state. It is very robust and can be conserved even if the plasma undergoes violent turbulence during relaxation. The Flux Squared or “Baricity” Invariant requires the plasma to maintain its order of nested flux surfaces, literally, to “not turn inside out”, preserving its basic topology, as it relaxes. Baricity conservation thus requires a relation through broad spectrum high frequency Alve'n turbulence without violent large scale turbulence.

Using the two invariants Helicity H and Baricity I, minimize magnetic energy W in the toroidal plasma with Helicity and Baricity being conserved using the Lagrange multiplier procedure:

L=W+λI+μH (26)

δL=δW+λδI+μδH=0 (27)
which becomes the Grad-Shafranov equilibrium equation:

Δ*ψ=λr²ψ+μ²ψ (28)
with plasma pressure function P=λψ² and rB_{θ}=μψ. models the pressure profiles in both Tokamaks and RFPs (Reversed Field Pinches) both of which have been successful experimentally in producing stable toroidal plasmas. [3, 4]

Therefore, a model of the relaxed equilibria of the plasma can be developed. A crucial detail in the function which describes the optimal rifling pattern on the inner surface of the conducting chamber, in order to maximize fusion performance.

The RTP (“Rifled Toroidal Pinch”) concept for formation of Tokamak plasmas by shock implosion processes is shown in the figure below:

Which shows the plasma and magnetic field lines in a RTP device after shock implosion and heating of plasma.

Implementations work in low temperature plasma experiments, as is summarized below.

A cylindrical limit theory shows that:

$$\frac{jxB}{c} ∇ P$$

$$\frac{{J}_{z} {B}_{θ}}{c} - \frac{{J}_{z} {B}_{θ}}{c} = \frac{\partial P}{\partial r}$$

$$\frac{1}{4 π} [ \frac{1}{r} \frac{\partial }{\partial r} ( r \frac{\partial {A}_{z}}{\partial r} ) {B}_{θ} - \frac{\partial {B}_{z}}{\partial r} {B}_{z} ] = \frac{\partial P}{\partial r}$$

$$\frac{1}{4 π r} \frac{\partial }{\partial r} ( r \frac{\partial {A}_{z}}{\partial r} ) \frac{\partial {A}_{z}}{\partial r} - \frac{1}{8 π} \frac{\partial {B}_{z}^{2}}{\partial r} = \frac{\partial P}{\partial r}$$

$$\frac{1}{4 π r} \frac{\partial }{\partial r} ( r \frac{\partial {A}_{z}}{\partial r} ) \frac{\partial {A}_{z}}{\partial r} = \frac{\partial P}{\partial r} + \frac{1}{8 π} \frac{\partial {B}_{z}^{2}}{\partial r}$$

In which case 1 shows no Bennett Pinch:

$$\frac{\partial P}{\partial r} + \frac{1}{8 π} \frac{\partial {B}_{z}^{2}}{\partial r} = 0$$

In which case shows 2 Bennett Pinch:

$$\frac{1}{8 π} \frac{\partial {B}_{z}^{2}}{\partial r} = 0$$

$$\frac{1}{4 π r} \frac{\partial }{\partial r} ( r \frac{\partial {A}_{z}}{\partial r} ) \frac{\partial {A}_{z}}{\partial r} = \frac{\partial P}{\partial r}$$

$$r \frac{\partial }{\partial r} ( r \frac{\partial {A}_{z}}{\partial r} ) \frac{\partial {A}_{z}}{\partial r} = 4 π {r}^{2} \frac{\partial P}{\partial r}$$

$${\int }_{0}^{a} \frac{\partial }{\partial r} ( r \frac{\partial {A}_{z}}{\partial r} ) r \frac{\partial {A}_{z}}{\partial r} d r = 2 π {\int }_{0}^{a} r \frac{\partial P}{\partial r} d r = 0 - 2 π {\int }_{0}^{a} Prdr$$

$$r \frac{\partial {A}_{z}}{\partial r} = r {B}_{θ} = r \frac{2 I}{c r} = \frac{2 I}{c}$$

$$\frac{4}{{c}^{2}} {\int }_{0}^{a} \frac{\partial I}{\partial r} Idr = 2 π {\int }_{0}^{a} Prdr$$

$$\frac{2}{{c}^{2}} {I}^{2} = 2 π {\int }_{0}^{a} Prdr$$

$$\frac{4 {I}^{2}}{2 {c}^{2} π {a}^{2}} = \frac{[ 2 π {\int }_{0}^{a} P r d r ]}{π {a}^{2}}$$

$$\frac{{B}_{θ}^{2} ( a )}{π} = \frac{[ 2 π {\int }_{0}^{a} P r d r ]}{π {a}^{2}}$$

$$\frac{{B}_{θ}^{2} ( a )}{π} = < P >$$

$$Should be$$

$$\frac{{B}_{θ}^{2} ( a )}{8 π} = < P >$$

$$< P > / \frac{{B}_{θ}^{2} ( a )}{8 π} = {β}_{p}$$

$$Case 3 mixed state$$

$$- \frac{1}{4 π r} \frac{\partial }{\partial r} ( r \frac{\partial {A}_{z}}{\partial r} ) \frac{\partial {A}_{z}}{\partial r} = \frac{\partial P}{\partial r} + \frac{1}{8 π} \frac{\partial {B}_{z}^{2}}{\partial r}$$

$$Model$$

$$P = {λ ( {A}_{z} - \frac{k {B}_{o}}{( λ + \frac{{k}^{2}}{8 π} )} )}^{2}$$

$${B}_{z} = k {A}_{z} - \frac{{k}^{2} {B}_{o}}{( λ + \frac{{k}^{2}}{8 π} )}$$

$$\frac{\partial P}{\partial r} + \frac{1}{8 π} \frac{\partial {B}_{z}^{2}}{\partial r} = 2 λ ( {A}_{z} + \frac{k {B}_{o}}{( λ + \frac{{k}^{2}}{8 π} )} ) \frac{d {A}_{z}}{d r} + 2 \frac{{k}^{2}}{8 π} ( {A}_{z} + \frac{k {B}_{o}}{( λ + \frac{{k}^{2}}{8 π} )} ) \frac{d {A}_{z}}{d r}$$

$$\frac{\partial P}{\partial r} + \frac{1}{8 π} \frac{\partial {B}_{z}^{2}}{\partial r} = 2 ( λ + \frac{{k}^{2}}{8 π} ) {A}_{z} \frac{d {A}_{z}}{d r} + 2 ( λ + \frac{{k}^{2}}{8 π} ) \frac{k {B}_{o}}{( λ + \frac{{k}^{2}}{8 π} )} \frac{{dA}_{z}}{dr}$$

$$\frac{\partial P}{\partial r} + \frac{1}{8 π} \frac{\partial {B}_{z}^{2}}{\partial r} = 2 ( λ + \frac{{k}^{2}}{8 π} ) {A}_{z} \frac{d {A}_{z}}{d r} + 2 k {B}_{o} \frac{d {A}_{z}}{d r}$$

$$\frac{2}{8 π r} \frac{\partial }{\partial r} ( r \frac{\partial {A}_{z}}{\partial r} ) \frac{\partial {A}_{z}}{\partial r} = - 2 ( λ + \frac{{k}^{2}}{8 π} ) {A}_{z} \frac{d {A}_{z}}{d r} - 2 k {B}_{o} \frac{d {A}_{z}}{d r}$$

$$\frac{1}{8 π r} \frac{\partial }{\partial r} ( r \frac{\partial {A}_{z}}{\partial r} ) + ( λ + \frac{{k}^{2}}{8 π} ) {A}_{z} = - k {B}_{o}$$

This yields Bessel's Equation zeroth order equation with an inhomogeneous term linear in Bₒ, that is due to do the MHD equilibrium term due plasma rotational current and the vacuum magnetic field. The first term linear in A_{z} is the MHD equilibrium term due to plasma pressure, and the second term is due to the MHD equilibrium term of rotational current in the plasma interacting with the change in B_{z} due to the plasma. It has the solution

$${A}_{z} = {A}_{o} {J}_{o} ( \frac{r}{{x}_{o}} ) - k {B}_{o} / ( λ + \frac{{k}^{2}}{8 π} )$$

Where at r=a, the plasma edge, a/xₒ=2.4 and A_{z}=−kBo/(λ+k²/8π)

We have then for plasma pressure:

$$P = {λ [ {A}_{o} {J}_{o} ( \frac{r}{{x}_{o}} ) - \frac{{kB}_{o}}{λ + \frac{{k}^{2}}{8 π}} ]}^{2}$$

P at the plasma edge.

$$P = {λ [ \frac{{kB}_{o}}{λ + \frac{{k}^{2}}{8 π}} ]}^{2}$$

The equilibrium equation can be re-written as an equation for current density J_{z}

$$- \frac{8 π}{8 π c} {J}_{z} = 2 ( λ + \frac{{k}^{2}}{8 π} ) {A}_{z} + 2 k {B}_{o}$$

Where for r=a and Jₒ(r/xₒ)=0, so that for a diamagnetic plasma, k>0 a reversed current mantle forms around the discharge, for r<a

$$\frac{{J}_{z}}{c} = - 2 k {B}_{o}$$

P at the plasma edge.

$$P = {λ [ \frac{{kB}_{o}}{λ + \frac{{k}^{2}}{8 π}} ]}^{2}$$

Thus, a pedestal in Plasma current, Magnetic field, and Plasma pressure exists.

To determine Aₒ:

$$\frac{1}{8 π r} \frac{\partial }{\partial r} ( r \frac{\partial {A}_{z}}{\partial r} ) + λ {A}_{z} + \frac{{k}^{2}}{8 π} {A}_{z} k = - k {B}_{o}$$

$$\frac{{B}_{θ}^{2} ( a )}{8 π} = < P > + \frac{< Δ {B}_{z}^{2} >}{8 π}$$

Where <ΔB_{z}²> is that due to effect of the plasma, rather than the vacuum field B_{z}(o)

$$q ( a ) = \frac{a {B}_{z} ( o )}{R {B}_{θ} ( a )} \approx 3$$

$$\frac{{B}_{θ} ( a )}{{B}_{z} ( o )} = \frac{1}{q} \frac{a}{R} \approx \frac{1}{3} \frac{a}{R} \approx 10 \%$$

$${[ \frac{{B}_{θ} ( a )}{{B}_{z} ( o )} ]}^{2} \approx {[ \frac{1}{3} \frac{a}{R} ]}^{2} \approx 1 \%$$

$$< P > / \frac{{B}_{θ}^{2} ( a )}{8 π} = {β}_{p} \approx 1$$

$${β}_{p} \frac{{B}_{θ}^{2} ( a )}{< {B}_{z}^{2} ( o ) >} = \frac{8 π < P >}{< {B}_{θ}^{2} ( a ) >} \frac{{B}_{θ}^{2} ( a )}{< {B}_{z}^{2} ( o ) >} \approx 1 \%$$

$$\frac{8 π < P >}{< {B}_{z}^{2} ( o ) >} = < β > \approx 1 \%$$

$$\frac{{B}_{θ}^{2} ( a )}{< {B}_{z}^{2} >} = < β > + 1$$

Define: the ΔB²_{z} is the B_{z} coupled to the plasma is, and B²_{z}(o) is the vacuum B_{z}

$$\frac{{B}_{θ}^{2} ( a )}{8 π} = < P > + \frac{< Δ {B}_{z}^{2} ( a ) >}{8 π}$$

$$\frac{{B}_{θ}^{2} ( a )}{8 π} = < λ {A}_{z}^{′ 2} > + \frac{< {k}^{2} {A}_{z}^{′2} ( a ) >}{8 π}$$

$$Where$$

$${A}_{z}^{′ 2} = {( {A}_{z} + \frac{k {B}_{o}}{λ + {k}^{2}} )}^{2}$$

The gauge term leads to the pedestal magnetic field, which reverses when βₚ>1 (plasma diamagnetism) where k goes from k>0 to k<0. At βₚ=1 the plasma decouples from the vacuum magnetic field Bₒ

Where

A_{z}(a)=0

And

$${B}_{z} ( a ) = \frac{k {B}_{o}}{\sqrt{λ + {k}^{2}}}$$

$$So that at r = a$$

$$\frac{{B}_{θ}^{2} ( a )}{8 π} = λ {B}_{o}^{2} + \frac{k {B}_{o}^{2}}{8 π}$$

$$1 = \frac{< P >}{\frac{{B}_{θ}^{2} ( a )}{8 π}} +$$

$$1 = {β}_{p} + \frac{< Δ {B}_{z}^{2} ( a ) >}{{B}_{θ}^{2} ( a )}$$

$$\frac{< Δ {B}_{z}^{2} ( a ) >}{{B}_{θ}^{2} ( a )} = 1 - {β}_{p}$$

In the systems, methods and apparatus described herein when fueled by deuterium and helium3 has a low threshold of fusion, as low as 100 million degrees Kelvin (K) for experimental testing purposes, due to the strong collisional coupling between the energetic alpha particles produced by fusion and the doubly charged helium3 nuclei. This means fusion energy produced in the system heats the remaining fusion fuel very efficiently, making it more reactive. This means that a small amount of tritium can be introduced into the system to bring it to fusion. Tritium fuses at lower temperatures and thus heats the plasma ions via fusion energy. This would however, introduce neutrons into the system and cause some activation of the structure.

The present systems, method and apparatus do not include a separate auxiliary heating device to bring the plasma to fusion temperatures of between 100,000,000 degrees K and 150,000,000 degrees K for deuterium-tritium fuel, fusion temperatures of between 600,000,000 degrees K and 1,000,000,000 degrees K for Helium3 and deuterium fuel and fusion temperatures of between 600,000,000 degrees K and 700,000,000 degrees K for a Helium3 fuel, in contrast to the tokamak and stellarator devices that do include a separate auxiliary heating method to bring the plasma to fusion temperatures of between 100,000,000 degrees K and 150,000,000 degrees K for deuterium-tritium fuel, fusion temperatures of between 600,000,000 degrees K and 1,000,000,000 degrees K for Helium3 and deuterium fuel and fusion temperatures of between 600,000,000 degrees K and 700,000,000 degrees K for a Helium3 fuel. The absence of an auxiliary heating device significantly reduces the complexity and mass of the apparatus 100, which is especially helpful in achieving deuterium-helium3 fusion reaction, however, the deuterium and helium3 fusion requires hotter and denser plasmas than the deuterium-tritium) fusion reaction and is thus more technically challenging. Nonetheless, the aneutronic fusion reaction excludes and obviates the need for a steam turbine to generate electricity.

Some implementations of systems, methods and apparatus described herein include a Langmuir probe and spectral density and temperature plasma diagnostic hardware and software.

In some implementations, systems, methods and apparatus described herein performs plasma heating and confinement at 100 eV and 1000 liters in volume.

In some implementations, systems, methods and apparatus described herein can be used in fusion reaction experiments.

In some implementations, systems, methods and apparatus described herein can include hardware and software to perform multipoint spectral density and temperature plasma diagnostics.

In some implementations, systems, methods and apparatus described herein performs plasma heating and confinement up to 60 KeV and 1000 liters in volume.

In some implementations, systems, methods and apparatus described herein includes hardware and software performs neutron and proton detector-based density and temperature plasma diagnostics to monitor fusion reactions.

In some implementations, systems, methods and apparatus described herein performs plasma heating and confinement up to 30 to 60 KeV and 1000 liters in volume.

In some implementations, systems, methods and apparatus described herein performs deuterium and helium3 fusion plasma heating and confinement up to 30-60 KeV and 1000 liters in volume.

In some implementations, systems, methods and apparatus described herein performs plasma heating and confinement of deuterium and helium3 at 30 to 60 KeV and 10¹⁵/cm³ for 100 millisecond pulses.

In some implementations, systems, methods and apparatus described herein performs plasma deuterium and helium3 fusion.

In some implementations, systems, methods and apparatus described herein performs deuterium and helium3 fusion confinement for experimental use while minimizing neutron output.

In some implementations, systems, methods and apparatus described herein performs stable plasma equilibrium for a deuterium and helium3 mixture using shock heating and subsequent confinement of a dense-hot plasma for 100 milliseconds at a number density of approximately nₑ=10¹⁷ electrons per cc. The magnetic field required for this is approximately 500 kG.

The systems, methods and apparatus described herein is a configuration that is simple, effective, and “user friendly” and that easily confines stable plasmas of nₑ=1000 liters in volume and electron and ion temperatures of 200 eV.

The systems, methods and apparatus described herein configuration at deuterium and helium3, will allow compact high power pulsed aneutronic fusion energy for experimental use, without radiation or nuclear waste, with the direct conversion of fusion power to electricity.

In some implementations, systems, methods and apparatus described herein performs plasma equilibrium with centrally peaked profiles, controlled by computer hardware and software, such as FIG. 13-15, that is coupled to systems, methods and apparatus described herein, performs detailed profile diagnostics and optical diagnostics using the visible line spectra of ionized helium at 320.3 nm and 468.5 nm to determine the ion temperature and electron density in the plasma core. In some implementations, these measurements are augmented at higher ion densities and temperatures in some implementations of the systems, methods and apparatus described herein with measurements of neutron emission from deuterium-deuterium fusion reactions and at higher temperatures high energy protons from the deuterium and helium3 reactions.

In regards to plasma physics, nuclear physics and power engineering issues, in MHD (Magneto-Hydro-Dynamic) equilibrium and stability, the parameter measuring the efficiency of the magnetic field in confining the plasma is termed p and the ratio of average thermodynamic pressure in the plasma to the average magnetic energy density. High β equilibria is most desirable; however, they are more susceptible to MHD instabilities, that leads to plasma escape. A “second region” of stability exist with stable equilibria up to β~4%.

In regards to suppression of deuterium-deuterium neutronic side reactions, a hot plasma containing both deuterium and helium3 will burn primarily deuterium and helium3, however deuterium-deuterium side reactions will also occur unless the deuterium can be kept at lower temperature. This will occur naturally in the initial shock heating phase of the pulsed plasma when most of the kinetic energy will be contained in the heavier helium3. However, in some cases, the deuterium will reach the same temperatures as the helium3 and deuterium-deuterium fusion reactions, which will create neutrons. The helium3 can be heated preferentially while keeping the deuterium cold and thus suppressing deuterium-deuterium reactions. Nonetheless, both the helium3 and deuterium can be spin polarized in the magnetic fields and that this polarized plasma promotes deuterium and helium3 fusion but suppress deuterium-deuterium reactions. Therefore, deuterium-deuterium reactions can be suppressed in the plasma by various methods and so the resulting neutron emission can also be sharply reduced in final systems.

The high temperature plasma required to fuse deuterium and helium3 leads to high energy electrons that are mildly relativistic and this leads to enhanced microwave emission by the plasma. This microwave emission is at high frequency compared to the normal cyclotron emission which is much more intense, is called synchrotron radiation. This requires having highly reflective inner walls for the inner chamber 118 to reflect power back into the plasma where it is reabsorbed. In some implementations, the inner walls of the inner chamber 118 can be made highly reflective to synchrotron radiation (high frequency microwaves) by being made of pure 100% aluminum. Alternatively, synchrotron radiation can extract power at high efficiency from the plasma since microwave antenna arrays can be fabricated which directly convert synchrotron radiation to electricity.

In some implementations, systems, methods and apparatus described herein is optimized to burn deuterium and helium3 by injecting of a small percentage (e.g. less than 5%) of tritium into the inner chamber 118. The tritium fuses instantly at the high temperatures required for deuterium and helium3 fusion and the resulting 4.5 Mev helium4 (alpha particles) collide with and heat of the helium3 to even higher temperature, igniting the plasma.

In some implementations, the fuel in systems, methods and apparatus described herein will fuse in a non-equilibrium mode, which is undesirable, in which case the deuterium and helium3 fuel can be mixed with a lean mixture of deuterium since most of the initial kinetic energy will be in the helium3 (because the helium3 is heavier and also because the helium3 will be heated more effectively by collisions with fusion helium4. In some implementations, additional suppression of deuterium-deuterium fusion reaction can be achieved by using polarized fuels, which enhances deuterium and helium3 reaction but suppresses deuterium-deuterium reactions. In some implementations, systems, methods and apparatus described herein, the same plasma-magnetic field dynamics that lead to plasma implosion for shock heating can be reversed to harvest fusion energy from the expanding hot plasma as it presses outward on the confining magnetic field.

### Testing and Experimental Criteria in FIGS. 1-3, 11-12 and 16-39

In various implementations, the systems, methods and apparatus described herein are used to test, measure and verify plasma temperature, plasma density, fusion reaction rates, neutron activity, voltage generation, power output, pulse characteristics and/or energy conversion efficiency.

In experimentation, testing and production, the temperature of plasma in the inner chamber 118 is measured and determined by measuring and determining optical spectra in the inner chamber, the density of plasma in the inner chamber 118 is measured and determined by measuring and determining optical spectra in the inner chamber, the fusion reaction rate of fusion in the plasma in the inner chamber 118 is measured and determined by neutron and proton detectors, the neutron activity of fusion in the plasma in the inner chamber 118 is measured and determined by Geiger counters, the voltage generation of the capacitor bank is measured and determined, the power input to the fusion confinement device is measured and determined, the power output of the fusion confinement device is measured and determined, energy conversion efficiency is determined from the power input to the fusion confinement device, the power output of the fusion confinement device and the pulse characteristics of the power output of the fusion confinement device.

In some implementations, the temperature of plasma in the inner chamber 118 is measured and determined by measuring and determining optical spectra in the inner chamber. In some implementations Spectroscopy of plasma utilizes high-resolution spectral line measurements of the emitted plasma light by which the plasma density and temperature is estimated. The light emitted from the plasma in some implementations is collected by a 100 mm in diameter lens and focused (170 mm focal length) onto a 100 μm-wide slit of a 1 m-long focus spectrometer with a grating of 2400 grooves/mm. At the output of the spectrometer, a fast-framing 4QuikE intensified camera in some implementations is installed. To obtain reliable spectral line profiles, the duration of the camera frame in these experiments in some implementations is 100 ns. Thus, the density and temperature obtained by analyzing the spectral lines in some implementations is considered to be average values during the exposure time. Spectral lines in some implementations are obtained at various times relative to the beginning of the discharge current by controlling the time delay of the camera's trigger time. Spectral calibration of the spectrometer at Hα (656.28 nm) and Hβ (486.13 nm) spectral lines using Hydrogen spectral lamps resulted in RHα=0.1075° A/pixel and RHβ=0.153° A/pixel. Using this spectral resolution, the instrumental Full Width at Half Maximum (FWHM) broadening of Hα and Hβ spectral lines in some implementations is found to be ΔλinstHα=0.432° A and ΔλinstHβ=0.533 A°. For hydrogen plasma, the main effects responsible for line broadening are Doppler broadenings due to hydrogen atom temperatures and Stark broadening created by the electric fields of the electrons and ions. To distinguish between the contributions of these two effects, the following algorithm in some implementations is applied. The Hα line Stark broadening in some implementations is smaller than the Hβ line Stark broadening for the same density of the plasma. However, the Doppler broadening of the Hα line is larger than that of Hβ. In general, assuming a Maxwellian energy distribution, the Doppler broadening of the spectral line due to the temperature of neutrals. In some embodiments, the optical spectra of the plasma is measured and determined by a spectrometer, such as the model HR6 spectrometer manufactured by Ocean Optics Solutions at Geograaf 24, 6921 EW, Duiven, The Netherlands, having a wavelength range of 180-1100 nm, an integration time of 7.2 ms-5 s, an optical resolution (FWHM) of 0.08-7.24 nm, a sound to noise ratio (SNR) at a single scan @10 ms of 400:01:00 and a SNR at max. per second w/high speed averaging mode 3,500:1.

In some implementations, the density of plasma in the inner chamber 118 is measured and determined by measuring and determining optical spectra in the inner chamber. In some implementations, the minimum acceptable density of the plasma is 10¹⁶ per cm³. In some implementations, the plasma density in the inner chamber 118 can be measured and determined by a klystron model 44151H, manufactured by Hughes EDD, Torrance, CA, USA) was used as a 70 GHz continuous wave (CW) microwave source. The klystron in some implementations is connected to a WR15 waveguide (50-75 GHz) with an ANTT-SGH-50-70 horn antenna (NSI-MI Technologies, Suwanee, Georgia, USA) (gain of 24.4 dBi) at its output.

In some implementations, the fusion reaction rate of fusion in the plasma in the inner chamber 118 is measured and determined by neutron and proton detectors. In some implementations, the minimum acceptable fusion reaction rate is 10¹⁸ fusion reactions per pulse. In some implementations, the fusion reaction rate of the fusion in the inner chamber 118 can be measured and determined by a high performance neutron detector such as a NDg screen having a formulation of 6LiF ZnS:Cu, Al; phosphor type of particulate blend; an emission color of green; a peak wavelength of 530 nm; a decay of 10% 85 μs; an afterglow of “low level”; an X-ray Absorption of “low” and an UV Absorption of “>220 nm into” manufactured by Scintacor, 125 Cowley Road, Cambridge Commercial Park, Cambridge, CB4 0DL, United Kingdom.

In some implementations, the neutron activity of fusion in the plasma in the inner chamber 118 is measured and determined by Geiger counters. In some implementations, the minimum acceptable neutron activity of the fusion is 10⁶ activations per pulse. In some implementations, the neutron activity of the fusion in the inner chamber 118 can be measured and determined by a Geiger counter GS 3, having measurement ranges of 0.01 μSv/h−1000 μSv/h, being a Geiger-Muller counting tub radiation detector, having internal memory 2 KB and operable to detect radiation types including Alpha 4 MeV, Beta 0.2 MeV and Gamma 0.02 MeV, that is manufactured by PCE Holding GmbH, Im Langel 26, 59872 Meschede, Germany.

In some implementations, the voltage generation of the capacitor bank is measured and determined. In some implementations, the minimum acceptable voltage generation of the capacitor bank is 15 KV. In some implementations, the measuring and determining of the voltage generation of the capacitor bank is performed by a loop coupled oscilloscope. One example of a loop coupled oscilloscope is a XR6-class Expert oscilloscope having maximum bandwidth of 500 MHz to 6 GHz, having 4 to 8 analog channels, having 16 digital channels having a maximum sample rate of 16 GSa/s, having a maximum memory depth of 1.6 Gpts, having an ADC resolution of 10 bits, and having brands MXR Series, EXR Series; that is manufactured by Keysight, 1400 Fountain Gove Parkway, Santa Rosa, CA.

In some implementations, the power input to the fusion confinement device is measured and determined. In some implementations, the minimum acceptable power input to the fusion confinement device is 300,000 Joules. In some implementations, the measuring and determining of the power input to the fusion confinement device is performed by a Rogowski coil. One example of a Rogowski coil is an ARH series Rogowski coil having and extended temperature range: up to 105 °C operating temperature and 125 °C in direct contact with busbar, class 0.5 (IEC 61869-10), having very low positioning error, compliant with UL and IEC 61010 and UL 2408, having very thin primary sensor (8 mm), having small external fields influence, having 22.5 mV/kA sensitivity to have a very thin coil, having electrostatic shield included for better common mode rejection of the integrator, having protection degree of IP57, and having ø 70 mm minimum sensing aperture; that is manufactured by LEM International SA, Route du Nant-d'Avril, 152, 1217 Meyrin, Switzerland.

In some implementations, the power output of the fusion confinement device is measured and determined. In some implementations, the minimum acceptable power output of the fusion confinement device is 50% increase per fusion pulse. In some implementations, the measuring and determining of the power output of the fusion confinement device is performed by a Rogowski coil. One example of a Rogowski coil is an ARH series Rogowski coil having and extended temperature range: up to 105 °C operating temperature and 125 °C in direct contact with busbar, class 0.5 (IEC 61869-10), having very low positioning error, compliant with UL and IEC 61010 and UL 2808, having very thin primary sensor (8 mm), having small external fields influence, having 22.5 mV/kA sensitivity to have a very thin coil, having electrostatic shield included for better common mode rejection of the integrator, having protection degree of IP57, and having ø 70 mm minimum sensing aperture; that is manufactured by LEM International SA, Route du Nant-d'Avril, 152, 1217 Meyrin, Switzerland.

In some implementations, the pulse characteristics of the power output of the fusion confinement device is measured and determined. In some implementations, the minimum acceptable pulse characteristics of the power output of the fusion confinement device is the height, and duration and in time of each fusion pulse. In some implementations, the measuring and determining of the pulse characteristics of the power output of the fusion confinement device is performed by a Rogowski coil. One example of a Rogowski coil is an ARH series Rogowski coil having and extended temperature range: up to 105 °C operating temperature and 125 °C in direct contact with busbar, class 0.5 (IEC 61869-10), having very low positioning error, compliant with UL and IEC 61010 and UL 2408, having very thin primary sensor (8 mm), having small external fields influence, having 22.5 mV/kA sensitivity to have a very thin coil, having electrostatic shield included for better common mode rejection of the integrator, having protection degree of IP57, and having ø 70 mm minimum sensing aperture; that is manufactured by LEM International SA, Route du Nant-d'Avril, 152, 1217 Meyrin, Switzerland.

Energy conversion efficiency is determined from the power input to the fusion confinement device, the power output of the fusion confinement device and the pulse characteristics of the power output of the fusion confinement device. In some implementations, the minimum acceptable energy conversion efficiency is a 50% increase in energy per pulse.

In some implementations of testing and experimentation, the primary objectives are verification of fusion conditions for Deuterium-Deuterium of plasma temperatures, densities and neutron production in subscale device.

In some implementations of testing and experimentation, the primary objectives are demonstration of fusion conditions for Deuterium-Deuterium of plasma temperatures, densities and neutron production in larger device.

In some implementations of testing and experimentation, the primary objectives are demonstration of fusion conditions for Deuterium-Helium 3 of plasma temperatures, densities and neutron production in larger device, such as fusion temperatures of between 600,000,000 degrees K and 700,000,000 degrees K for a Helium3 fuel.

### CONCLUSION

A rifled toroidal pinch fueled by a mixture of helium3 and deuterium, or helium3 alone, is described. A technical effect of the rifled toroidal pinch fueled by a mixture of helium3 and deuterium, or helium3 alone, is shaping electromagnetic force and generating maximum compression force onto a plasma in an experimental nuclear fusion reactor. Although specific implementations are illustrated and described herein, it will be appreciated by those of ordinary skill in the art that any arrangement which is calculated to achieve the same purpose may be substituted for the specific implementations shown. This application is intended to cover any adaptations or variations.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future, different and new fusion confinement devices 110, first half-shells 114, second half-shells 116, inner chambers 118, flanges 120 and 122, insulation layers 124, non-ferrous and non-conductive fasteners 126 and 128, terminals 130, terminals 132, vacuum pumps 134, vacuum lines 136, vacuum ports 138, fuel injectors 140, fuel lines 142, fuel tanks 144, gas injectors 146, gas line 148, gas tank 150, EM foils 152, gas sensors 154, electric lines 156, electrical sources 158, pre-ionizers 160, electric lines 162, electrical sources 164, electrical switches 166, electric lines 168 and 170, conductive center pieces 172, electrical sources 174 and electrical sinks 176.

The terminology used in this application is meant to include all environments and alternate technologies which provide the same functionality as described herein.

In some implementations, a unitary fusion system includes a first half-shell enclosing a first hemisphere of a hollow toroidal interior chamber; a second half-shell enclosing a second hemisphere of the hollow toroidal interior chamber, the first hemisphere and the second hemispheres forming two hemispheres; wherein the first hemisphere of the hollow toroidal interior chamber and the second hemisphere of the hollow toroidal interior chamber form the hollow toroidal interior chamber; wherein the hollow toroidal interior chamber includes an interior surface having rifling; wherein the first half-shell and the second half-shell both have a diameter of at least 1 meter and no more than 3 meters; wherein the first half-shell and the second half-shell are fastened together; wherein the first half-shell and the second half-shell are made of non-ferrous materials, wherein the non-ferrous material comprise an aluminum/scandium alloy with no more than 1% scandium; a first flange on an outer perimeter of the first half-shell and that extends away from a center axis of the unitary fusion system; a second flange on the outer perimeter of the second half-shell and that extends away from the center axis of the unitary fusion system; an insulator that is positioned between the first flange of the first half-shell and the second half-shell of the second half-shell; a conductive center piece that is between an inner perimeter of the first half-shell and the inner perimeter of the second half-shell, but is absent between the center axis and the hemispheres of the first half-shell and the second half-shell, putting the first half-shell in electrical contact with the second half-shell; wherein the unitary fusion system does not include electromagnetic coils; wherein the unitary fusion system is not a Z-pinch device, a sheet-pinch device, a screw pinch device, a reversed field pinch device, a toroidal pinch device, an inverse pinch device, a cylinder pinch device, an orthogonal pinch device, a Ware pinch device, a MagLIF pinch device or an uncontrolled pinch device; wherein the hollow toroidal interior chamber includes a one-turn EM foil; further comprising an electronic controller that generates a plurality of pulses of electrical energy; a first electrical line electrically coupled to the first half-shell; a second electrical line electrically coupled to the second half-shell; an electrical source electrically coupled to first electrical lines; an electrical sink electrically coupled to the second electrical line, wherein the electrical sink includes an electrical conditioner electrically coupled to an electrical power distribution grid; a gas injector mounted in either the first hemisphere of the hollow toroidal interior chamber or the second hemisphere of the hollow toroidal interior chamber, that receives a gas from outside the hollow toroidal interior chamber and injects the gas into the hollow toroidal interior chamber; wherein the gas is argon, helium or air; a fuel injector mounted in either the first hemisphere of the hollow toroidal interior chamber or the second hemisphere of the hollow toroidal interior chamber, that receives a fuel from outside the hollow toroidal interior chamber and injects the fuel into the hollow toroidal interior chamber; wherein the fuel is a mixture of a helium3 and a deuterium, wherein the mixture of the helium3 and the deuterium is approximately equal amounts of the helium3 and the deuterium, wherein the mixture of the helium3 and the deuterium is lean in deuterium in order to reduce fusion between atoms of the deuterium that produce harmful protons; a gas sensor mounted in either the first hemisphere of the hollow toroidal interior chamber or the second hemisphere of the hollow toroidal interior chamber, that determines a composition of the gas and a pressure of the gas inside the hollow toroidal interior chamber and transmits the composition and the pressure of the gas in the hollow toroidal interior chamber; and a controller that is electrically coupled to the electrical source, the gas injector, a vacuum pump, a vacuum port, an electrical switch, the gas sensor, a pre-ionizer and the fuel injector that generates and transmits commands to the gas injector to achieve and maintain a predetermined composition of the gas and predetermined pressure of the gas, and that determines a pattern of the plurality of pulses of the electrical energy from the electrical source to a first electrical conductor and that transmits the pattern of plurality of pulses of the electrical energy, wherein each of the plurality of pulses of the electrical energy is about a square wave, having a duration of 1 millisecond and having a pulse strength of approximately 0.5 megagausses.

In some implementations, a unitary fusion system includes a fusion confinement device enclosing a hollow toroidal interior chamber that includes an interior surface having rifling; and a fuel injector mounted in the fusion confinement device that receives a fuel wherein the fuel is a mixture of a helium3 and a deuterium, wherein the mixture of the helium3 and the deuterium is approximately equal amounts of the helium3 and the deuterium.

In some implementations, a unitary fusion system includes a housing enclosing a hollow toroidal interior chamber, wherein the hollow toroidal interior chamber includes an interior surface having a rifling.

1. An experimental fusion system comprising:
a unitary housing having a hollow toroidal interior chamber that includes an interior surface of the unitary housing, the interior surface of the unitary housing having a rifled geometric shape; and
a coil that is physically mounted to a ridge of the rifled geometric shape.

2. The experimental fusion system of claim 1 further comprising:
the unitary housing further comprising enclosing the hollow toroidal interior chamber;
a first electrical line electrically coupled to the unitary housing;
a second electrical line electrically coupled to the unitary housing;
an electrical source electrically coupled to first electrical lines; and
an electronic controller that generates a plurality of pulses of electrical energy.

3. The experimental fusion system of claim 2
wherein the unitary housing has a diameter of at least 1 meter and no more than 3 meters.

8. The experimental fusion system of claim 2
a gas injector mounted in the unitary housing, that receives a gas from outside the hollow toroidal interior chamber and injects the gas into the hollow toroidal interior chamber; wherein the gas is argon, helium or air; and
a gas sensor mounted in the unitary housing, that determines a composition of the gas and a pressure of the gas inside the hollow toroidal interior chamber and transmits the composition and the pressure of the gas in the hollow toroidal interior chamber.

9. The experimental fusion system of claim 8 further comprising:
a fuel injector mounted in the unitary housing, that receives a fuel from outside the hollow toroidal interior chamber and injects the fuel into the hollow toroidal interior chamber; and
a second electronic controller that is electrically coupled to the fuel injector.

10. The experimental fusion system of claim 9
wherein the electronic controller is electrically coupled to the electrical source, the gas injector, a vacuum pump, a vacuum port, an electrical switch, the gas sensor, a pre-ionizer and the fuel injector that generates and transmits commands to the gas injector to achieve and maintain a predetermined composition of the gas and predetermined pressure of the gas, and that determines a pattern of the plurality of the pulses of the electrical energy from the electrical source to a first electrical conductor and that transmits the pattern of the plurality of the pulses of the electrical energy, wherein each of the plurality of pulses of the electrical energy is about a square wave, having a duration of 1 millisecond and having a pulse strength of approximately 0.5 megagausses.

11. The experimental fusion system of claim 2 further comprising:
a second electronic controller that is electrically coupled to the electrical source.

13. The experimental fusion system of claim 2 further comprising:
wherein the unitary housing is made of non-ferrous materials, wherein the non-ferrous materials further comprise an aluminum/scandium alloy with no more than 1% scandium.

14. The experimental fusion system of claim 1 further comprising:
wherein the experimental fusion system produces an aneutronic fusion reaction, thus no excessive quantities of heat are generated by the aneutronic fusion reaction and the experimental fusion system does not include a steam turbine to generate electricity.

15. The experimental fusion system of claim 1 further comprising:
wherein the experimental fusion system is not a Z-pinch device, a sheet-pinch device, a screw pinch device, a reversed field pinch device, a toroidal pinch device, an inverse pinch device, a cylinder pinch device, an orthogonal pinch device, a Ware pinch device, a MagLIF pinch device or an uncontrolled pinch device.

16. The experimental fusion system of claim 1 further comprising:
wherein a fuel is a mixture of a helium3 and a deuterium.

17. The experimental fusion system of claim 16 further comprising:
wherein the mixture of the helium3 and the deuterium is equal amounts of the helium3 and the deuterium.

18. The experimental fusion system of claim 16 further comprising:
wherein the mixture of the helium3 and the deuterium is lean in deuterium in order to reduce fusion between atoms of the deuterium that produce harmful protons.

19. The experimental fusion system of claim 1 further comprising:
wherein a first hemisphere of the hollow toroidal interior chamber and a second hemisphere of the hollow toroidal interior chamber form the hollow toroidal interior chamber.
